(19) United States
(12) Patent Application Publication
(10) Pub. No.: US 2020/0171501 A1
(43) Pub. Date: Jun. 4, 2020

(54) Biological Process Systems and Methods Using Microfluidic Apparatus Having an Optimized Electrowetting Surface

(71) Applicant: Berkeley Lights, Inc., Emeryville, CA (US)

(72) Inventors: Jason M. McEwen, El Cerrito, CA (US); Magali Soumillon, Boston, MA (US); Shao Ning Pei, Albany, CA (US); Randall D. Lowe, Jr., Emeryville, CA (US); Samira A. Nedungadi, Berkeley, CA (US); Volker L.S. Kurz, Oakland, CA (US); Jian Gong, Danville, CA (US); Yara X. Mejia Gonzalez, Berkeley, CA (US); Mckenzi S. Toh, Oakland, CA (US); Brian A. Rabkin, Redwood City, CA (US); Jason C. Briggs, Pleasanton, CA (US); Darcy K. Kelly-Greene, Pleasanton, CA (US); James M. Porter, Jr., Oakland, CA (US)

(73) Assignee: Berkeley Lights, Inc., Emeryville, CA (US)

(21) Appl. No.: 16/661,310

(22) Filed: Oct. 23, 2019

Related U.S. Application Data
(63) Continuation of application No. PCT/US2018/029648, filed on Apr. 26, 2018.
(60) Provisional application No. 62/490,596, filed on Apr. 26, 2017.
(60) Provisional application No. 62/490,534, filed on Apr. 26, 2017.

(51) Int. Cl. B01L 3/00; B01L 7/00; B03C 5/00; B03C 5/02

(52) U.S. Cl. CPC B01L 3/502792; B01L 7/52; B03C 5/005; B03C 5/026; B01L 3/502715; B01L 2300/0645; B01L 2300/165; B01L 2300/06; B01L 2400/0427; B03C 2201/26; B01L 2300/12; B01L 2300/1822

(57) ABSTRACT

Microfluidic devices having an electrowetting configuration and an optimized droplet actuation surface are provided for processing biological cells, e.g., for use in nucleic acid library preparation and/or synthesis (including amplification). The devices include a dielectric layer, a hydrophobic layer covalently bonded to the dielectric layer, and a first electrode. Methods of nucleic acid library preparation and/or synthesis can involve providing reagents to cells or nucleic acids by merging appropriate droplets on a droplet actuation surface within a water-immiscible organic liquid and can be performed in the presence of appropriate surfactants. The hydrophobic layer features self-associating molecules covalently bonded to a surface of the dielectric layer in a manner that produces a densely-packed monolayer that resists intercalation and or penetration by polar molecules or species. Also provided are systems for temperature control of the microfluidic device during nucleic acid library preparation and/or synthesis which can reduce temperature overshooting during heating and cooling steps.

### CROSS REFERENCE TO RELATED APPLICATIONS

This application is a continuation of International Patent Application No. PCT/US2018/029648, filed Apr. 26, 2018, which claims priority from U.S. Provisional Application No. 62/490,534, filed Apr. 26, 2017, and U.S. Provisional Application No. 62/490,596, filed Apr. 26, 2017, the contents of each of which are incorporated herein by reference in their entirety.

### INTRODUCTION AND SUMMARY

Micro-objects, such as biological cells, can be processed in microfluidic apparatuses. For example, droplets containing micro-objects or reagents can be moved around and merged within a microfluidic apparatus. Embodiments of the present disclosure are directed to improvements in microfluidic apparatuses that facilitate robust manipulation of droplets, allowing complex chemical and biological reactions to be precisely and reproducibly performed at small scale. The reactions include nucleic acid amplification such as PCR. The reactions can also include a series of steps to obtain nucleic acid from cells and prepare a sequencing library therefrom. Droplets can be moved and merged within a microfluidic apparatus by changing an effective wetting property of an electrowetting surface in the microfluidic apparatus. Such movements can facilitate workflows in which cells are processed to assess various cellular properties, optionally after culturing the cell within the microfluidic apparatus. Present solutions for electrowetting are extremely limited in nature and fail to scale or implement additional functionality. For example, when a microfluidic device having an electrowetting configuration is used for nucleic acid amplification, a proper thermal control system at a broad range of temperatures suitable to prevent temperature overshooting is needed. Consequently, a need exists for improved electrowetting surfaces, stable substrates for microfluidic applications, and integration of additional functionality (e.g., cellular growth and characterization prior to downstream processing made possible by electrowetting), all of which will facilitate additional medical research applications.

In some embodiments, a method of processing biological cells in a microfluidic device having an electrowetting configuration is provided. The method can comprise: disposing a first droplet of aqueous medium upon a droplet actuation surface of the microfluidic device, wherein the first droplet comprises one or more biological cells; merging the first droplet with a second droplet of aqueous medium to form a first combined droplet, wherein the second droplet comprises a cell lysing agent; incubating the first combined droplet upon the droplet actuation surface for a first period of time sufficient to lyse the one or more biological cells; and inactivating the cell lysing agent. In some embodiments, the microfluidic device further comprises a substrate having a dielectric layer and a first electrode configured to be connected to an AC voltage source, and a second electrode configured to be connected to the AC voltage source, wherein the dielectric layer is electrically coupled to the first electrode, wherein the droplet actuation surface comprises a hydrophobic layer covalently bonded to the dielectric layer, and wherein, when the first electrode and the second electrode are connected to opposing terminals of the AC voltage source, the substrate is capable of applying an electrowetting force to aqueous droplets in contact with the droplet actuating surface. The methods can be performed on any of the microfluidic devices disclosed herein. For example, the microfluidic device can include an electrowetting configuration that includes a dielectric layer having an electrical impedance of about 50 kOhms to about 150 kOhms. The dielectric layer can be a single layer or a composite of multiple dielectric sub-layers, with at least the outermost dielectric sub-layer being formed by atomic layer deposition (ALD). In certain embodiments, one or more (e.g., all) internal surfaces of the microfluidic device can include an outer hydrophobic layer comprising self-associating molecules covalently bonded to the dielectric layer. The self-associating molecules can include, for example, a linking group and a surface modifying ligand. The linking group can be, for example, a siloxane group or a phosphonic acid group. The surface modifying ligand can be, for example, a linear alkane group or a linear fluoroalkane group. In some embodiments, the method of processing biological cells is a method of preparing a nucleic acid library.

In some embodiments, a method of processing biological cells in a microfluidic device having an electrowetting configuration is provided. The method can comprise: disposing a first droplet of aqueous medium upon a droplet actuation surface of the microfluidic device, wherein the first droplet comprises one or more biological cells; merging the first droplet with a second droplet of aqueous medium to form a first combined droplet, wherein the second droplet comprises a cell lysing agent; incubating the first combined droplet upon the droplet actuation surface for a first period of time sufficient to lyse the one or more biological cells; and inactivating the cell lysing agent. In some embodiments, the microfluidic device further comprises a substrate having a dielectric layer and a first electrode configured to be connected to an AC voltage source, and a second electrode configured to be connected to the AC voltage source, wherein the dielectric layer is electrically coupled to the first electrode, wherein the droplet actuation surface comprises a hydrophobic layer covalently bonded to the dielectric layer, wherein the hydrophobic layer is a monolayer formed from molecules each comprising a surface modifying ligand and a linking group that links the surface modifying ligand to the surface, each molecule having a structure of:

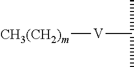

wherein: [symbol] is the surface; V is a linker; m is an integer of 9 or greater; and wherein, when the first electrode and the second electrode are connected to opposing terminals of the AC voltage source, the substrate is capable of applying an electrowetting force to aqueous droplets in contact with the droplet actuating surface. In some embodiments, V is —Si(OZ)₂W—; W is —O— and connects to the surface; and Z is a bond to an adjacent silicon atom attached to the surface or is a bond to the surface. In some embodiments, m is 15, 17 or 19. In some embodiments, the method further comprises filling the enclosure, or a portion thereof, with a first liquid medium which is immiscible with the first and second droplets, wherein the enclosure is filled with the first liquid medium prior to disposing the first droplet upon the droplet actuation surface, and wherein the first liquid medium comprises an organic liquid having branched carbon backbone. In some embodiments, the organic liquid is a carbonate or a hydrocarbon, such as bis(2-ethylhexyl) carbonate or heptamethylnonane. In some embodiments, the first droplet comprises a surfactant, such as a non-ionic surfactant, e.g., TET surfactant, N-(1,3-bis(Glucopyrano side)propan-2-yl)-3-Butyl-3-Cyclohexylheptanamide (Cy-Tripglu), or a polyethylene oxide-polypropylene oxide (PEO-PPO) block copolymer, optionally wherein the PEO-PPO block copolymer is a poloxamer. In some embodiments, the second droplet comprises a surfactant, such as a non-ionic surfactant having a polar head group of a size greater than 750 daltons. For example, the surfactant in the second droplet can be a polysorbate surfactant having a molecular weight of at least 1000 daltons (e.g., polysorbate 20). The methods can further comprise fragmenting DNA or reverse transcribing RNA from the one or more biological cells, and can further comprise amplifying the resultant fragmented DNA or cDNA. The methods can be performed on any of the microfluidic devices disclosed herein. For example, the microfluidic device can include an electrowetting configuration that includes a dielectric layer having an electrical impedance of about 50 kOhms to about 150 kOhms. The dielectric layer can be a single layer or a composite of multiple dielectric sub-layers, with at least the outermost dielectric sub-layer being formed by atomic layer deposition (ALD). In certain embodiments, one or more (e.g., all) internal surfaces of the microfluidic device can include an outer hydrophobic layer comprising self-associating molecules covalently bonded to the dielectric layer. In some embodiments, the method of processing biological cells is a method of preparing a nucleic acid library.

In some embodiments, a method of processing biological cells in a microfluidic device having an electrowetting configuration is provided. The method can comprise: disposing a first droplet of aqueous medium upon a droplet actuation surface of the microfluidic device, wherein the first droplet comprises one or more biological cells; merging the first droplet with a second droplet of aqueous medium to form a first combined droplet, wherein the second droplet comprises a cell lysing agent; incubating the first combined droplet upon the droplet actuation surface for a first period of time sufficient to lyse the one or more biological cells; and inactivating the cell lysing agent. In some embodiments, the microfluidic device further comprises a substrate having a dielectric layer and a first electrode configured to be connected to an AC voltage source, and a second electrode configured to be connected to the AC voltage source, wherein the dielectric layer is electrically coupled to the first electrode, wherein the droplet actuation surface comprises a hydrophobic layer covalently bonded to the dielectric layer, wherein the hydrophobic layer is a monolayer formed from molecules each comprising a surface modifying ligand and a linking group that links the surface modifying ligand to the surface, each molecule having a structure of:

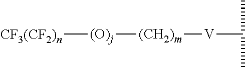

wherein: [symbol] is the surface; V is a linker; n+m+j is 13 or greater, n is 5 or greater, and m ranges from 2 to 13, and j is 0 or 1; and wherein, when the first electrode and the second electrode are connected to opposing terminals of the AC voltage source, the substrate is capable of applying an electrowetting force to aqueous droplets in contact with the droplet actuating surface. In some embodiments, V is —Si(OZ)₂W—; W is —O— and connects to the surface; and Z is a bond to an adjacent silicon atom attached to the surface or is a bond to the surface. In some embodiments, m is 2, and/or n is 11, 13, or 15. In some embodiments, the first droplet comprises a surfactant, such as a non-ionic surfactant, e.g., TET surfactant, N-(1,3-bis(Glucopyranoside)propan-2-yl)-3-Butyl-3-Cyclohexylheptanamide (Cy-Tripglu), or a polyethylene oxide-polypropylene oxide (PEO-PPO) block copolymer, optionally wherein the PEO-PPO block copolymer is a poloxamer. In some embodiments, the second droplet comprises a surfactant, such as a non-ionic surfactant having a polar head group of a size greater than 750 daltons. For example, the surfactant in the second droplet can be a polysorbate surfactant having a molecular weight of at least 1000 daltons (e.g., polysorbate 20). The methods can further comprise fragmenting DNA or reverse transcribing RNA from the one or more biological cells, and can further comprise amplifying the resultant fragmented DNA or cDNA. The methods can be performed on any of the microfluidic devices disclosed herein. For example, the microfluidic device can include an electrowetting configuration that includes a dielectric layer having an electrical impedance of about 50 kOhms to about 150 kOhms. The dielectric layer can be a single layer or a composite of multiple dielectric sub-layers, with at least the outermost dielectric sub-layer being formed by atomic layer deposition (ALD). In certain embodiments, one or more (e.g., all) internal surfaces of the microfluidic device can include an outer hydrophobic layer comprising self-associating molecules covalently bonded to the dielectric layer. In some embodiments, the method of processing biological cells is a method of preparing a nucleic acid library.

In some embodiments, a method of amplifying nucleic acid in a microfluidic device having an electrowetting configuration is provided. The method can comprise: disposing a first droplet of aqueous medium upon a droplet actuation surface of the microfluidic device, wherein the first droplet comprises nucleic acid; merging the first droplet with a second droplet of aqueous medium to form a combined droplet, wherein the second droplet comprises a nucleic acid polymerase, and wherein the combined droplet comprises a buffer and precursors (e.g., nucleotides, primers, etc.) that support a polymerase activity of the nucleic acid polymerase; and incubating the combined droplet upon the droplet actuation surface, under conditions that promote amplification of the nucleic acid originating from the first droplet. In some embodiments, the microfluidic device further comprises a substrate having a dielectric layer and a first electrode configured to be connected to an AC voltage source, and a second electrode configured to be connected to the AC voltage source, wherein the dielectric layer is electrically coupled to the first electrode, wherein the droplet actuation surface comprises a hydrophobic layer covalently bonded to the dielectric layer, and wherein, when the first electrode and the second electrode are connected to opposing terminals of the AC voltage source, the substrate is capable of applying an electrowetting force to aqueous droplets in contact with the droplet actuating surface. In some embodiments, incubating the combined droplet under conditions that promote amplification comprises adjusting the temperature of the microfluidic device to a first temperature that is sufficient to cause the nucleic acid originating from the first droplet to denature partially or fully. In some embodiments, incubating the combined droplet under conditions that promote amplification further comprises adjusting the temperature of the microfluidic device to a second temperature that promotes priming of the nucleic acid originating from the first droplet and/or the template-based extension of the primed nucleic acid. In some embodiments, the first droplet comprises a surfactant, such as a non-ionic surfactant, e.g., TET surfactant, N-(1,3-bis(Glucopyranoside)propan-2-yl)-3-Butyl-3-Cyclohexylheptanamide (Cy-Tripglu), or a polyethylene oxide-polypropylene oxide (PEO-PPO) block copolymer, optionally wherein the PEO-PPO block copolymer is a poloxamer. In some embodiments, the second droplet comprises a surfactant, such as a non-ionic surfactant, e.g., a polysorbate surfactant having a molecular weight of at least 1000 daltons, optionally polysorbate 20, or a polyethylene oxide-polypropylene oxide (PEO-PPO) block copolymer, optionally a poloxamer. The methods can be performed on any of the microfluidic devices disclosed herein. For example, the microfluidic device can include an electrowetting configuration that includes a dielectric layer having an electrical impedance of about 50 kOhms to about 150 kOhms. The dielectric layer can be a single layer or a composite of multiple dielectric sub-layers, with at least the outermost dielectric sub-layer being formed by atomic layer deposition (ALD). In certain embodiments, one or more (e.g., all) internal surfaces of the microfluidic device can include an outer hydrophobic layer comprising self-associating molecules covalently bonded to the dielectric layer. The self-associating molecules can include, for example, a linking group and a surface modifying ligand. The linking group can be, for example, a siloxane group or a phosphonic acid group. The surface modifying ligand can be, for example, a linear alkane group or a linear fluoroalkane group.

In some embodiments, a system for operating a microfluidic device is provided. The system can comprise: a support configured to hold and operatively couple with a micro fluidic device, the support comprising an electrical signal generation subsystem configured to selectively apply a biasing voltage across a pair of electrodes in the microfluidic device when the microfluidic device is held by, and operatively coupled with, the support; a thermal control subsystem configured to regulate a temperature of the microfluidic device when the microfluidic device is held by, and operably coupled with, the support, the thermal control subsystem comprising a thermal control circuit, a thermistor, and a Peltier thermoelectric device, wherein the thermistor is positioned in the support and configured to measure the temperature of a location at or proximal to a surface of the microfluidic device, wherein the Peltier thermoelectric device is configured to interface with the surface of the microfluidic device, and wherein the thermal control circuit is configured to follow rules correlating a temperature value measured by the thermistor with a target temperature and a power output of Peltier thermoelectric device. In certain embodiments, the rules comprise: setting the power output of the Peltier thermoelectric device to a first value if the difference between the target temperature and the thermistor-measured temperature is larger than N; setting the power output of the Peltier thermoelectric device to a second value lower than the first value if the difference between the target temperature and the thermistor-measured temperature is equal to or smaller than N and larger than M; and determining the power output of the Peltier thermoelectric device by a proportionate-integral-derivative (PID) loop controller with the thermistor-measured temperature as an input if the difference between the target temperature and the thermistor-measured temperature is smaller than or equal to M. In certain embodiments, M is in the range of 5° C. to 15° C. (e.g., about 7° C. to about 13° C., or about 8° C. to about 12° C., or about 9° C. to about 11° C.) and N is in the range of 1° C. to 5° C. (e.g., about 2° C. to about 4° C. or about 2.5° C. to about 3.5° C.). In some embodiments, the first value is in the range of 70% to 100% power output of the Peltier thermoelectric device. In some embodiments, the second value is a power output value determined from calibration data correlating a plurality of target temperature values with a plurality of power output values, optionally wherein: the target temperature values correlated to the power output values were determined by equilibrating a calibration chip comprising a thermocouple with the Peltier thermoelectric device at each of the power output values and associating the temperature registered by the thermocouple following equilibration with the power output value; and/or the plurality of target temperature values comprises at least 4, 5, 6, 7, 8, 9, or 10 values in the range of 0° C. to 100° C., optionally wherein a power output value corresponding to a target temperature value between values represented in the calibration data is determined by linear interpolation. The microfluidic device can be any of the microfluidic devices disclosed herein.

Additional aspects and embodiments of the invention will be evident from the drawings and the detailed description that follows.

### BRIEF DESCRIPTION OF THE DRAWINGS

FIG. 1A illustrates a generalized microfluidic device and a system with associated control equipment for controlling and monitoring the microfluidic device, according to some embodiments of the disclosure.

FIG. 1B is a vertical cross-sectional view of a microfluidic apparatus having a substrate, a cover, and a spacing element which together form an enclosure configured to hold a liquid medium and droplets of a liquid immiscible in the liquid medium. The substrate has an electrowetting configuration that allows the droplets to be manipulated within the enclosure.

FIGS. 1C and 1D illustrate a dielectric layer of a microfluidic device according to some embodiments of the disclosure.

FIGS. 1E and 1F illustrate a microfluidic device according to some embodiments of the disclosure.

FIGS. 2A and 2B illustrate isolation pens according to some embodiments of the disclosure.

FIG. 2C illustrates a detailed sequestration pen according to some embodiments of the disclosure.

FIG. 2D illustrate sequestration pens according to some other embodiments of the disclosure.

FIG. 2E illustrates a coated surface of the microfluidic device according to an embodiment of the disclosure.

FIG. 2F illustrates a microfluidic device according to an embodiment of the disclosure.

FIG. 3A illustrates a specific example of a system for use with a microfluidic device and associated control equipment according to some embodiments of the disclosure.

FIG. 3B illustrates an imaging device according to some embodiments of the disclosure.

FIG. 4 illustrates an example of a microfluidic device having an EW configuration and a DEP configuration with a duolithic substrate.

FIG. 5 illustrates an example of a microfluidic device having an EW configuration and a DEP configuration with a monolithic substrate.

FIG. 6A is a view of an electrical addressing operational representation for one functional aspect of a substrate of a microfluidic device according to some embodiments of the disclosure.

FIG. 6B is a view of an electrical addressing operational representation for one functional aspect of a substrate of a microfluidic device according to some embodiments of the disclosure.

FIGS. 7A-7C are photographic representations of the movement of an aqueous droplet on a modified microfluidic surface according to an embodiment of the disclosure.

FIG. 7D is a photographic representation of droplets having a precise volume formed within a system according to an embodiment of the disclosure.

FIG. 8 is a horizontal cross-sectional view of a microfluidic apparatus, which can comprise an electrowetting configuration as shown in FIG. 1B, and which includes multiple microfluidic channels, chambers that open off of at least one of the microfluidic channels, and a droplet generator. In this embodiment, one microfluidic channel contains an aqueous medium (lighter color), while the microfluidic channel connected to the droplet generator contains a non-aqueous medium (darker color). The chambers likewise contain either an aqueous medium or a non-aqueous medium.

FIG. 9 is a horizontal cross-sectional view of a microfluidic apparatus, which can comprise an electrowetting configuration as shown in FIG. 1B, and which includes multiple microfluidic channels, chambers that open off of at least one of the microfluidic channels, and a droplet generator. In this embodiment, one microfluidic channel and a first set of chambers contains an aqueous medium (lighter color), while the microfluidic channel connected to the droplet generator and a second set of chambers contains a hydrophobic medium (darker color). FIG. 9 presents a variation on the embodiment shown in FIG. 8, wherein each chamber that contains an aqueous medium is located directly across the channel with the hydrophobic medium from a corresponding chamber that contains hydrophobic medium.

FIG. 10 is a diagram of a method of processing biological micro-objects within a microfluidic apparatus.

FIG. 11 is a schematic representation of a method for generating a sequencing library according to an embodiment of the disclosure.

FIG. 12 is a photographic representation of merging a first droplet containing a single cell with a second droplet containing a cell lysing agent to form a combined droplet, and incubating the combined droplet to achieve lysis of the single cell according to an embodiment of the disclosure. The arrow indicates the position of the cell in the first droplet and the combined droplet. The cell disappears in the combined droplet during the course of the incubation.

FIG. 13 is a schematic representation of a method of preparing suitably sized nucleic acid fragments for sequencing according to an embodiment of the disclosure.

FIG. 14 is a photographic representation of droplets staged for use in a method of preparing suitably sized nucleic acid fragments for sequencing according to another embodiment of the disclosure.

FIG. 15 is a schematic representation of adapters used for nucleic acid amplification in of a method for preparing a DNA library according to another embodiment of the disclosure.

FIG. 16 is a schematic representation of droplets having either nucleic acid fragments or adapters, wherein the droplets are staged within corresponding sequestration pens for use in a method of amplifying and/or barcoding nucleic acids in an embodiment of the disclosure.

FIG. 17 is a photographic representation of a method for on chip quantification of an amount of nucleic acid in a droplet according to an embodiment of the disclosure.

FIG. 18 is a photographic representation of a method of amplifying nucleic acids present in droplets located in a microfluidic device according to an embodiment of the disclosure.

FIG. 19 is a graph showing the brightness of a droplet containing nucleic acid as a function of on chip amplification cycle according to an embodiment of the disclosure.

FIG. 20 is a graphic display of temperature readings obtained from a system programed to cycle the temperature of a microfluidic device for a method for nucleic acid amplification according to an embodiment of the disclosure.

FIG. 21 is a set of graphical representations, each showing the size distribution of nucleic acid fragments resulting from the on chip fragmentation of genomic DNA according to various embodiments of the disclosure.

FIG. 22 is a graphical representation of off chip qPCR results obtained for nucleic acid samples that were (i) previously amplified on chip for 30 cycles or (ii) previously amplified on chip for 30 cycles, then diluted six fold, according to another embodiment of the disclosure. The qPCR samples are compared to various controls, including a nucleic acid sample that was previously amplified off chip for 30 cycles, a nucleic acid sample that was exported from a microfluidic chip without previous amplification, and a no template control.

FIGS. 23A-23C are a graphical representation the size distribution of nucleic acid fragments resulting from a method of on chip amplification according to various embodiments of the disclosure. The nucleic acid fragments in FIGS. 23A and 23B were prepared off chip, then amplified on chip, which the nucleic acid fragments in FIG. 23C were prepared on chip and amplified on chip. All samples were further amplified off chip prior to size distribution analysis, according to certain embodiments of the disclosure.

FIGS. 24A-24B are graphical representations comparing two methods of nucleic acid fragmentation and amplification to generate a DNA sequencing library according to certain embodiments of the disclosure.

FIGS. 25A-25B are graphical representations comparing two methods of nucleic acid fragmentation and amplification to generate a DNA sequencing library according to certain embodiments of the disclosure.

FIGS. 26A-26B are graphical representations comparing two methods of nucleic acid fragmentation and amplification to generate a DNA sequencing library according to certain embodiments of the disclosure.

FIG. 27 is a graphical representation comparing two methods of nucleic acid fragmentation and amplification to generate a DNA sequencing library according to certain embodiments of the disclosure.

FIG. 28 is a photographic representation of an agarose gel showing cDNA obtained by a method of on chip reverse transcription according to an embodiment of the disclosure.

FIGS. 29A and 29B are graphical representations of the size of cDNA molecules obtained by a method of on chip reverse transcription according to the embodiment of FIG. 28.

FIG. 30 is a graphical representation of a nucleic acid sequencing library sample obtained from cDNA prepared on chip according to an embodiment of the disclosure.

FIG. 31 is a graphical representation of sequencing results for nucleic acid sequencing library samples obtained from cDNA prepared on chip, including the sample of FIG. 30, according to an embodiment of the disclosure.

FIG. 32A shows thermistor and thermocouple temperature measurements when a Peltier was set to heat a calibration chip at full power. Vertical axis, ° C. Horizontal axis, time (seconds).

FIG. 32B shows thermistor and thermocouple temperature measurements when a Peltier was set to cool a calibration chip at full power. Vertical axis, ° C. Horizontal axis, time (seconds).

FIG. 33A shows thermistor and thermocouple temperature measurements when a Peltier was set to heat a calibration chip using a three-stage temperature control procedure as described herein. Vertical axis, ° C. Horizontal axis, time (seconds).

FIG. 33B shows thermistor and thermocouple temperature measurements when a Peltier was set to heat a calibration chip using a three-stage temperature control procedure as described herein. Vertical axis, ° C. Horizontal axis, time (seconds).

FIG. 34 shows thermistor and thermocouple temperature measurements when a Peltier was set to heat and cool a calibration chip to a series of target temperatures as indicated using a three-stage temperature control procedure according to an embodiment of the disclosure. The PID status data indicates when the PID algorithm was disengaged (at 0) or engaged (at values matching the target temperatures). Vertical axis, ° C. Horizontal axis, time (seconds).

FIG. 35 shows thermistor and thermocouple temperature measurements from a further experiment wherein a Peltier was set to heat and cool a calibration chip to a series of target temperatures as indicated using a three-stage temperature control procedure according to an embodiment of the disclosure. Vertical axis, ° C. Horizontal axis, time (seconds).

### DETAILED DESCRIPTION OF CERTAIN EMBODIMENTS

This specification describes exemplary embodiments and applications of the disclosure. The disclosure, however, is not limited to these exemplary embodiments and applications or to the manner in which the exemplary embodiments and applications operate or are described herein. Moreover, the figures may show simplified or partial views, and the dimensions of elements in the figures may be exaggerated or otherwise not in proportion. Section headings are provided for the convenience of the reader and do not limit the scope of the disclosure.

### I. DEFINITIONS

As the terms “on,” “attached to,” “connected to,” “coupled to,” or similar words are used herein, one element (e.g., a material, a layer, a substrate, etc.) can be “on,” “attached to,” “connected to,” or “coupled to” another element regardless of whether the one element is directly on, attached to, connected to, or coupled to the other element or there are one or more intervening elements between the one element and the other element. Also, unless the context dictates otherwise, directions (e.g., above, below, top, bottom, side, up, down, under, over, upper, lower, horizontal, vertical, “x,” “y,” “z,” etc.), if provided, are relative and provided solely by way of example and for ease of illustration and discussion and not by way of limitation. In addition, where reference is made to a list of elements (e.g., elements a, b, c), such reference is intended to include any one of the listed elements by itself, any combination of less than all of the listed elements, and/or a combination of all of the listed elements. Section divisions in the specification are for ease of review only and do not limit any combination of elements discussed.

As used herein, “substantially” means sufficient to work for the intended purpose. The term “substantially” thus allows for minor, insignificant variations from an absolute or perfect state, dimension, measurement, result, or the like such as would be expected by a person of ordinary skill in the field but that do not appreciably affect overall performance. When used with respect to numerical values or parameters or characteristics that can be expressed as numerical values, “substantially” means within ten percent.

The term “ones” means more than one.

As used herein, the term “plurality” can be 2, 3, 4, 5, 6, 7, 8, 9, 10, or more.

As used herein, the term “disposed” encompasses within its meaning “located.”

As used herein, a “microfluidic device” or “microfluidic apparatus” is a device that includes one or more discrete microfluidic circuits configured to hold a fluid, each microfluidic circuit comprised of fluidically interconnected circuit elements, including but not limited to region(s), flow region(s), channel(s), chamber(s), and/or pen(s), and (for microfluidic device that include a cover) at least two ports configured to allow the fluid (and, optionally, micro-objects suspended in the fluid) to flow into and/or out of the microfluidic device. Typically, a microfluidic circuit of a microfluidic device will include at least one microfluidic channel and at least one chamber, and will hold a volume of fluid of less than about 1 mL, e.g., less than about 750, 500, 250, 200, 150, 100, 75, 50, 25, 20, 15, 10, 9, 8, 7, 6, 5, 4, 3, or 2 μL. In certain embodiments, the microfluidic circuit holds about 1-2, 1-3, 1-4, 1-5, 2-5, 2-8, 2-10, 2-12, 2-15, 2-20, 5-20, 5-30, 5-40, 5-50, 10-50, 10-75, 10-100, 20-100, 20-150, 20-200, 50-200, 50-250, or 50-300 μL.

As used herein, a “nanofluidic device” or “nanofluidic apparatus” is a type of microfluidic device having a microfluidic circuit that contains at least one circuit element configured to hold a volume of fluid of less than about 1 μL, e.g., less than about 750, 500, 250, 200, 150, 100, 75, 50, 25, 20, 15, 10, 9, 8, 7, 6, 5, 4, 3, 2, 1 nL or less. A nanofluidic device may comprise a plurality of circuit elements (e.g., at least 2, 3, 4, 5, 6, 7, 8, 9, 10, 15, 20, 25, 50, 75, 100, 150, 200, 250, 300, 400, 500, 600, 700, 800, 900, 1000, 1500, 2000, 2500, 3000, 3500, 4000, 4500, 5000, 6000, 7000, 8000, 9000, 10,000, or more). In certain embodiments, one or more (e.g., all) of the at least one circuit elements is configured to hold a volume of fluid of about 100 pL to 1 nL, 100 pL to 2 nL, 100 pL to 5 nL, 250 pL to 2 nL, 250 pL to 5 nL, 250 pL to 10 nL, 500 pL to 5 nL, 500 pL to 10 nL, 500 pL to 15 nL, 750 pL to 10 nL, 750 pL to 15 nL, 750 pL to 20 nL, 1 to 10 nL, 1 to 15 nL, 1 to 20 nL, 1 to 25 nL, or 1 to 50 nL. In other embodiments, one or more (e.g., all) of the at least one circuit elements is configured to hold a volume of fluid of about 20 nL to 200 nL, 100 to 200 nL, 100 to 300 nL, 100 to 400 nL, 100 to 500 nL, 200 to 300 nL, 200 to 400 nL, 200 to 500 nL, 200 to 600 nL, 200 to 700 nL, 250 to 400 nL, 250 to 500 nL, 250 to 600 nL, or 250 to 750 nL.

A “microfluidic channel” or “flow channel” as used herein refers to a flow region of a microfluidic device having a length that is significantly longer than both the horizontal and vertical dimensions. For example, the flow channel can be at least 5 times the length of either the horizontal or vertical dimension, e.g., at least 10 times the length, at least 25 times the length, at least 100 times the length, at least 200 times the length, at least 500 times the length, at least 1,000 times the length, at least 5,000 times the length, or longer. In some embodiments, the length of a flow channel is in the range of from about 50,000 microns to about 500,000 microns, including any range therebetween. In some embodiments, the horizontal dimension is in the range of from about 100 microns to about 1000 microns (e.g., about 150 to about 500 microns) and the vertical dimension is in the range of from about 25 microns to about 200 microns, e.g., from about 40 to about 150 microns. It is noted that a flow channel may have a variety of different spatial configurations in a microfluidic device, and thus is not restricted to a perfectly linear element. For example, a flow channel may include one or more sections having any of the following configurations: curve, bend, spiral, incline, decline, fork (e.g., multiple different flow paths), and any combination thereof. In addition, a flow channel may have different cross-sectional areas along its path, widening and constricting to provide a desired fluid flow therein.

As used herein, the term “obstruction” refers generally to a bump or similar type of structure that is sufficiently large so as to partially (but not completely) impede movement of target micro-objects between two different regions or circuit elements in a microfluidic device. The two different regions/circuit elements can be, for example, a microfluidic sequestration pen and a microfluidic channel, or a connection region and an isolation region of a microfluidic sequestration pen.

As used herein, the term “constriction” refers generally to a narrowing of a width of a circuit element (or an interface between two circuit elements) in a microfluidic device. The constriction can be located, for example, at the interface between a microfluidic sequestration pen and a microfluidic channel, or at the interface between an isolation region and a connection region of a microfluidic sequestration pen.

As used herein, the term “transparent” refers to a material which allows visible light to pass through without substantially altering the light as is passes through.

As used herein, the term “micro-object” refers generally to any microscopic object that may be isolated and collected in accordance with the present disclosure. Non-limiting examples of micro-objects include: inanimate micro-objects such as microparticles; microbeads (e.g., polystyrene beads, Luminex™ beads, or the like); magnetic beads; microrods; microwires; quantum dots, and the like; biological micro-objects such as cells (e.g., embryos, oocytes, ova, sperm cells, cells dissociated from a tissue, eukaryotic cells, protist cells, animal cells, mammalian cells, human cells, immunological cells, hybridomas, cultured cells, cells from a cell line, cancer cells, infected cells, transfected and/or transformed cells, reporter cells, prokaryotic cells, and the like); biological organelles; vesicles, or complexes; synthetic vesicles; liposomes (e.g., synthetic or derived from membrane preparations); lipid nanorafts (as described in Ritchie et al. (2009) “Reconstitution of Membrane Proteins in Phospholipid Bilayer Nanodiscs,” Methods Enzymol., 464:211-231), and the like; or a combination of inanimate micro-objects and biological micro-objects (e.g., microbeads attached to cells, liposome-coated micro-beads, liposome-coated magnetic beads, or the like). Beads may further have other moieties/molecules covalently or non-covalently attached, such as fluorescent labels, proteins, small molecule signaling moieties, antigens, or chemical/biological species capable of use in an assay.

As used herein, the term “maintaining (a) cell(s)” refers to providing an environment comprising both fluidic and gaseous components and, optionally a surface, that provides the conditions necessary to keep the cells viable and/or expanding.

A “component” of a fluidic medium is any chemical or biochemical molecule present in the medium, including solvent molecules, ions, small molecules, antibiotics, nucleotides and nucleosides, nucleic acids, amino acids, peptides, proteins, sugars, carbohydrates, lipids, fatty acids, cholesterol, metabolites, or the like.

As used herein in reference to a fluidic medium, “diffuse” and “diffusion” refer to thermodynamic movement of a component of the fluidic medium down a concentration gradient.

The phrase “flow of a medium” means bulk movement of a fluidic medium primarily due to any mechanism other than diffusion. For example, flow of a medium can involve movement of the fluidic medium from one point to another point due to a pressure differential between the points. Such flow can include a continuous, pulsed, periodic, random, intermittent, or reciprocating flow of the liquid, or any combination thereof. When one fluidic medium flows into another fluidic medium, turbulence and mixing of the media can result.

The phrase “substantially no flow” refers to a rate of flow of a fluidic medium that, averaged over time, is less than the rate of diffusion of components of a material (e.g., an analyte of interest) into or within the fluidic medium. The rate of diffusion of components of such a material can depend on, for example, temperature, the size of the components, and the strength of interactions between the components and the fluidic medium.

As used herein in reference to different regions within a microfluidic device, the phrase “fluidically connected” means that, when the different regions are substantially filled with fluid, such as fluidic media, the fluid in each of the regions is connected so as to form a single body of fluid. This does not mean that the fluids (or fluidic media) in the different regions are necessarily identical in composition. Rather, the fluids in different fluidically connected regions of a microfluidic device can have different compositions (e.g., different concentrations of solutes, such as proteins, carbohydrates, ions, or other molecules) which are in flux as solutes move down their respective concentration gradients and/or fluids flow through the device.

A microfluidic (or nanofluidic) device can comprise “swept” regions and “unswept” regions. As used herein, a “swept” region is comprised of one or more fluidically interconnected circuit elements of a microfluidic circuit, each of which experiences a flow of medium when fluid is flowing through the microfluidic circuit. The circuit elements of a swept region can include, for example, regions, channels, and all or parts of chambers. As used herein, an “unswept” region is comprised of one or more fluidically interconnected circuit element of a microfluidic circuit, each of which experiences substantially no flux of fluid when fluid is flowing through the microfluidic circuit. An unswept region can be fluidically connected to a swept region, provided the fluidic connections are structured to enable diffusion but substantially no flow of media between the swept region and the unswept region. The microfluidic device can thus be structured to substantially isolate an unswept region from a flow of medium in a swept region, while enabling substantially only diffusive fluidic communication between the swept region and the unswept region. For example, a flow channel of a microfluidic device is an example of a swept region while an isolation region (described in further detail below) of a microfluidic device is an example of an unswept region.

As used herein, a “flow region” refers to one or more fluidically connected circuit elements (e.g. channel(s), region(s), chamber(s) and the like) that define, and are subject to, the trajectory of a flow of medium. A flow region is thus an example of a swept region of a microfluidic device. Other circuit elements (e.g., unswept regions) may be fluidically connected with the circuit elements that comprise the flow region without being subject to the flow of medium in the flow region.

As used herein, “alkyl” refers to a straight or branched hydrocarbon chain radical consisting solely of carbon and hydrogen atoms, containing no unsaturation, having from one to six carbon atoms (e.g., C1-C6 alkyl). Whenever it appears herein, a numerical range such as “1 to 6” refers to each integer in the given range; e.g., “1 to 6 carbon atoms” means that the alkyl group may consist of 1 carbon atom, 2 carbon atoms, 3 carbon atoms, etc., up to and including 6 carbon atoms, although the present definition also covers the occurrence of the term “alkyl” where no numerical range is designated. In some embodiments, it is a C1-C3 alkyl group. Typical alkyl groups include, but are in no way limited to, methyl, ethyl, propyl, isopropyl, n-butyl, iso-butyl, sec-butyl isobutyl, tertiary butyl, pentyl, isopentyl, neopentyl, hexyl, and the like. The alkyl is attached to the rest of the molecule by a single bond, for example, methyl (Me), ethyl (Et), n-propyl, 1-methylethyl (iso-propyl), n-butyl, n-pentyl, 1,1-dimethylethyl (t-butyl), hexyl, and the like.

Unless stated otherwise specifically in the specification, an alkyl group may be optionally substituted by one or more substituents which independently are: aryl, arylalkyl, heteroaryl, heteroarylalkyl, hydroxy, halo, cyano, trifluoromethyl, trifluoromethoxy, nitro, trimethylsilanyl, —OR′, SR′, —OC(O)—R′, —N(R′)₂, —C(O)R′, C(O)OR′, —OC(O)N(R′)₂, —C(O)N(R′)₂, —N(R′)C(O)OR′, —N(R′)C(O)R′, —N(R′)C(O)N(R′)₂, N(R′)C(NR′)N(R′)₂, —N(R′)S(O)ₜR′(where t is 1 or 2), —S(O)ₜOR′(where t is 1 or 2), —S(O)ₜN(R′)₂ (where t is 1 or 2), or PO₃(R′)₂ where each R′ is independently hydrogen, alkyl, fluoroalkyl, aryl, aralkyl, heterocycloalkyl, or heteroaryl.

As referred to herein, a fluorinated alkyl moiety is an alkyl moiety having one or more hydrogens of the alkyl moiety replaced by a fluoro substituent. A perfluorinated alkyl moiety has all hydrogens attached to the alkyl moiety replaced by fluoro substituents.

As referred to herein, a “halo” moiety is a bromo, chloro, or fluoro moiety.

As referred to herein, an “olefinic” compound is an organic molecule which contains an “alkene” moiety. An alkene moiety refers to a group consisting of at least two carbon atoms and at least one carbon-carbon double bond. The non-alkene portion of the molecule may be any class of organic molecule, and in some embodiments, may include alkyl or fluorinated (including but not limited to perfluorinated) alkyl moieties, any of which may be further substituted.

As used herein, a “densely packed hydrophobic monolayer” refers to a single layer of hydrophobic molecules that are packed sufficiently close together so as to resist intercalation and/or intrusion of polar molecules, such as water, ions, and other charged species.

As used herein, a “surfactant” refers to a molecule or population of molecules (e.g., a polymer or population of molecules with a polymeric component, wherein the length of the polymer or polymeric component may vary) comprising polar and non-polar moieties. The polar moiety can be nonionic, anionic, cationic, or zwitterionic and may be referred to as a head group. The presence of a surfactant in aqueous solution generally substantially lowers surface tension. Which parts of a surfactant form the head group and the hydrophobic moiety will generally be immediately apparent to one skilled in the art, in that the polar head group comprises hydrogen bond donors and/or acceptors or charged groups, whereas the hydrophobic moiety generally does not (e.g., as in a hydrocarbon chain). For example, in the surfactants sodium dodecyl sulfate and octylglucoside, the sodium sulfate and the glucoside are the polar head groups, while the dodecyl and octyl are the hydrophobic moieties.

As used herein: “μm” (or “um”) means micrometer; “μm³” means cubic micrometer; “pL” means picoliter, “nL” means nanoliter; and “μL” (or “uL”) means microliter.

The term “or” is used in an inclusive sense, i.e., equivalent to “and/or,” unless the context dictates otherwise.

### II. MICROFLUIDIC DEVICES, IMMISCIBLE MEDIUM, AND SURFACTANTS IN DROPLETS

Methods described herein can comprise synthesizing or amplifying nucleic acid and/or preparing nucleic acid libraries in microfluidic devices. Suitable microfluidic devices and related procedures are described below.

A. Methods of Loading into Microfluidic Devices.

Loading of micro-objects, such as biological micro-objects and/or beads, into different regions of a microfluidic device can involve the use of fluid flow, gravity, a dielectrophoresis (DEP) force, an electrowetting force, a magnetic force, or any combination thereof as described herein. The DEP force can be generated optically, such as by an optoelectronic tweezers (OET) configuration and/or electrically, such as by activation of electrodes/electrode regions in a temporal/spatial pattern. Similarly, the electrowetting force may be provided optically, such as by an opto-electro wetting (OEW) configuration and/or electrically, such as by activation of electrodes/electrode regions in a temporal spatial pattern.

B. Microfluidic Devices and Systems for Operating and Observing such Devices.

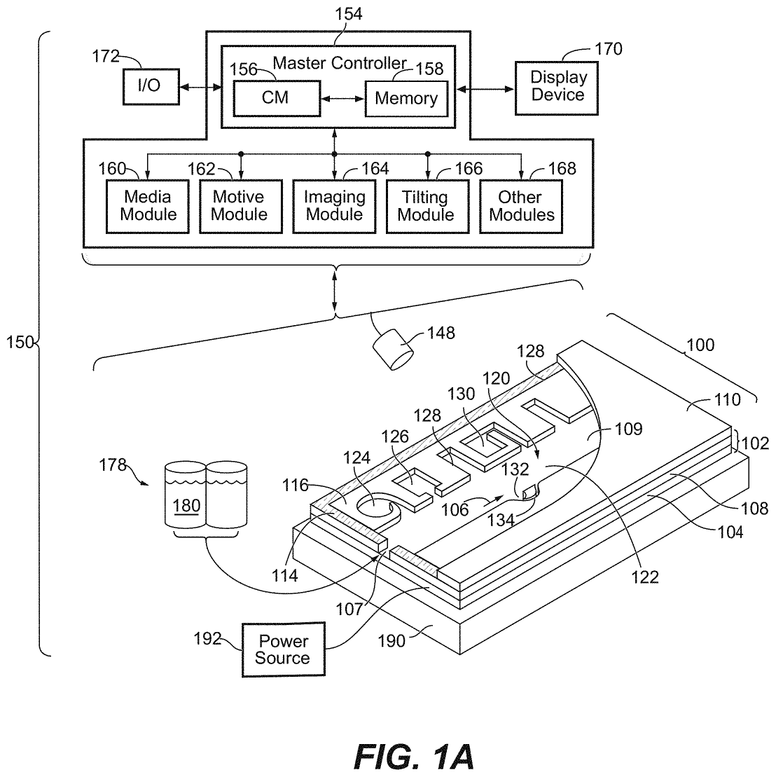

FIG. 1A illustrates a generalized example of a microfluidic device 100 and a system 150 which can be used to control the microfluidic device 100 and the movement of micro-objects and/or droplet therein. A perspective view of the microfluidic device 100 is shown having a partial cut-away of its cover 110 to provide a partial view into the microfluidic device 100. The microfluidic device 100 generally comprises a microfluidic circuit 120 comprising a flow region 106 through which a fluidic medium 180 can flow, optionally carrying one or more micro-objects (not shown) into and/or through the microfluidic circuit 120. Although a single microfluidic circuit 120 is illustrated in FIG. 1A, suitable microfluidic devices can include a plurality (e.g., 2 or 3) of such microfluidic circuits. Regardless, the microfluidic device 100 can be configured to be a nanofluidic device.

In some embodiments, the microfluidic device can include an enclosure having at least one microfluidic channel. In addition, the enclosure can include at least one microfluidic chamber (or sequestration pen) fluidically connected to the microfluidic channel. At least a portion of the substrate that defines the microchannel and/or the chamber can have an electrowetting configuration as described herein. The electrowetting configuration can be connected to a biasing potential and, while thus connected, change an effective wetting characteristic of any of a plurality of corresponding regions of the substrate surface (i.e., the droplet actuating surface). The wetting characteristic of the substrate surface can be changed sufficiently to move a liquid droplet across the substrate surface and between the microfluidic channel and the chamber. In the embodiment illustrated in FIG. 1A, the microfluidic circuit 120 comprises a plurality of microfluidic sequestration pens 124, 126, 128, and 130, each having a single opening in fluidic communication with flow region 106. As discussed further below, the microfluidic sequestration pens comprise various features and structures that have been optimized for retaining micro-objects in the microfluidic device, such as microfluidic device 100, even when a medium 180 is flowing through the flow region 106. Before turning to the foregoing, however, a brief description of microfluidic device 100 and system 150 is provided.

As generally illustrated in FIG. 1A, the microfluidic circuit 120 is defined by an enclosure 102. Although the enclosure 102 can be physically structured in different configurations, in the example shown in FIG. 1A the enclosure 102 is depicted as comprising a support structure 104 (e.g., a base), a microfluidic circuit structure 108, and a cover 110. In certain embodiments, however, the enclosure 102 may lack the cover 110 and the microfluidic circuit 120 may be defined by the support structure 104 and the microfluidic circuit structure 108. The support structure 104, the microfluidic circuit structure 108, and (optionally) the cover 110 can be attached to each other. For example, the microfluidic circuit structure 108 can be disposed on an inner surface 109 of the support structure 104, and the cover 110 can be disposed over the microfluidic circuit structure 108. Together with the support structure 104 and (optionally) the cover 110, the microfluidic circuit structure 108 can define the elements of the microfluidic circuit 120.

The support structure 104 can be at the bottom and the cover 110 at the top of the microfluidic circuit 120, as illustrated in FIG. 1A. Alternatively, the support structure 104 and the cover 110 can be configured in other orientations. For example, the support structure 104 can be at the top and the cover 110 at the bottom of the microfluidic circuit 120. Regardless, there can be one or more ports 107 each comprising a passage into or out of the enclosure 102. Examples of a passage include a valve, a gate, a pass-through hole, or the like. As illustrated, port 107 is a pass-through hole created by a gap in the microfluidic circuit structure 108. However, the port 107 can be situated in other components of the enclosure 102, such as the cover 110. Only one port 107 is illustrated in FIG. 1A, but the microfluidic circuit 120 can have two or more ports 107. For example, there can be a first port 107 that functions as an inlet for fluid entering the microfluidic circuit 120, and there can be a second port 107 that functions as an outlet for fluid exiting the microfluidic circuit 120. Whether a port 107 function as an inlet or an outlet can depend upon the direction that fluid flows through flow region 106.

The support structure 104 can comprise one or more electrodes (not shown) and a substrate or a plurality of interconnected substrates. The substrate can be any suitable substrate known in the art. For example, the support structure 104 can comprise one or more semiconductor substrates, each of which is electrically connected to at least one of the one or more electrodes (e.g., all or a subset of the semiconductor substrates can be electrically connected to a single electrode). Alternatively, the support structure 104 can comprise a printed circuit board assembly (“PCBA”) which comprises the one or more electrodes. In still other embodiments, the support structure 104 can comprise a substrate (e.g., a semiconductor substrate) which is mounted on a PCBA.

The microfluidic circuit structure 108 can define circuit elements of the microfluidic circuit 120. Such circuit elements can comprise spaces or regions that can be fluidly interconnected when microfluidic circuit 120 is filled with fluid, such as flow regions (which may include or be one or more flow channels), chambers, pens, traps, and the like. In the microfluidic circuit 120 illustrated in FIG. 1A, the microfluidic circuit structure 108 comprises a frame 114 and a microfluidic circuit material 116. The frame 114 can partially or completely enclose the microfluidic circuit material 116. The frame 114 can be, for example, a relatively rigid structure substantially surrounding the microfluidic circuit material 116. For example, the frame 114 can comprise a metal material. Alternatively, the microfluidic circuit structure 108 can lack a frame. For example, the microfluidic circuit structure 108 can consist of or consist essentially of the microfluidic circuit material 116.

The microfluidic circuit material 116 can be patterned with cavities or the like to define circuit elements and interconnections of the microfluidic circuit 120. The microfluidic circuit material 116 can comprise a flexible material, such as a flexible polymer (e.g. rubber, plastic, elastomer, silicone, polydimethylsiloxane (“PDMS”), or the like), which can be gas permeable. Other examples of materials that can compose microfluidic circuit material 116 include molded glass, an etchable material such as silicone (e.g. photo-patternable silicone or “PPS”), photo-resist (e.g., SU8), or the like. In some embodiments, such materials—and thus the microfluidic circuit material 116—can be rigid and/or substantially impermeable to gas. Regardless, the microfluidic circuit material 116 can be disposed on the support structure 104 and (optionally) inside the frame 114.

The cover 110 can be an integral part of the microfluidic circuit material 116 and/or the frame 114. Alternatively, the cover 110 can be a structurally distinct element, as illustrated in FIG. 1A. The cover 110 can comprise the same or different materials as the frame 114 and/or the microfluidic circuit material 116. Similarly, the support structure 104 can be a separate structure from the microfluidic circuit material 116 or the frame 114, as illustrated, or an integral part of the microfluidic circuit material 116 or frame 114. Likewise, the microfluidic circuit material 116 and the frame 114, if present, can be separate structures as shown in FIG. 1A or integral portions of the same structure.

In some embodiments, the cover 110 can comprise a rigid material. The rigid material may be glass or a material with similar properties. In some embodiments, the cover 110 can comprise a deformable material. The deformable material can be a polymer, such as PDMS. In some embodiments, the cover 110 can comprise both rigid and deformable materials. For example, one or more portions of cover 110 (e.g., one or more portions positioned over sequestration pens 124, 126, 128, 130) can comprise a deformable material that interfaces with rigid materials of the cover 110. In some embodiments, the cover 110 can further include one or more electrodes. The one or more electrodes can comprise a conductive oxide, such as indium-tin-oxide (ITO), which may be coated on glass or a similarly insulating material. Alternatively, the one or more electrodes can be flexible electrodes, such as single-walled nanotubes, multi-walled nanotubes, nanowires, clusters of electrically conductive nanoparticles, or combinations thereof, embedded in a deformable material, such as a polymer (e.g., PDMS). Flexible electrodes that can be used in microfluidic devices have been described, for example, in U.S. 2012/0325665 (Chiou et al.), the contents of which are incorporated herein by reference. In some embodiments, the cover 110 can be modified (e.g., by coating or conditioning all or part of a surface that faces inward toward the microfluidic circuit 120) to support droplet movement and/or cell adhesion, cell viability and/or cell growth. The modification may include a coating of a synthetic or natural polymer or a conditioned surface having covalently bound molecules (e.g., self-associating molecules). In some embodiments, the cover 110 and/or the support structure 104 can be transparent to light. The cover 110 may also include at least one material that is gas permeable (e.g., PDMS or PPS).

FIG. 1A also shows a system 150 for operating and controlling microfluidic devices, such as microfluidic device 100. System 150 includes an electrical power source 192, an imaging device 194 (not shown, but may be part of imaging module 164), and a tilting device 190 (not shown, but may be part of tilting module 166).

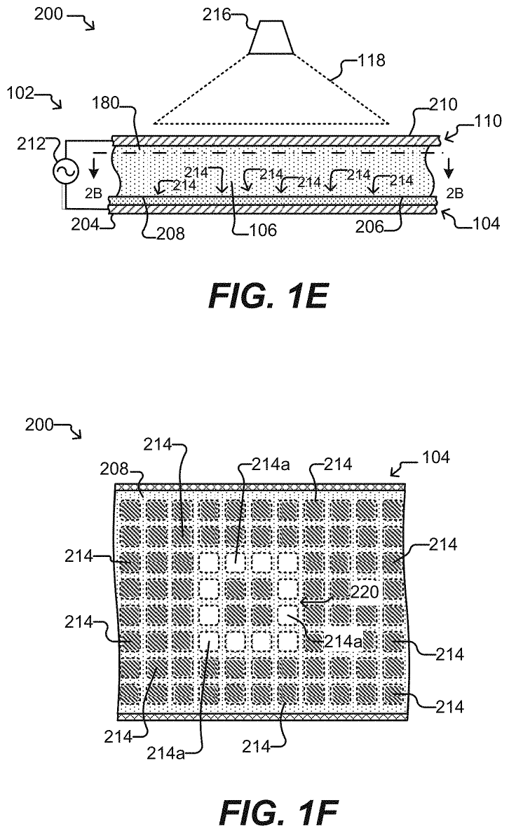

The electrical power source 192 can provide electric power to the microfluidic device 100 and/or tilting device 190, providing biasing voltages or currents as needed. The electrical power source 192 can, for example, comprise one or more alternating current (AC) and/or direct current (DC) voltage or current sources. The imaging device 194 can comprise a device, such as a digital camera, for capturing images inside microfluidic circuit 120. In some instances, the imaging device 194 further comprises a detector having a fast frame rate and/or high sensitivity (e.g. for low light applications). The imaging device 194 can also include a mechanism for directing stimulating radiation and/or light beams into the microfluidic circuit 120 and collecting radiation and/or light beams reflected or emitted from the microfluidic circuit 120 (or micro-objects contained therein). The emitted light beams may be in the visible spectrum and may, e.g., include fluorescent emissions. The reflected light beams may include reflected emissions originating from an LED or a wide spectrum lamp, such as a mercury lamp (e.g. a high pressure mercury lamp) or a Xenon arc lamp. As discussed with respect to FIG. 3B, the imaging device 194 may further include a microscope (or an optical train), which may or may not include an eyepiece.

System 150 further comprises a tilting device 190 configured to rotate a microfluidic device 100 about one or more axes of rotation. In some embodiments, the tilting device 190 is configured to support and/or hold the enclosure 102 comprising the microfluidic circuit 120 about at least one axis such that the microfluidic device 100 (and thus the microfluidic circuit 120) can be held in a level orientation (i.e. at 0° relative to x- and y-axes), a vertical orientation (i.e. at 90° relative to the x-axis and/or the y-axis), or any orientation therebetween. The orientation of the microfluidic device 100 (and the microfluidic circuit 120) relative to an axis is referred to herein as the “tilt” of the microfluidic device 100 (and the microfluidic circuit 120). For example, the tilting device 190 can tilt the microfluidic device 100 at 0.1°, 0.2°, 0.3°, 0.4°, 0.5°, 0.6°, 0.7°, 0.8°, 0.9°, 1°, 2°, 3°, 4°, 5°, 10°, 15°, 20°, 25°, 30°, 35°, 40°, 45°, 50°, 55°, 60°, 65°, 70°, 75°, 80°, 90°, or any degree therebetween relative to the x-axis or the y-axis. The level orientation (and thus the x- and y-axes) is defined as normal to a vertical axis defined by the force of gravity. The tilting device can also tilt the microfluidic device 100 (and the microfluidic circuit 120) to any degree greater than 90° relative to the x-axis and/or y-axis, or tilt the microfluidic device 100 (and the microfluidic circuit 120) 180° relative to the x-axis or the y-axis in order to fully invert the microfluidic device 100 (and the microfluidic circuit 120). Similarly, in some embodiments, the tilting device 190 tilts the microfluidic device 100 (and the microfluidic circuit 120) about an axis of rotation defined by flow region 106/channel 122 or some other portion of microfluidic circuit 120.

In some instances, the microfluidic device 100 is tilted into a vertical orientation such that the flow region 106/channel 122 is positioned above or below one or more sequestration pens. The term “above” as used herein denotes that the flow region 106/channel 122 is positioned higher than the one or more sequestration pens on a vertical axis defined by the force of gravity (i.e. an object in a sequestration pen above a flow region 106/channel 122 would have a higher gravitational potential energy than an object in the flow region/channel). The term “below” as used herein denotes that the flow region 106/channel 122 is positioned lower than the one or more sequestration pens on a vertical axis defined by the force of gravity (i.e. an object in a sequestration pen below a flow region 106/channel 122 would have a lower gravitational potential energy than an object in the flow region/channel).

In some instances, the tilting device 190 tilts the microfluidic device 100 about an axis that is parallel to the flow region 106/channel 122. Moreover, the microfluidic device 100 can be tilted to an angle of less than 90° such that the flow region 106/channel 122 is located above or below one or more sequestration pens without being located directly above or below the sequestration pens. In other instances, the tilting device 190 tilts the microfluidic device 100 about an axis perpendicular to the flow region 106/channel 122. In still other instances, the tilting device 190 tilts the microfluidic device 100 about an axis that is neither parallel nor perpendicular to the flow region 106/channel 122.

System 150 can further include a media source 178. The media source 178 (e.g., a container, reservoir, or the like) can comprise multiple sections or containers, each for holding a different fluidic medium 180. Thus, the media source 178 can be a device that is outside of and separate from the microfluidic device 100, as illustrated in FIG. 1A. Alternatively, the media source 178 can be located in whole or in part inside the enclosure 102 of the microfluidic device 100. For example, the media source 178 can comprise reservoirs that are part of the microfluidic device 100.

FIG. 1A also illustrates simplified block diagram depictions of examples of control and monitoring equipment 152 that constitute part of system 150 and can be utilized in conjunction with a microfluidic device 100. As shown, examples of such control and monitoring equipment 152 include a master controller 154, a media module 160 for controlling the media source 178, a motive module 162 for controlling movement and/or selection of micro-objects and/or medium (e.g., droplets of medium) in the microfluidic circuit 120, an imaging module 164 for controlling an imaging device 194 (e.g., a camera, microscope, light source or any combination thereof) for capturing images (e.g., digital images), and a tilting module 166 for controlling a tilting device 190. The control equipment 152 can also include other modules 168 for controlling, monitoring, or performing other functions with respect to the microfluidic device 100. As shown, the equipment 152 can be operatively coupled with (or further include) a display device 170 and an input/output device 172.

The master controller 154 can comprise a control module 156 and a digital memory 158. The control module 156 can comprise, for example, a digital processor configured to operate in accordance with machine executable instructions (e.g., software, firmware, source code, or the like) stored as non-transitory data or signals in the memory 158. Alternatively, or in addition, the control module 156 can comprise hardwired digital circuitry and/or analog circuitry. The media module 160, motive module 162, imaging module 164, tilting module 166, and/or other modules 168 can be similarly configured. Thus, functions, processes acts, actions, or steps of a process discussed herein as being performed with respect to the microfluidic device 100 or any other microfluidic apparatus can be performed by any one or more of the master controller 154, media module 160, motive module 162, imaging module 164, tilting module 166, and/or other modules 168 configured as discussed above. Similarly, the master controller 154, media module 160, motive module 162, imaging module 164, tilting module 166, and/or other modules 168 may be communicatively coupled to transmit and receive data used in any function, process, act, action or step discussed herein.

The media module 160 controls the media source 178. For example, the media module 160 can control the media source 178 to input a selected fluidic medium 180 into the enclosure 102 (e.g., through an inlet port 107). The media module 160 can also control removal of media from the enclosure 102 (e.g., through an outlet port (not shown)). One or more media can thus be selectively input into and removed from the microfluidic circuit 120. The media module 160 can also control the flow of fluidic medium 180 in the flow region 106/channel 122 inside the microfluidic circuit 120. For example, in some embodiments the media module 160 stops the flow of media 180 in the flow region 106/channel 122 and through the enclosure 102 prior to the loading of a micro-object or a bead into a sequestration pen (e.g., using gravity, electrowetting (EW) force, dielectrophoresis (DEP) force, or a combination thereof).

The motive module 162 can be configured to control selection, trapping, and movement of micro-objects and/or droplets of medium in the microfluidic circuit 120. As discussed in detail herein, the enclosure 102 can comprise an electrowetting (EW) configuration, such as an opto-electrowetting (OEW) configuration, an electrowetting on dielectric (EWOD) configuration, a single-sided electrowetting configuration, or the like. In certain embodiments, the enclosure 102 can further comprise a dielectrophoresis (DEP) configuration, such as an optoelectronic tweezer (OET) configuration, an electrically actuated DEP configuration, and the like. The motive module 162 can control the activation of electrodes and/or transistors (e.g., phototransistors) comprised by such EW and/or DEP configurations to select and move micro-objects and/or droplets of medium in the flow region 106/channel 122 and/or sequestration pens 124, 126, 128, 130.

The imaging module 164 can control the imaging device 194 (not shown). For example, the imaging module 164 can receive and process image data from the imaging device 194. Image data from the imaging device 194 can comprise any type of information captured by the imaging device 194 (e.g., the presence or absence of micro-objects, droplets of medium, accumulation of label, such as fluorescent label, etc.). Using the information captured by the imaging device 194, the imaging module 164 can further calculate the position of objects (e.g., micro-objects, droplets of medium, or the like) and/or the rate of motion of such objects within the microfluidic device 100.

The tilting module 166 can control the tilting motions of tilting device 190 (not shown). In addition, the tilting module 166 can control the tilting rate and timing, for example, to optimize transfer of micro-objects to the one or more sequestration pens via gravitational forces. The tilting module 166 is communicatively coupled with the imaging module 164 to receive data describing the motion of micro-objects and/or droplets of medium in the microfluidic circuit 120. Using this data, the tilting module 166 may adjust the tilt of the microfluidic circuit 120 in order to adjust the rate at which micro-objects and/or droplets of medium move in the microfluidic circuit 120. The tilting module 166 may also use this data to iteratively adjust the position of a micro-object and/or droplet of medium in the microfluidic circuit 120.

In the example shown in FIG. 1A, the microfluidic circuit 120 is illustrated as comprising a single flow region 106 consisting essentially of microfluidic channel 122. Each of sequestration pens 124, 126, 128, and 130 comprises a single opening to flow region 106/channel 122, but otherwise is enclosed such that the pens can substantially isolate micro-objects inside the pen from micro-objects and/or fluidic medium 180 in the flow region 106/channel 122 or in other pens. The walls of the sequestration pen can extend from the inner surface 109 of the base to the inside surface of the cover 110 to thereby facilitate such isolation. The opening of the pen to the flow region 106/channel 122 can be oriented at an angle with respect to the flow of fluidic medium 180 in flow region 106/channel 122 such that the flow of fluidic medium 180 is not directed into the pens. The flow may be, for example, tangential or orthogonal to the plane of the opening of the pen. In some instances, pens 124, 126, 128, and/or 130 are configured to physically corral one or more micro-objects within the microfluidic circuit 120. Sequestration pens in accordance with the present disclosure can comprise various shapes, surfaces and features that are optimized for use with EW, OEW, DEP, and/or OET forces, fluid flow, and/or gravitational forces, as will be discussed in detail below.

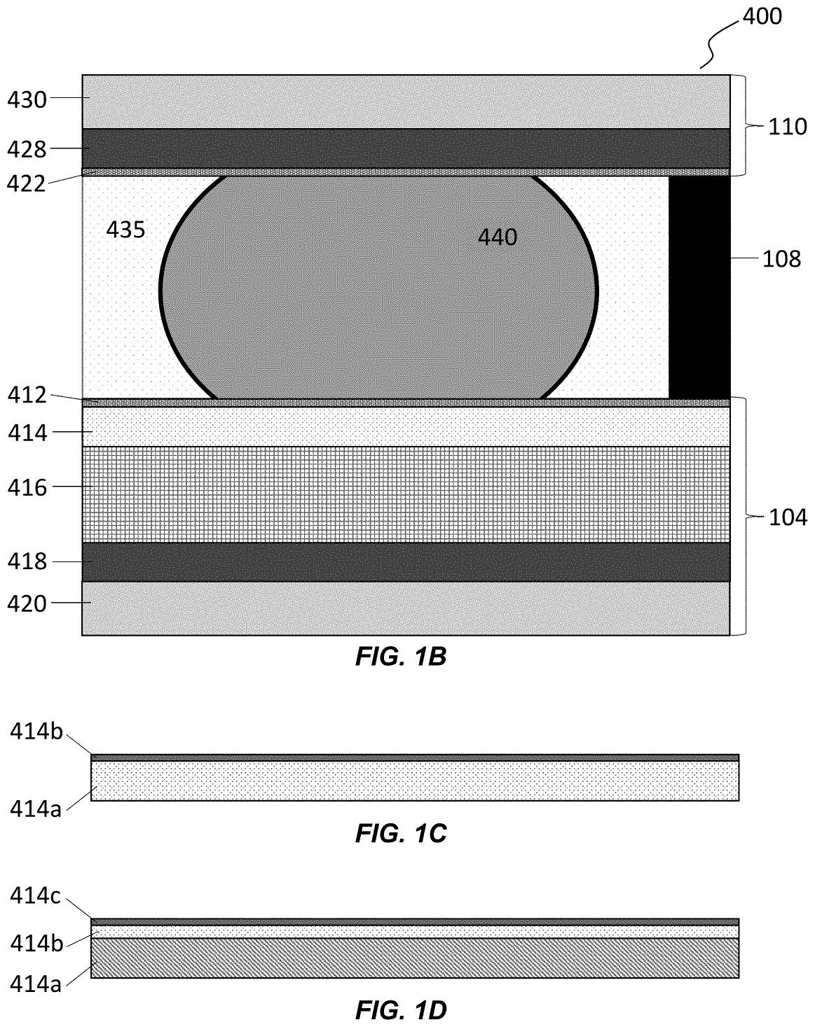

The microfluidic circuit 120 may comprise any number of microfluidic sequestration pens. Although five sequestration pens are shown, microfluidic circuit 120 may have fewer or more sequestration pens. As shown, microfluidic sequestration pens 124, 126, 128, and 130 of microfluidic circuit 120 each comprise differing features and shapes which may provide one or more benefits useful for the manipulation of micro-objects and/or droplets of fluidic medium with the microfluidic device 100. Thus, in some embodiments, the microfluidic circuit 120 may comprise a plurality of microfluidic sequestration pens, wherein two or more of the sequestration pens comprise differing structures and/or features which provide differing benefits. In some embodiments, however, the microfluidic circuit 120 comprises a plurality of identical microfluidic sequestration pens. Microfluidic devices useful the manipulation of micro-objects and/or droplets of medium may include any of the sequestration pens 124, 126, 128, and 130, or variations thereof, including pens configured like those shown in FIGS. 2B, 2C, and 2D, as discussed below.

In the embodiment illustrated in FIG. 1A, a single flow region 106 is shown. However, other embodiments of microfluidic device 100 may contain multiple flow regions 106, each configured to provide a separate path for fluid to flow through the microfluidic device 100. The microfluidic circuit 120 comprises an inlet valve or port 107 in fluid communication with the flow region 106, whereby fluidic medium 180 can access flow region 106/channel 122 via the inlet port 107. In some instances, the flow region 106 comprises a single flow path. In other instances, the flow region 106 comprises a plurality of flow paths (e.g., 2, 3, 4, 5, 6, or more), each of which may comprise a microchannel (e.g., like channel 122). Two or more (e.g., all) of the plurality of flow paths may be substantially parallel to one another. For example, flow region 106 can split into a plurality of parallel channels (e.g., like channel 122). In certain embodiments, the flow region 106 (and one or more channels comprised by the flow region) is arranged in a zigzag pattern, whereby the flow region 106 travels across the microfluidic device 100 two or more times in alternating directions. In some instances, the fluidic medium within each flow region 106 flows in at least one of a forward or reverse direction. In some instances, a plurality of sequestration pens is configured (e.g., relative to a flow region 106/channel 122) such that the sequestration pens can be loaded with target micro-objects in parallel.

In some embodiments, microfluidic circuit 120 further comprises one or more micro-object traps 132. The traps 132 are generally formed in a wall forming the boundary of a flow region 106/channel 122, and may be positioned opposite an opening of one or more of the microfluidic sequestration pens 124, 126, 128, and 130. In some embodiments, the traps 132 are configured to receive or capture a single micro-object from the flow region 106/channel 122. In some embodiments, the traps 132 are configured to receive or capture a plurality of micro-objects from the flow region 106/channel 122. In some instances, the traps 132 comprise a volume approximately equal to the volume of a single target micro-object.

The traps 132 may further comprise an opening which is configured to assist the flow of targeted micro-objects into the traps 132. In some instances, the traps 132 comprise an opening having a height and width that is size according to the dimensions of a single target micro-object, whereby other micro-objects (or micro-objects that are greater in size) are prevented from entering into the micro-object trap. The traps 132 may further comprise other features configured to assist in retention of targeted micro-objects within the trap 132. In some instances, the trap 132 is aligned with and situated on the opposite side of a channel 122 relative to the opening of a microfluidic sequestration pen, such that upon tilting the microfluidic device 100 about an axis parallel to the channel 122, the trapped micro-object exits the trap 132 at a trajectory that causes the micro-object to fall into the opening of the sequestration pen. In some instances, the trap 132 comprises a side passage 134 that is smaller than the target micro-object in order to facilitate flow through the trap 132 and thereby increase the likelihood of capturing a micro-object in the trap 132.

As discussed in greater detail below, in some embodiments electrowetting (EW) forces are applied at one or more positions on the surface of the support structure 104 (and/or the cover 110) of the microfluidic device 100 (e.g., positions within the flow region and/or the sequestration pens) via one or more electrodes (not shown) to manipulate, transport, separate and sort droplets located in the microfluidic circuit 120. For example, in some embodiments, EW forces are applied at one or more positions on the surface of the support structure 104 (and/or the cover 110) to transfer a droplet from the flow region 106 into a desired microfluidic sequestration pen. In some embodiments, EW forces are used to prevent a droplet within a sequestration pen (e.g., sequestration pen 124, 126, 128, or 130) from being displaced therefrom. Further, in some embodiments, EW forces are used to selectively remove a droplet from a sequestration pen that was previously collected in accordance with the teachings of the instant disclosure. In some embodiments, the EW forces comprise opto-electrowetting (OEW) forces.

In some embodiments, dielectrophoretic (DEP) forces are applied across the fluidic medium 180 (e.g., in the flow region and/or in the sequestration pens) via one or more electrodes (not shown) to manipulate, transport, separate and sort micro-objects located therein. For example, in some embodiments, DEP forces are applied within one or more portions of microfluidic circuit 120 to transfer a single micro-object from the flow region 106 into a desired microfluidic sequestration pen. In some embodiments, DEP forces are used to prevent a micro-object within a sequestration pen (e.g., sequestration pen 124, 126, 128, or 130) from being displaced therefrom. Further, in some embodiments, DEP forces are used to selectively remove a micro-object from a sequestration pen that was previously collected in accordance with the teachings of the instant disclosure. In some embodiments, the DEP forces comprise optoelectronic tweezer (OET) forces.

In some embodiments, DEP and/or EW forces are combined with other forces, such as flow and/or gravitational force, so as to manipulate, transport, separate and sort micro-objects and/or droplets within the microfluidic circuit 120. For example, the enclosure 102 can be tilted (e.g., by tilting device 190) to position the flow region 106/channel 122 and micro-objects located therein above the microfluidic sequestration pens, and the force of gravity can transport the micro-objects and/or droplets into the pens. In some embodiments, the DEP and/or EW forces can be applied prior to the other forces. In other embodiments, the DEP and/or EW forces can be applied after the other forces. In still other instances, the DEP and/or EW forces can be applied at the same time as the other forces or in an alternating manner with the other forces.

C. Microfluidic Device Motive Configurations.

As described above, the control and monitoring equipment of the system can comprise a motive module for selecting and moving objects, such as micro-objects or droplets, in the microfluidic circuit of a microfluidic device. The microfluidic devices of the disclosure can have a variety of motive configurations, depending upon the type of object being moved and other considerations. In particular, the support structure 104 and/or cover 110 of the microfluidic device 100 can comprise an electrowetting (EW) configuration for selectively inducing EW forces on droplets in a fluidic medium 180 in the microfluidic circuit 120 and thereby select, capture, and/or move individual droplets or groups of droplets. In certain embodiments, the microfluidic devices of the disclosure can comprise a first section having an EW configuration and a second section having a dielectrophoresis (DEP) configuration. Thus, at least a section of the support structure 104 and/or cover 110 of the microfluidic device 100 can comprise a DEP configuration for selectively inducing DEP forces on micro-objects in a fluidic medium 180 in the microfluidic circuit 120 and thereby select, capture, and/or move individual micro-objects or groups of micro-objects

D. Electrowetting Configurations.

In certain embodiments, a microfluidic device of the disclosure can comprise an electrowetting configuration which includes a substrate having a dielectric layer and a droplet actuation surface, the droplet actuation surface comprising (or consisting of, or consisting essentially of) a hydrophobic layer (i.e., an outer hydrophobic layer) covalently bonded to the surface of an underlying dielectric layer (i.e., an inner dielectric layer). When the microfluidic device is operatively connected to a voltage source, an aqueous droplet resting upon or otherwise contacting the hydrophobic layer can be reliably and robustly wetted, and thereby moved, by an electrowetting force. The dielectric layer can be located beneath the hydrophobic layer such that a droplet resting on the substrate directly contacts the hydrophobic layer. FIG. 2A illustrates an example of a portion of such a microfluidic device.

The microfluidic device can comprise a base that includes the substrate, and the substrate can further have at least one electrode (e.g., a first electrode) configured to be connected to the voltage source (e.g., an AC voltage source), the at least one electrode being electrically coupled to the inner dielectric layer. In some embodiments, the microfluidic device further comprises a cover and at least one spacing element. The substrate and the cover can be substantially parallel to one another and joined together by the spacing element to define an enclosure configured to hold a liquid medium. In such embodiments, the cover can include at least one electrode configured to be connected to the voltage source (e.g., the AC voltage source). In some embodiments, the microfluidic device can comprise a single-sided electrowetting configuration. In such embodiments, the microfluidic device need not include a cover. For example, the base can include the substrate and a first electrode configured to be connected to a voltage source (e.g., an AC voltage source), and the substrate can include a second electrode (e.g., a mesh electrode) configured to be connected to the voltage source.

As shown, apparatus 400 can include a base 104 which comprises the substrate and at least one electrode (e.g., a first electrode) 418. The substrate can comprise various layers, including an outer hydrophobic layer 412, an inner dielectric layer 414, a semi-conductive layer 416, an electrode 418, and optionally a support 420. The hydrophobic layer 412 and the inner dielectric layer 414 can provide an inward-facing surface of the substrate 102 that defines, in part, the enclosure.

Apparatus 400 also includes a cover 110, which includes an outer hydrophobic layer 422, an inner layer 428, which may comprise the at least one electrode, and optionally a support 430. Cover 110 and base 104 are substantially parallel to one another and joined together by a spacing element 108 (e.g., microfluidic circuit material) so as to define an enclosure 435 configured to hold a liquid medium. The liquid medium can be, for example, a hydrophobic liquid, such as an organic liquid. In addition, the enclosure 435 can hold a droplet of liquid 440, such as an aqueous medium. Typically, the liquid medium and the liquid of the droplet are selected to be immiscible liquids.

The spacing element 108 can comprise a polymer. The polymer can be, for example, a silicon-based organic polymer, such as polydimethylsiloxane (PDMS) or photo-patternable silicone (PPS), both available from Dow Corning. Alternatively, the spacing element 108 can comprise an epoxy-based adhesive. The epoxy-based adhesive can be, for example, SU-8 or equivalent types of materials. The spacing element 108 can have a thickness (i.e., the gap between the inner surface of the substrate 104 and the cover 110, which could also be described as “height”) of at least 30, 40, 50, 60, 70, 80, 90, 100, or more microns. Thus, for example, the thickness of spacing element 108 can be 30-60 microns, 40-80 microns, 50-100 microns, 60-120 microns, 70-140 microns, 75-150 microns, 80-160 microns, 90-180 microns, or 100-200 microns.

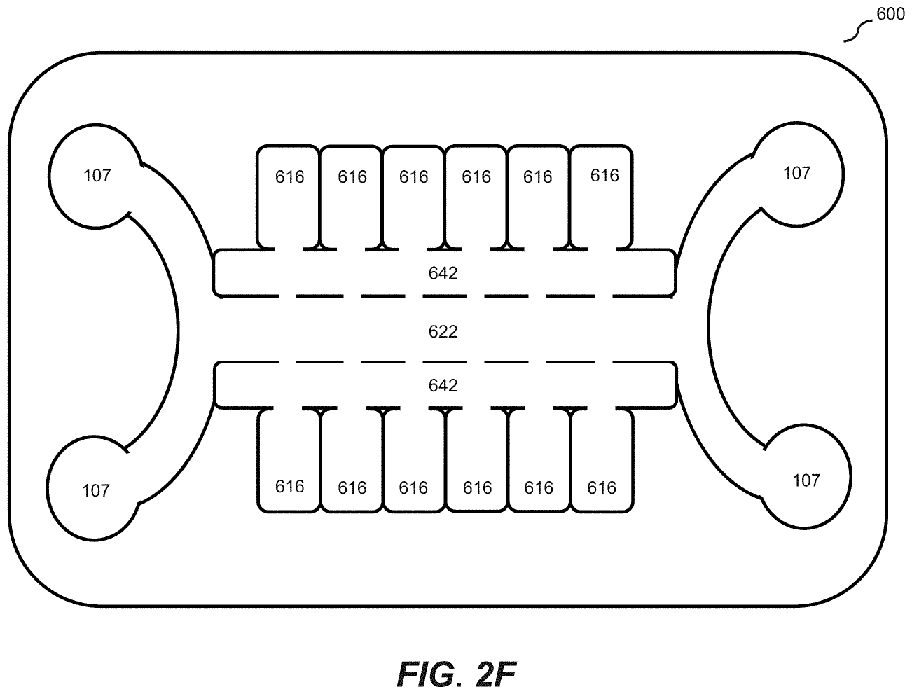

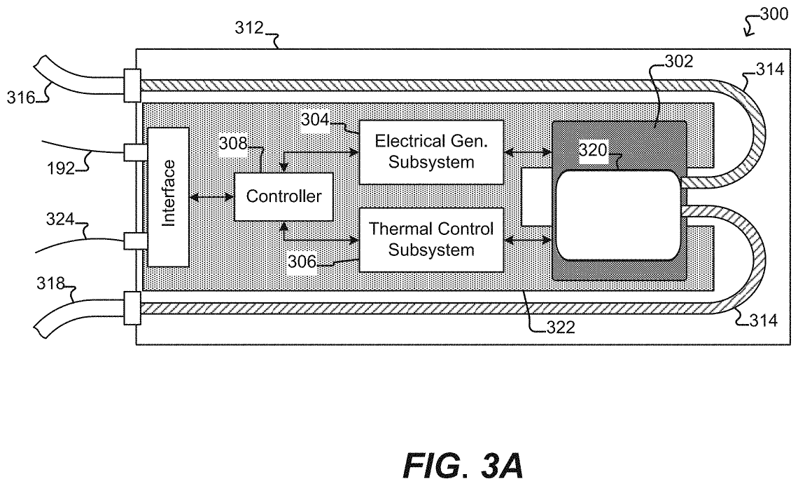

The spacing element 108 can define one or more microfluidic channels within the enclosure. In addition, the spacing element 108 can further define a plurality of chambers (or sequestration pens) within the enclosure, wherein each chamber is fluidically connected to and opens off of at least one microfluidic channel. Thus, for example, the spacing element 108 can define a single microfluidic channel and a plurality of chambers fluidically connected thereto, or a plurality of microfluidic channels with each channel fluidically connected to a plurality of chambers. Furthermore, each chamber can be fluidically connected to more than one microfluidic channel, as illustrated in FIGS. 8 and 9.

When the at least one electrode 418 of the substrate 104 and the at least one electrode 428 of the cover 110 are connected to opposing terminals of an AC voltage source (not shown), the substrate 104 is capable of applying an electrowetting force to aqueous droplets in contact with the outer hydrophobic surface 412 (i.e., the droplet actuation surface) of the substrate 104. In certain embodiments, the AC voltage used to achieve electrowetting-based movement of a droplet in the microfluidic device is at least 20 Volts peak-to-peak (ppV) (e.g., about 20 to 80 ppV, about 20 to 60 ppV, about 25 to 50 ppV, about 25 to 40 ppV, or about 25 to 35 ppV). In certain embodiments, the frequency of the AC voltage used to achieve electrowetting-based movement of a droplet in the microfluidic device is about 1 to 100 kHz (e.g., about 5 to 90 kHz, about 10 to 80 kHz, about 15 to 70 kHz, about 20 to 60 kHz, about 25 to 50 kHz, or about 30 to 40 kHz).

The outer hydrophobic layer 412 of the substrate 104 and the outer hydrophobic layer 422 of the cover 110 can each comprise a densely packed monolayer of self-associating molecules covalently bound to the inner dielectric layer 414 of the substrate 104 or the inner layer 428 of the cover 110, respectively. The self-associating molecules of the monolayer comprise sufficient two-dimensional packing density so as to create a hydrophobic barrier between a surface to which the monolayer is bound and a hydrophilic liquid (i.e., to prevent intercalation and/or penetration of polar molecules or other chemical species into the monolayer). The packing density of a densely packed monolayer will depend on the self-associating molecules used. A densely packed monolayer comprising alkyl-terminated siloxane will typically comprise at least 1×10¹⁴ molecules/cm² (e.g., at least 1.5×10¹⁴, 2.0×10¹⁴, 2.5×10¹⁴, or more molecules/cm²).

As described in greater detail below, the self-associating molecules can each comprise a linking group, such as a siloxane group or a phosphonic acid group. The siloxane groups can be covalently bonded to the molecules of the inner dielectric layer 414 or inner layer 428. Similarly, the phosphonic acid groups can be covalently bonded to the molecules of the inner dielectric layer 414 or inner layer 428. The self-associating molecules can comprise long-chain hydrocarbons, which can be unbranched. Thus, the self-associating molecules can comprise alkyl-terminated siloxane or alkyl-terminated phosphonic acid. The long-chain hydrocarbons can comprise a chain of at least 10 carbons (e.g., at least 16, 18, 20, 22, or more carbons). The self-associating molecules can comprise fluorinated carbon chains. Thus, for example, the self-associating molecules can comprise fluoroalkyl-terminated siloxane or fluoroalkyl-terminated phosphonic acid. The fluorinated carbon chains can have the chemical formula CF₃—(CF₂)m—(CH₂)n-, wherein m is at least 2, n is 0,1,2, or greater, and m+n is at least 9.

The monolayer of self-associating molecules can have a thickness of less than about 5 nanometers (e.g., about 1.0 to about 4.0 nanometers, about 1.5 to about 3.0 nanometers, or about 2.0 to about 2.5 nanometers).

The outer hydrophobic layer 412 of the substrate 104 can be patterned such that select regions are relatively hydrophilic compared to the remainder of the outer hydrophobic layer. This can be achieved, for example, by increasing the voltage drop across the underlying inner dielectric layer 122 to 50 ppV or greater (e.g., 60, 65, 70, 75, 80, or more ppV) for a period of time. Without intending to be bound by theory, it is believed that the relatively hydrophilic regions comprise water molecules that have intercalated into the monolayer.

1. Dielectric Layer(s) and Stacks

In some embodiments, the inner dielectric layer of the substrate can comprise one or more oxide layers. In some embodiments, the inner dielectric layer of the substrate can comprise a first layer of dielectric material. For example, the inner dielectric layer can consist of a single layer of dielectric material (e.g., aluminum oxide, hafnium oxide, or the like). For example, the inner dielectric layer can comprise or consist of a single oxide layer, such as a metal oxide layer. In certain embodiments, the first oxide layer is formed by atomic layer deposition (ALD).

Alternatively, the inner dielectric layer can be a dielectric stack that comprises two or more layers of dielectric material. Thus, in certain embodiments, the inner dielectric layer can comprise a first layer of dielectric material and a second layer of dielectric material. The first layer of dielectric material can comprise an oxide, such as a metal oxide (e.g., aluminum oxide, hafnium oxide, or the like); and the second layer of dielectric material can comprise an oxide, such as silicon oxide, or a nitride, such as silicon nitride. In such embodiments, the first layer of dielectric material can have a first surface that contacts the second layer of dielectric material and an opposing surface to which the hydrophobic layer is covalently bound. In certain embodiments, the second layer of dielectric material can have a thickness of about 30 nm to about 100 nm, depending upon the type of dielectric material used. For example, the second layer of dielectric material can comprise silicon oxide and can have a thickness of about 30 nm to about 50 nm, or about 30 nm to about 40 nm. Alternatively, the second layer of dielectric material can comprise silicon nitride and can have a thickness of about 50nm to about 100 nm, or about 80 nm to about 100 nm. In certain embodiments, the second layer of dielectric material is formed by ALD. In other embodiments, the second layer of dielectric material is formed by a Plasma Enhanced Chemical Vapor Deposition (PECVD) technique. In certain embodiments, the first layer of dielectric material can have a thickness of about 1 nm to about 50 nm (e.g., about 1 nm to about 10 nm, about 2 nm to about 5 nm, about 5 nm to about 10 nm, about 5 nm to about 15 nm, about 10 nm to about 20 nm, about 15 nm to about 25 nm, about 20 nm to about 30 nm, about 25 nm to about 35 nm, about 30 nm to about 40 nm, about 35 nm to about 45 nm, about 40 nm to about 50 nm, or any range defined by two of the foregoing endpoints) and can be formed by ALD. In some embodiments, the first layer of dielectric material is formed by PECVD (e.g., comprising silicon oxide or silicon nitride), optionally wherein the second layer is formed by ALD (e.g., comprising a metal oxide, such as aluminum oxide or hafnium oxide). Thus, for example, the metal oxide layer can be deposited by an Atomic Layer Deposition (ALD) technique and the layer comprising silicon dioxide or silicon nitride can be deposited by a Plasma Enhanced Chemical Vapor Deposition (PECVD) technique. In certain embodiments, the thickness of the metal oxide layer can range from about 1 nm to about 15 nm, about 5 nm to about 20 nm, about 15 nm to about 45 nm, or about 30 nm to about 40 nm, or about 33 nm to about 36 nm.

In yet other embodiments, the inner dielectric stack can comprise a third layer of dielectric material, with the third layer of dielectric material have a first surface that contact the first layer of dielectric material and an opposing surface that is covalently bonded to the hydrophobic layer. In such embodiments, the first layer of dielectric material can comprise an oxide, as described above (or elsewhere herein), and the second layer of dielectric material can comprise an oxide or a nitride, as described above (or elsewhere herein). In some embodiments, the first layer comprises silicon oxide or silicon nitride and is formed by PECVD. In some embodiments, the second layer comprises a metal oxide and is formed by ALD, optionally wherein the first layer comprises silicon oxide or silicon nitride and is formed by PECVD. In certain embodiments, the third layer of dielectric material can comprise an oxide, such as silicon dioxide or other dielectric materials that bond well to linkers such as siloxane groups or phosphonic acid groups. In certain embodiments, the third layer of dielectric material is deposited by ALD, optionally wherein the third layer comprises silicon oxide, further optionally wherein the second layer comprises a metal oxide and is formed by ALD and the first layer comprises silicon oxide or silicon nitride and is formed by PECVD. In some embodiments, a first layer can comprise a metal oxide, such as aluminum oxide, hafnium oxide, or the like, which can be sandwiched between a silicon dioxide layer and a silicon nitride layer. In certain embodiments, the thickness of the metal oxide layer can range from about 5 nm to about 20 nm, and the layer can be deposited by an Atomic Layer Deposition (ALD) technique. The silicon oxide layer can also be deposited by ALD, and can have a thickness of about 1 nm to about 10 nm. The silicon nitride layer can be deposited by a Plasma Enhanced Chemical Vapor Deposition (PECVD) technique has and can have a thickness of about 80 nm to about 100 nm, or about 90 nm thickness. In certain embodiments, a third layer of dielectric material has a thickness of about 1 nm to about 10 nm, or about 4 nm to about 6 nm.

Regardless of the number of layers that make up the inner dielectric stack, the inner dielectric layer can have a total thickness of at least about 40 nm (e.g., about 40 nm to about 120 nm, about 40 nm to about 60 nm, about 50 nm to about 70 nm, about 60 nm to about 80 nm, about 70 nm to about 90 nm, about 80 nm to about 100 nm, about 90 nm to about 110 nm, about 100 nm to about 120 nm, or a range defined by any two of the foregoing endpoints). Likewise, the dielectric stack can have an impedance of about 50 kOhms to about 150 kOhms (e.g., about 50 kOhms to about 75 kOhms, about 75 kOhms to about 100 kOhms, about 100 kOhms to about 125 kOhms, about 125 kOhms to about 150 kOhms, or a range defined by any two of the foregoing endpoints). In some embodiments, the inner dielectric layer can have a thickness of about 50 to 105 nanometers and/or an impedance of about 50 to 150 kOhms, e.g., about 100 kOhms.

A summary of exemplary embodiments of the dielectric layer is provided as follows.

### a) Single Layer

In certain embodiments, the dielectric layer is a single layer of metal oxide, deposited by ALD. Examples of the metal oxide for the first layer include, e.g., aluminum oxide and hafnium oxide. The thickness of the single layer can be adjusted to achieve an electrical impedance of about 50 kOhms to about 150 kOhms (e.g., about 100 kOhms). In some embodiments, the impedance is as described above.

### b) Two Sub-Layers

In some embodiments, a first layer is provided comprising a metal oxide, e.g., aluminum oxide and hafnium oxide, which is deposited by ALD. A second layer is deposited on the first layer by ALD. The second layer is formed of silicon oxide or other material that bonds well to siloxane linkers in the molecules that make up the surface coating. The thickness of the first layer can be from about 1 nm to about 10 nm (e.g., about 2nm to about 5 nm). The thickness of the second layer can be from about 1 nm to about 10 nm (e.g., about 2nm to about 5 nm).

In other embodiments, a first layer of silicon oxide (or silicon nitride, or the like) is formed by plasma enhanced chemical vapor deposition (PECVD). A second layer is deposited on the first layer and formed of a metal oxide (e.g., aluminum oxide or hafnium oxide) deposited by ALD. FIG. 1C shows an example of an embodiment of a dielectric layer having the first layer 414a and the second layer 414b.

The total thickness of the two-layer dielectric stack can be adjusted to ensure an electrical impedance of about 50 kOhms to about 150 kOhms (e.g., about 100 kOhms). In some embodiments, the impedance is as described above.

### c) Three Sub-Layers

In some embodiments, a first layer of silicon oxide (or silicon nitride, or the like) is formed by plasma enhanced chemical vapor deposition (PECVD). A second layer is provided on top of the first layer and formed of a metal oxide (e.g., aluminum oxide or hafnium oxide) deposited by ALD. The second layer has a thickness of about 1 nm to 10 nm (e.g., about 2 nm to about 5 nm).

A third layer is further provided on top of the second layer, with the third layer formed of silicon oxide (or another dielectric material that can bond well to siloxane linkers in the molecules that make up the surface coating). The third layer should also be formed by ALD, with a thickness of about 1 nm to about 10 nm (e.g., about 2-5 nm). FIG. 1D shows an example of an embodiment of a dielectric layer having the first layer 414a, the second layer 414b, and the third layer 414c.

The total thickness of the three-sublayer dielectric stack can be adjusted to achieve an electrical impedance of about 50 kOhms to about 150 kOhms (e.g., about 100 kOhms). In some embodiments, the impedance is as described above.

2. Photoresponsive Layer

The substrate 104 can comprise a semi-conductive layer 416 having a first side that contacts the inner dielectric layer 414, and a second side that contacts the at least one electrode 418, thereby electrically coupling the inner dielectric layer 414 with the electrode 418. The semi-conductive layer 416 can be photoresponsive. For example, the photoresponsive layer 416 can comprise hydrogenated amorphous silicon (a-Si:H). The a-Si:H can comprise about 8% to 40% hydrogen (i.e., calculated as 100 * the number of hydrogen atoms/total number of hydrogen and silicon atoms). The a-Si:H layer can have a thickness of at least about 500 nanometers (e.g., at least about 600 to 1400, about 700 to 1300, about 800 to 1200, about 900 to 1100, or about 1000 nanometers). However, the thickness of the a-Si:H layer can be varied in accordance with the thickness of the inner dielectric layer 414 so as to achieve a suitable difference between the impedance of the inner dielectric layer 414 and the impedance of the a-Si:H layer when the substrate 104 is in the on state (i.e., illuminated and conducting) and the off state (i.e., dark and non-conducting). For example, the impedance of the inner dielectric layer 414 can be tuned to about 50 kOhms to about 150 kOhms, and the impedance of the a-Si:H layer can be tuned to at least about 0.5 MOhms in the off state and less than or equal to about 1 kOhms in the on state. These are only examples, but they illustrate how the impedances can be tuned to achieve a photoresponsive (in this case, photoconductive) layer 416 displaying robust on/off performance.

In embodiments where the semi-conductive layer 416 has a photoresponsive layer formed from a-Si:H layer, the substrate 104 can optionally include additional components. For example, the semi-conductive layer 416 can include an array of phototransistors, such as described in U.S. Pat. No. 7,956,339 (Chiou et al.) or U.S. Pat. No. 9,908,115 (Hobbs et al.), the contents of which are incorporated herein by reference. The a-Si:H layer can be deposited on top of the array of phototransistors, as described in PCT Publication No. WO 2017/075295 (Lowe et al.), the contents of which are incorporated herein by reference. Alternatively, or in addition, the semi-conductive layer 416 can include floating electrode pads located between the a-Si:H layer and the inner dielectric layer 414. Such floating electrode pads have been described, for example, in U.S. Pat. No. 6,958,132, the contents of which are incorporated herein by reference.

The semi-conductive layer 416 can, alternatively, comprise a plurality of conductors, each conductor controllably connectable to the at least one electrode of the substrate 102 via a transistor switch. The transistor switch can be a phototransistor switch. Conductors controlled by transistor switches are well-known in the art and have been described, e.g., in U.S. Pat. No. 9,403,172 (Short et al.), U.S. Pat. No. 6,942,776 (Medoro), and U.S. Pat. No. 6,294,063 (Becker et al.), the contents of each of which are incorporated herein by reference.

The substrate 104 can comprise a single electrode 418 configured to be connected to an AC voltage source. The single electrode 418 can comprising a layer of indium-tin-oxide (ITO), which can, for example, be formed upon by a glass support 420. Alternatively, the single electrode 418 can comprise a layer of electrically conductive silicon. In other embodiments, the substrate 104 can comprise a plurality of electrodes that are individually addressable, as in the manner of EWOD devices, which are well-known in the art. The individually addressable electrodes can be connectable to one or more AC voltage sources via corresponding transistor switches.

3. Cover; Additional Layers Associated with Cover

For embodiments in which the microfluidic device comprises a cover, a surface of the cover that faces inward toward the enclosure can include an inner layer and a hydrophobic layer (i.e., an outer hydrophobic layer) covalently bonded to the inner layer. Similar to the outer hydrophobic layer of the substrate, the outer hydrophobic layer of the cover can comprise self-associating molecules covalently bonded to the inner layer so as to form a densely-packed hydrophobic monolayer. Thus, the outer hydrophobic layer can comprise any of the self-associating molecules described above (or elsewhere herein) for the outer hydrophobic layer of the substrate. In some embodiments, the outer hydrophobic layer of the cover comprises the same self-associating molecules as the outer hydrophobic layer of the substrate. In other embodiments, the outer hydrophobic layer of the substrate has a different type (or types) of self-associating molecules as the outer hydrophobic layer of the substrate. Thus, the cover 110 can, in the manner of the substrate, further comprise a dielectric layer (not shown) juxtaposed to the hydrophobic layer 422, and a conductive layer (not shown) juxtaposed between the dielectric layer and the electrode 428. Thus, the microfluidic apparatus 400 can have both the substrate 104 and the cover 110 configured to provide an electrowetting force to an aqueous droplet 440 located within the enclosure 435. In such embodiments, the dielectric layer of the cover 110 can be configured in any of the ways disclosed herein for the inner dielectric layer 414 of the substrate 104, and the conductive layer of the cover 104 can be configured in any of the ways disclosed herein for the conductive layer 126 of the substrate 102

In some embodiments, the outer hydrophobic layer of the inward-facing surface of the cover has a thickness of less than 5 nanometers (e.g., about 1.5 to 3.0 nanometers). In some embodiments, the outer hydrophobic layer of the inward-facing surface of the cover can be patterned such that select regions are relatively hydrophilic compared to the remainder of the outer hydrophobic layer.

4. Integration with Electro Positioning Apparatus

In some embodiments, an electrowetting apparatus is integrated with an electro positioning apparatus. For example, in some embodiments, a microfluidic device can include a substrate having an electrowetting configuration and a portion of a substrate can further comprise a dielectrophoresis (DEP) configuration. Exemplary DEP configurations are discussed in detail below. Thus, the substrate can be monolithic. Alternatively, the microfluidic device or apparatus can include a first module or section having a first substrate that has a dielectrophoresis (DEP) configuration, and a second module or section having a second substrate that includes an electrowetting configuration. Such devices can be considered as having a duolithic substrate, and there can be a bridge between the first module or section and the second module or section that provides integration of the functionalities associated with each substrate and its particular configuration. The bridge can include tubing or the like that connects two otherwise discrete devices. Alternatively, the bridge can comprise a bonding agent that brings the substrates into close juxtaposition (e.g., within 2 mm, 1.5 mm, 1.0 mm, 0.5 mm, or less). In yet other alternatives, the bridge can be a non-functional region on a monolithic substrate, wherein the zone of non-functionality is where the substrate configuration switches from one configuration (e.g., an electrowetting configuration) to another configuration (e.g., a DEP configuration). Regardless of whether the microfluidic device has a monolithic or duolithic substrate (or even a multi-lithic substrate), each of the electrowetting configuration and the DEP configuration can be any such configuration known in the art or disclosed herein. For example, the electrowetting configuration can be an opto-electrowetting (OEW) configuration, an electrowetting on dielectric (EWOD) configuration, a single-sided electrowetting configuration, or the like. Similarly, the DEP configuration can be an optoelectronic tweezer (OET) configuration, such as provided by photoconductive substrate comprising a layer of amorphous silicon and/or an array of phototransistors, an array of electrodes controlled by phototransistors, an array of electrodes electrically actuated, or the like. In certain alternative embodiments, the substrate can comprise an electrowetting configuration but lack any additional configuration (e.g., lack a dielectrophoresis (DEP) configuration).

E. Dielectrophoresis (DEP) Configurations.

As discussed herein, the microfluidic devices of the disclosure can include a section having a DEP configuration. One example of such as section is microfluidic device 200 illustrated in FIGS. 1E and 1F While for purposes of simplicity FIGS. 1E and 1F show a vertical cross-sectional view and a horizontal cross-sectional view, respectively, of a portion of an enclosure 102 of the microfluidic device 200 having an open region/chamber 202, it should be understood that the region/chamber 202 may be part of a fluidic circuit element having a more detailed structure, such as a growth chamber, a sequestration pen, a flow region, or a flow channel. Furthermore, the microfluidic device 200 may include other fluidic circuit elements. For example, the microfluidic device 200 can include a plurality of growth chambers or sequestration pens and/or one or more flow regions or flow channels, such as those described herein with respect to microfluidic device 100. A DEP configuration may be incorporated into any such fluidic circuit elements of the microfluidic device 200, or select portions thereof. It should be further appreciated that any of the above or below described microfluidic device components and system components may be incorporated in and/or used in combination with the microfluidic device 200. For example, system 150 including control and monitoring equipment 152, described above, may be used with microfluidic device 200, including one or more of the media module 160, motive module 162, imaging module 164, tilting module 166, and other modules 168.

As seen in FIG. 1E, the microfluidic device 200 includes a support structure 104 having a bottom electrode 204 and an electrode activation substrate 206 overlying the bottom electrode 204, and a cover 110 having a top electrode 210, with the top electrode 210 spaced apart from the bottom electrode 204. The top electrode 210 and the electrode activation substrate 206 define opposing surfaces of the region/chamber 202. A medium 180 contained in the region/chamber 202 thus provides a resistive connection between the top electrode 210 and the electrode activation substrate 206. A power source 212 configured to be connected to the bottom electrode 204 and the top electrode 210 and create a biasing voltage between the electrodes, as required for the generation of DEP forces in the region/chamber 202, is also shown. The power source 212 can be, for example, an alternating current (AC) power source.

In certain embodiments, the microfluidic device 200 illustrated in FIGS. 1E and 1F can have an optically-actuated DEP configuration. Accordingly, changing patterns of light 218 from the light source 216, which may be controlled by the motive module 162, can selectively activate and deactivate changing patterns of DEP electrodes at regions 214 of the inner surface 208 of the electrode activation substrate 206. (Hereinafter the regions 214 of a microfluidic device having a DEP configuration are referred to as “DEP electrode regions.”) As illustrated in FIG. 1F, a light pattern 218 directed onto the inner surface 208 of the electrode activation substrate 206 can illuminate select DEP electrode regions 214a (shown in white) in a pattern, such as a square. The non-illuminated DEP electrode regions 214 (cross-hatched) are hereinafter referred to as “dark” DEP electrode regions 214. The relative electrical impedance through the DEP electrode activation substrate 206 (i.e., from the bottom electrode 204 up to the inner surface 208 of the electrode activation substrate 206 which interfaces with the medium 180 in the flow region 106) is greater than the relative electrical impedance through the medium 180 in the region/chamber 202 (i.e., from the inner surface 208 of the electrode activation substrate 206 to the top electrode 210 of the cover 110) at each dark DEP electrode region 214. An illuminated DEP electrode region 214a, however, exhibits a reduced relative impedance through the electrode activation substrate 206 that is less than the relative impedance through the medium 180 in the region/chamber 202 at each illuminated DEP electrode region 214a.

With the power source 212 activated, the foregoing DEP configuration creates an electric field gradient in the fluidic medium 180 between illuminated DEP electrode regions 214a and adjacent dark DEP electrode regions 214, which in turn creates local DEP forces that attract or repel nearby micro-objects (not shown) in the fluidic medium 180. DEP electrodes that attract or repel micro-objects in the fluidic medium 180 can thus be selectively activated and deactivated at many different such DEP electrode regions 214 at the inner surface 208 of the region/chamber 202 by changing light patterns 218 projected from a light source 216 into the microfluidic device 200. Whether the DEP forces attract or repel nearby micro-objects can depend on such parameters as the frequency of the power source 212 and the dielectric properties of the medium 180 and/or micro-objects (not shown).

The square pattern 220 of illuminated DEP electrode regions 214a illustrated in FIG. 1E is an example only. Any pattern of the DEP electrode regions 214 can be illuminated (and thereby activated) by the pattern of light 218 projected into the device 200, and the pattern of illuminated/activated DEP electrode regions 214 can be repeatedly changed by changing or moving the light pattern 218.

In some embodiments, the electrode activation substrate 206 can comprise or consist of a photoconductive material. In such embodiments, the inner surface 208 of the electrode activation substrate 206 can be featureless. For example, the electrode activation substrate 206 can comprise or consist of a layer of hydrogenated amorphous silicon (a-Si:H). The a-Si:H can comprise, for example, about 8% to 40% hydrogen (calculated as 100 * the number of hydrogen atoms/the total number of hydrogen and silicon atoms). The layer of a-Si:H can have a thickness of about 500 nm to about 2.0 □ m. In such embodiments, the DEP electrode regions 214 can be created anywhere and in any pattern on the inner surface 208 of the electrode activation substrate 206, in accordance with the light pattern 218. The number and pattern of the DEP electrode regions 214 thus need not be fixed, but can correspond to the light pattern 218. Examples of microfluidic devices having a DEP configuration comprising a photoconductive layer such as discussed above have been described, for example, in U.S. Patent No. RE 44,711 (Wu et al.) (originally issued as U.S. Pat. No. 7,612,355), the entire contents of which are incorporated herein by reference.

In other embodiments, the electrode activation substrate 206 can comprise a substrate comprising a plurality of doped layers, electrically insulating layers (or regions), and electrically conductive layers that form semiconductor integrated circuits, such as is known in semiconductor fields. For example, the electrode activation substrate 206 can comprise a plurality of phototransistors, including, for example, lateral bipolar phototransistors, each phototransistor corresponding to a DEP electrode region 214. Alternatively, the electrode activation substrate 206 can comprise electrodes (e.g., conductive metal electrodes) controlled by phototransistor switches, with each such electrode corresponding to a DEP electrode region 214. The electrode activation substrate 206 can include a pattern of such phototransistors or phototransistor-controlled electrodes. The pattern, for example, can be an array of substantially square phototransistors or phototransistor-controlled electrodes arranged in rows and columns, such as shown in FIG. 2B. Alternatively, the pattern can be an array of substantially hexagonal phototransistors or phototransistor-controlled electrodes that form a hexagonal lattice. Regardless of the pattern, electric circuit elements can form electrical connections between the DEP electrode regions 214 at the inner surface 208 of the electrode activation substrate 206 and the bottom electrode 210, and those electrical connections (i.e., phototransistors or electrodes) can be selectively activated and deactivated by the light pattern 218. When not activated, each electrical connection can have high impedance such that the relative impedance through the electrode activation substrate 206 (i.e., from the bottom electrode 204 to the inner surface 208 of the electrode activation substrate 206 which interfaces with the medium 180 in the region/chamber 202) is greater than the relative impedance through the medium 180 (i.e., from the inner surface 208 of the electrode activation substrate 206 to the top electrode 210 of the cover 110) at the corresponding DEP electrode region 214. When activated by light in the light pattern 218, however, the relative impedance through the electrode activation substrate 206 is less than the relative impedance through the medium 180 at each illuminated DEP electrode region 214, thereby activating the DEP electrode at the corresponding DEP electrode region 214 as discussed above. DEP electrodes that attract or repel micro-objects (not shown) in the medium 180 can thus be selectively activated and deactivated at many different DEP electrode regions 214 at the inner surface 208 of the electrode activation substrate 206 in the region/chamber 202 in a manner determined by the light pattern 218.

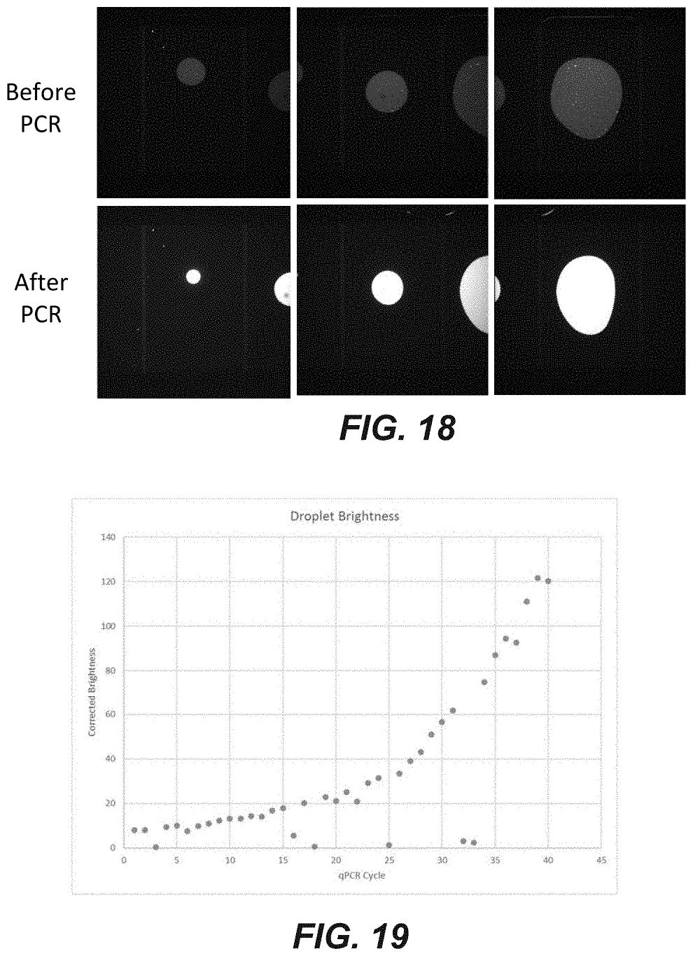

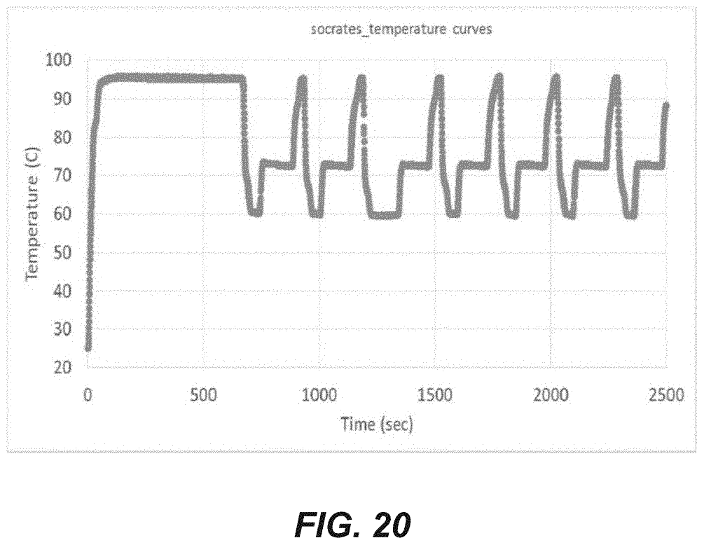

Examples of microfluidic devices having electrode activation substrates that comprise phototransistors have been described, for example, in U.S. Pat. No. 7,956,339 (Ohta et al.) (see, e.g., device 300 illustrated in FIGS. 21 and 22, and descriptions thereof), the entire contents of which are incorporated herein by reference. Examples of microfluidic devices having electrode activation substrates that comprise electrodes controlled by phototransistor switches have been described, for example, in U.S. Patent Publication No. 2014/0124370 (Short et al.) (see, e.g., devices 200, 400, 500, 600, and 900 illustrated throughout the drawings, and descriptions thereof), the entire contents of which are incorporated herein by reference.

In some embodiments of a DEP configured microfluidic device, the top electrode 210 is part of a first wall (or cover 110) of the enclosure 102, and the electrode activation substrate 206 and bottom electrode 204 are part of a second wall (or support structure 104) of the enclosure 102. The region/chamber 202 can be between the first wall and the second wall. In other embodiments, the electrode 210 is part of the second wall (or support structure 104) and one or both of the electrode activation substrate 206 and/or the electrode 210 are part of the first wall (or cover 110). Moreover, the light source 216 can alternatively be used to illuminate the enclosure 102 from below.

With the microfluidic device 200 of FIGS. 1E-1F having a DEP configuration, the motive module 162 can select a micro-object (not shown) in the medium 180 in the region/chamber 202 by projecting a light pattern 218 into the device 200 to activate a first set of one or more DEP electrodes at DEP electrode regions 214a of the inner surface 208 of the electrode activation substrate 206 in a pattern (e.g., square pattern 220) that surrounds and captures the micro-object. The motive module 162 can then move the captured micro-object by moving the light pattern 218 relative to the device 200 to activate a second set of one or more DEP electrodes at DEP electrode regions 214. Alternatively, the device 200 can be moved relative to the light pattern 218.

In other embodiments, the microfluidic device 200 can have a DEP configuration that does not rely upon light activation of DEP electrodes at the inner surface 208 of the electrode activation substrate 206. For example, the electrode activation substrate 206 can comprise selectively addressable and energizable electrodes positioned opposite to a surface including at least one electrode (e.g., cover 110). Switches (e.g., transistor switches in a semiconductor substrate) may be selectively opened and closed to activate or inactivate DEP electrodes at DEP electrode regions 214, thereby creating a net DEP force on a micro-object (not shown) in region/chamber 202 in the vicinity of the activated DEP electrodes. Depending on such characteristics as the frequency of the power source 212 and the dielectric properties of the medium (not shown) and/or micro-objects in the region/chamber 202, the DEP force can attract or repel a nearby micro-object. By selectively activating and deactivating a set of DEP electrodes (e.g., at a set of DEP electrodes regions 214 that forms a square pattern 220), one or more micro-objects in region/chamber 202 can be trapped and moved within the region/chamber 202. The motive module 162 in FIG. 1A can control such switches and thus activate and deactivate individual ones of the DEP electrodes to select, trap, and move particular micro-objects (not shown) around the region/chamber 202. Microfluidic devices having a DEP configuration that includes selectively addressable and energizable electrodes are known in the art and have been described, for example, in U.S. Pat. Nos. 6,294,063 (Becker et al.) and U.S. Pat. No. 6,942,776 (Medoro), the entire contents of which are incorporated herein by reference.

F. Microfluidic Devices with Electrowetting (EW) and Dielectrophoresis (DEP) Configurations.

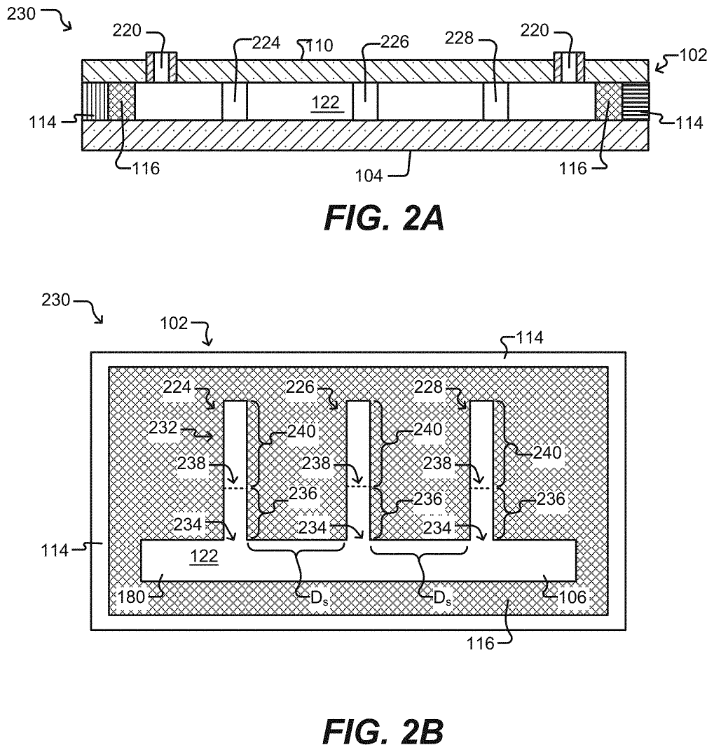

FIG. 4 is a vertical cross-sectional view of a microfluidic device or apparatus 450 that integrates multiple microfluidic applications in accordance with various embodiments. The device 450 comprises two different sections (though there could be more), each having a single microfluidic configuration. Section 460 comprises an electrowetting configuration, which includes a base 104 which comprises the substrate. The substrate comprises various layers, including an outer hydrophobic layer 412, an inner dielectric layer 414, a semi-conductive layer 416, and an electrode 418. The hydrophobic layer 412 and the inner dielectric layer 414 can provide an inward-facing surface of the substrate that defines, in part, the enclosure 435. Section 460 also includes a cover 110 comprising an electrode 428 and an outer hydrophobic layer 422, and microfluidic circuit material 108 that connects the base 104 with the cover 110 and further helps to define the microfluidic circuit of the electrowetting section, including enclosure 435 which is configured to hold an immiscible fluid.

Section 470 of microfluidic device 450 comprises a dielectrophoresis DEP configuration, which includes a base 104, a first electrode 479, an electrode activation substrate 474, and an inward-facing surface that defines, in part, the enclosure 475. Section 470 further includes a cover 110 comprising an electrode 468, and microfluidic circuit material 108 that connects the base 104 with the cover 110 and further helps to define the microfluidic circuit of the DEP section.

As shown in FIG. 4, the electrowetting section 460 and the DEP section 470 can share the same base 104 and cover 110, while their substrates and electrodes are not shared. The electrowetting section 460 and the DEP section 470 of device 450 can be joined by a bridge 465, which can be tubing, an adhesive material, or the like, or any combination thereof.

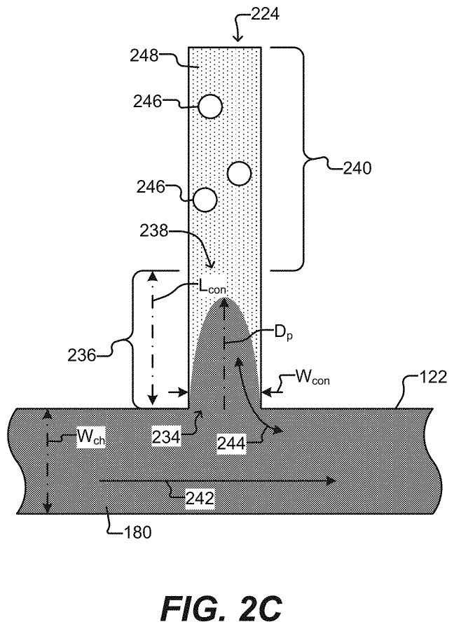

FIG. 5 is a vertical cross-sectional view of a microfluidic device or apparatus 500 that integrates multiple microfluidic applications in accordance with various embodiments. Like device 400, device 500 comprises two different sections (though there could be more), each having a single microfluidic configuration. Specifically, section 460 comprises an electrowetting configuration and section 470 comprises a DEP configuration. The various components of device 500 have corresponding parts to those in device 400, as shown by corresponding reference numbers. However, device 500 has a monolithic substrate having a semi-conductive layer 416, a first electrode 418, and a second electrode 428, all of which are shared by both sections 460 and 470.

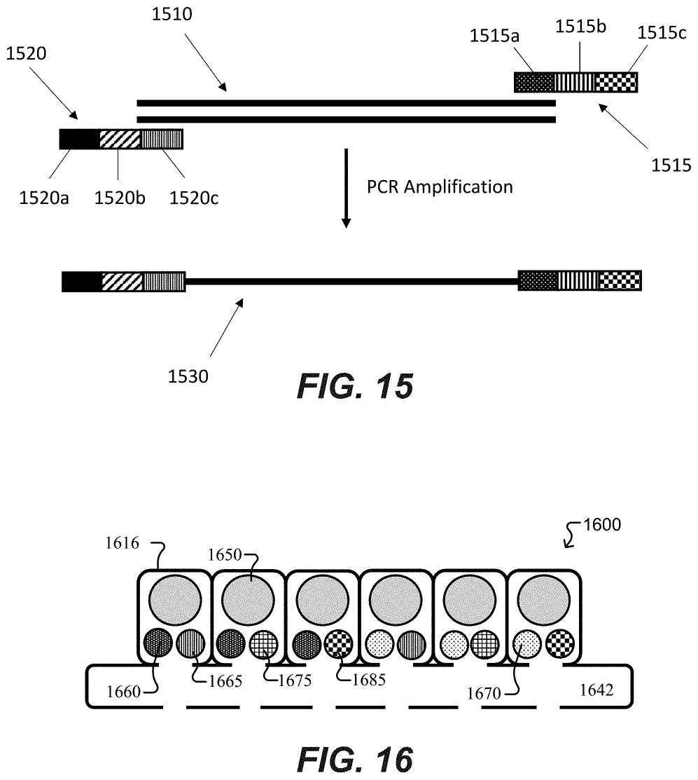

FIGS. 19A and 19B provide a view of an electrical addressing operational representation for one functional aspect in accordance with the embodiments depicted in connection with FIG. 5. As previously described in connection with FIG. 5, the system integrates two microfluidic operations, as depicted by DEP and EW modules that share a monolithic substrate. In this embodiment, the DEP (which can be an OET) module has lower impedance relative to the EW module. During operation, the EW module's impedance overcomes the DEP module's impedance and essentially renders the DEP module a short circuit.

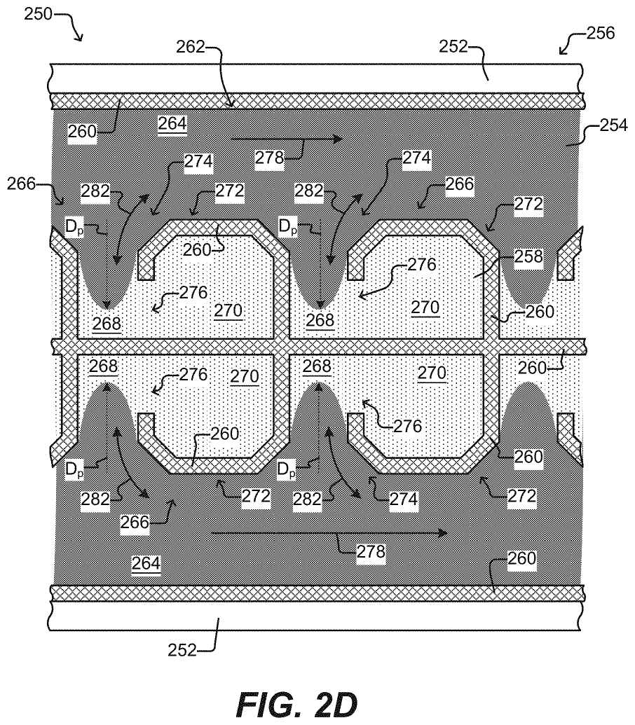

In one embodiment as depicted in FIG. 6A, the OEP module operates by applying a voltage in a range of 1-10 Volts at a frequency in a range of 100 kHz to 10 mHz. In the same embodiment, as depicted in FIG. 6B, OEW module operates by applying a voltage in a range of 10-100 Volts at a frequency in a range of 1 kHz to 300 kHz. In one preferred embodiment, the OEP module operates by applying a voltage of 5 Volts at a frequency of 1 MHz and the OEW module operates by applying a voltage of 30 Volts at a frequency of 30 kHz.

G. Sequestration Pens.

Non-limiting examples of generic sequestration pens 224, 226, and 228 are shown within the microfluidic device 230 depicted in FIGS. 2A-2C. Each sequestration pen 224, 226, and 228 can comprise an isolation structure 232 defining an isolation region 240 and a connection region 236 fluidically connecting the isolation region 240 to a channel 122. The connection region 236 can comprise a proximal opening 234 to the channel 122 and a distal opening 238 to the isolation region 240. The connection region 236 can be configured so that the maximum penetration depth of a flow of a fluidic medium (not shown) flowing from the channel 122 into the sequestration pen 224, 226, 228 does not extend into the isolation region 240. Thus, due to the connection region 236, a micro-object (not shown) or other material (not shown) disposed in an isolation region 240 of a sequestration pen 224, 226, 228 can thus be isolated from, and not substantially affected by, a flow of medium 180 in the channel 122.

The sequestration pens 224, 226, and 228 of FIGS. 2A-2C each have a single opening which opens directly to the channel 122. The opening of the sequestration pen opens laterally from the channel 122. The electrode activation substrate 206 underlays both the channel 122 and the sequestration pens 224, 226, and 228. The upper surface of the electrode activation substrate 206 within the enclosure of a sequestration pen, forming the floor of the sequestration pen, is disposed at the same level or substantially the same level of the upper surface the of electrode activation substrate 206 within the channel 122 (or flow region if a channel is not present), forming the floor of the flow channel (or flow region, respectively) of the microfluidic device. The electrode activation substrate 206 may be featureless or may have an irregular or patterned surface that varies from its highest elevation to its lowest depression by less than about 3 microns, 2.5 microns, 2 microns, 1.5 microns, 1 micron, 0.9 microns, 0.5 microns, 0.4 microns, 0.2 microns, 0.1 microns or less. The variation of elevation in the upper surface of the substrate across both the channel 122 (or flow region) and sequestration pens may be less than about 3%, 2%, 1%. 0.9%, 0.8%, 0.5%, 0.3% or 0.1% of the height of the walls of the sequestration pen or walls of the microfluidic device. While described in detail for the microfluidic device 200, this also applies to any of the microfluidic devices 100, 230, 250, 280, 290, 600, 700 described herein.

The channel 122 can thus be an example of a swept region, and the isolation regions 240 of the sequestration pens 224, 226, 228 can be examples of unswept regions. As noted, the channel 122 and sequestration pens 224, 226, 228 can be configured to contain one or more fluidic media 180. In the example shown in FIGS. 2A-2B, the ports 222 are connected to the channel 122 and allow a fluidic medium 180 to be introduced into or removed from the microfluidic device 230. Prior to introduction of the fluidic medium 180, the microfluidic device may be primed with a gas such as carbon dioxide gas. Once the microfluidic device 230 contains the fluidic medium 180, the flow 242 of fluidic medium 180 in the channel 122 can be selectively generated and stopped. For example, as shown, the ports 222 can be disposed at different locations (e.g., opposite ends) of the channel 122, and a flow 242 of medium can be created from one port 222 functioning as an inlet to another port 222 functioning as an outlet.

FIG. 2C illustrates a detailed view of an example of a sequestration pen 224 according to the present disclosure. Examples of micro-objects 246 are also shown.

As is known, a flow 242 of fluidic medium 180 in a microfluidic channel 122 past a proximal opening 234 of sequestration pen 224 can cause a secondary flow 244 of the medium 180 into and/or out of the sequestration pen 224. To isolate micro-objects 246 in the isolation region 240 of a sequestration pen 224 from the secondary flow 244, the length L_{con} of the connection region 236 of the sequestration pen 224 (i.e., from the proximal opening 234 to the distal opening 238) should be greater than the penetration depth Dₚ of the secondary flow 244 into the connection region 236. The penetration depth Dₚ of the secondary flow 244 depends upon the velocity of the fluidic medium 180 flowing in the channel 122 and various parameters relating to the configuration of the channel 122 and the proximal opening 234 of the connection region 236 to the channel 122. For a given microfluidic device, the configurations of the channel 122 and the opening 234 will be fixed, whereas the rate of flow 242 of fluidic medium 180 in the channel 122 will be variable. Accordingly, for each sequestration pen 224, a maximal velocity Vmax for the flow 242 of fluidic medium 180 in channel 122 can be identified that ensures that the penetration depth Dₚ of the secondary flow 244 does not exceed the length L_{con} of the connection region 236. As long as the rate of the flow 242 of fluidic medium 180 in the channel 122 does not exceed the maximum velocity Vₘₐₓ, the resulting secondary flow 244 can be limited to the channel 122 and the connection region 236 and kept out of the isolation region 240. The flow 242 of medium 180 in the channel 122 will thus not draw micro-objects 246 out of the isolation region 240. Rather, micro-objects 246 located in the isolation region 240 will stay in the isolation region 240 regardless of the flow 242 of fluidic medium 180 in the channel 122.

Moreover, as long as the rate of flow 242 of medium 180 in the channel 122 does not exceed Vₘₐₓ, the flow 242 of fluidic medium 180 in the channel 122 will not move miscellaneous particles (e.g., microparticles and/or nanoparticles) from the channel 122 into the isolation region 240 of a sequestration pen 224. Having the length L_{con} of the connection region 236 be greater than the maximum penetration depth Dₚ of the secondary flow 244 can thus prevent contamination of one sequestration pen 224 with miscellaneous particles from the channel 122 or another sequestration pen (e.g., sequestration pens 226, 228 in FIG. 2D).

Because the channel 122 and the connection regions 236 of the sequestration pens 224, 226, 228 can be affected by the flow 242 of medium 180 in the channel 122, the channel 122 and connection regions 236 can be deemed swept (or flow) regions of the microfluidic device 230. The isolation regions 240 of the sequestration pens 224, 226, 228, on the other hand, can be deemed unswept (or non-flow) regions. For example, components (not shown) in a first fluidic medium 180 in the channel 122 can mix with a second fluidic medium 248 in the isolation region 240 substantially only by diffusion of components of the first medium 180 from the channel 122 through the connection region 236 and into the second fluidic medium 248 in the isolation region 240. Similarly, components (not shown) of the second medium 248 in the isolation region 240 can mix with the first medium 180 in the channel 122 substantially only by diffusion of components of the second medium 248 from the isolation region 240 through the connection region 236 and into the first medium 180 in the channel 122. In some embodiments, the extent of fluidic medium exchange between the isolation region of a sequestration pen and the flow region by diffusion is greater than about 90%, 91%, 92%, 93%, 94% 95%, 96%, 97%, 98%, or greater than about 99% of fluidic exchange. The first medium 180 can be the same medium or a different medium than the second medium 248. Moreover, the first medium 180 and the second medium 248 can start out being the same, then become different (e.g., through conditioning of the second medium 248 by one or more cells in the isolation region 240, or by changing the medium 180 flowing through the channel 122).

The maximum penetration depth Dₚ of the secondary flow 244 caused by the flow 242 of fluidic medium 180 in the channel 122 can depend on a number of parameters, as mentioned above. Examples of such parameters include: the shape of the channel 122 (e.g., the channel can direct medium into the connection region 236, divert medium away from the connection region 236, or direct medium in a direction substantially perpendicular to the proximal opening 234 of the connection region 236 to the channel 122); a width W_{ch} (or cross-sectional area) of the channel 122 at the proximal opening 234; and a width W_{con} (or cross-sectional area) of the connection region 236 at the proximal opening 234; the velocity V of the flow 242 of fluidic medium 180 in the channel 122; the viscosity of the first medium 180 and/or the second medium 248, or the like.

In some embodiments, the dimensions of the channel 122 and sequestration pens 224, 226, 228 can be oriented as follows with respect to the vector of the flow 242 of fluidic medium 180 in the channel 122: the channel width W_{ch} (or cross-sectional area of the channel 122) can be substantially perpendicular to the flow 242 of medium 180; the width W_{con} (or cross-sectional area) of the connection region 236 at opening 234 can be substantially parallel to the flow 242 of medium 180 in the channel 122; and/or the length L_{con} of the connection region can be substantially perpendicular to the flow 242 of medium 180 in the channel 122. The foregoing are examples only, and the relative position of the channel 122 and sequestration pens 224, 226, 228 can be in other orientations with respect to each other.

As illustrated in FIG. 2C, the width W_{con} of the connection region 236 can be uniform from the proximal opening 234 to the distal opening 238. The width W_{con} of the connection region 236 at the distal opening 238 can thus be in any of the ranges identified herein for the width W_{con} of the connection region 236 at the proximal opening 234. Alternatively, the width W_{con} of the connection region 236 at the distal opening 238 can be larger than the width W_{con} of the connection region 236 at the proximal opening 234.

As illustrated in FIG. 2C, the width of the isolation region 240 at the distal opening 238 can be substantially the same as the width W_{con} of the connection region 236 at the proximal opening 234. The width of the isolation region 240 at the distal opening 238 can thus be in any of the ranges identified herein for the width W_{con} of the connection region 236 at the proximal opening 234. Alternatively, the width of the isolation region 240 at the distal opening 238 can be larger or smaller than the width W_{con} of the connection region 236 at the proximal opening 234. Moreover, the distal opening 238 may be smaller than the proximal opening 234 and the width W_{con} of the connection region 236 may be narrowed between the proximal opening 234 and distal opening 238. For example, the connection region 236 may be narrowed between the proximal opening and the distal opening, using a variety of different geometries (e.g. chamfering the connection region, beveling the connection region). Further, any part or subpart of the connection region 236 may be narrowed (e.g. a portion of the connection region adjacent to the proximal opening 234).

FIG. 2D depicts another exemplary embodiment of a micro fluidic device 250 containing a microfluidic circuit 262 and flow channels 264, which are variations of the respective microfluidic device 100, circuit 132 and channel 134 of FIG. 1. The microfluidic device 250 also has a plurality of sequestration pens 266 that are additional variations of the above-described sequestration pens 124, 126, 128, 130, 224, 226 or 228. In particular, it should be appreciated that the sequestration pens 266 of device 250 shown in FIG. 2D can replace any of the above-described sequestration pens 124, 126, 128, 130, 224, 226 or 228 in devices 100, 200, 230, 280, 290, or 320. Likewise, the microfluidic device 250 is another variant of the microfluidic device 100, and may also have the same or a different DEP configuration as the above-described microfluidic device 100, 200, 230, 280, 290, 320 as well as any of the other microfluidic system components described herein.

The microfluidic device 250 of FIG. 2D comprises a support structure (not visible in FIG. 2D, but can be the same or generally similar to the support structure 104 of device 100 depicted in FIG. 1A), a microfluidic circuit structure 256, and a cover (not visible in FIG. 2D, but can be the same or generally similar to the cover 122 of device 100 depicted in FIG. 1A). The microfluidic circuit structure 256 includes a frame 252 and microfluidic circuit material 260, which can be the same as or generally similar to the frame 114 and microfluidic circuit material 116 of device 100 shown in FIG. 1A. As shown in FIG. 2D, the microfluidic circuit 262 defined by the microfluidic circuit material 260 can comprise multiple channels 264 (two are shown but there can be more) to which multiple sequestration pens 266 are fluidically connected.

Each sequestration pen 266 can comprise an isolation structure 272, an isolation region 270 within the isolation structure 272, and a connection region 268. From a proximal opening 274 at the channel 264 to a distal opening 276 at the isolation structure 272, the connection region 268 fluidically connects the channel 264 to the isolation region 270. Generally, in accordance with the above discussion of FIGS. 2B and 2C, a flow 278 of a first fluidic medium 254 in a channel 264 can create secondary flows 282 of the first medium 254 from the channel 264 into and/or out of the respective connection regions 268 of the sequestration pens 266.

FIG. 2F illustrates an example a microfluidic apparatus 600 which comprises an enclosure having a plurality of inlets/outlets 107, a microfluidic channel 622 connected to the inlets/outlets, and a plurality of sequestration pens 616. The microfluidic apparatus 600 further comprises a pair of side channels 642 each of which has openings to both the microfluidic channel 622 and a subset of sequestration pens 616. The side channels 642 connect the sequestration pens 616 to the microfluidic channel 622, allowing for the transport of droplets between the microfluidic channel 622 and the sequestration pens 616, while buffering the openings to the sequestration pens from fluid flow in the microfluidic channel 622 and providing an area for staging of droplets destined for the sequestration pens 616.

In various embodiments of sequestration pens (e.g. 124, 126, 128, 130, 224, 226, 228, or 266), the isolation region (e.g. 240 or 270) is configured to contain a plurality of micro-objects. In other embodiments, the isolation region can be configured to contain only one, two, three, four, five, or a similar relatively small number of micro-objects. Accordingly, the volume of an isolation region can be, for example, at least 1×10⁶, 2×10⁶, 4×10⁶, 6×10⁶ cubic microns, or more.

In various embodiments of sequestration pens, the width W_{ch} of the channel (e.g., 122) at a proximal opening (e.g. 234) can be within any of the following ranges: about 50-1000 microns, 50-500 microns, 50-400 microns, 50-300 microns, 50-250 microns, 50-200 microns, 50-150 microns, 50-100 microns, 70-500 microns, 70-400 microns, 70-300 microns, 70-250 microns, 70-200 microns, 70-150 microns, 90-400 microns, 90-300 microns, 90-250 microns, 90-200 microns, 90-150 microns, 100-300 microns, 100-250 microns, 100-200 microns, 100-150 microns, and 100-120 microns. In some other embodiments, the width W_{ch} of the channel (e.g., 122) at a proximal opening (e.g. 234) can be in a range of about 200-800 microns, 200-700 microns, or 200-600 microns. The foregoing are examples only, and the width W_{ch} of the channel 122 can be in other ranges (e.g., a range defined by any of the endpoints listed above). Moreover, the W_{ch} of the channel 122 can be selected to be in any of these ranges in regions of the channel other than at a proximal opening of a sequestration pen.

In some embodiments, a sequestration pen has a height of about 30 to about 200 microns, or about 50 to about 150 microns. In some embodiments, the sequestration pen has a cross-sectional area of about 1×10⁴-3×10⁶ square microns, 2×10⁴-2×10⁶ square microns, 4×10⁴-1×10⁶ square microns, 2×10⁴-5×10⁵ square microns, 2×10⁴-1×10⁵ square microns or about 2×10⁵-2×10⁶ square microns. In some embodiments, the connection region has a cross-sectional width of about 100 to about 500 microns, 200 to about 400 microns or about 200 to about 300 microns.

In various embodiments of sequestration pens, the height H_{ch} of the channel (e.g., 122) at a proximal opening (e.g., 234) can be within any of the following ranges: 20-100 microns, 20-90 microns, 20-80 microns, 20-70 microns, 20-60 microns, 20-50 microns, 30-100 microns, 30-90 microns, 30-80 microns, 30-70 microns, 30-60 microns, 30-50 microns, 40-100 microns, 40-90 microns, 40-80 microns, 40-70 microns, 40-60 microns, or 40-50 microns. The foregoing are examples only, and the height H_{ch} of the channel (e.g., 122) can be in other ranges (e.g., a range defined by any of the endpoints listed above). The height H_{ch} of the channel 122 can be selected to be in any of these ranges in regions of the channel other than at a proximal opening of a sequestration pen.

In various embodiments of sequestration pens a cross-sectional area of the channel (e.g., 122) at a proximal opening (e.g., 234) can be within any of the following ranges: 500-50,000 square microns, 500-40,000 square microns, 500-30,000 square microns, 500-25,000 square microns, 500-20,000 square microns, 500-15,000 square microns, 500-10,000 square microns, 500-7,500 square microns, 500-5,000 square microns, 1,000-25,000 square microns, 1,000-20,000 square microns, 1,000-15,000 square microns, 1,000-10,000 square microns, 1,000-7,500 square microns, 1,000-5,000 square microns, 2,000-20,000 square microns, 2,000-15,000 square microns, 2,000-10,000 square microns, 2,000-7,500 square microns, 2,000-6,000 square microns, 3,000-20,000 square microns, 3,000-15,000 square microns, 3,000-10,000 square microns, 3,000-7,500 square microns, or 3,000 to 6,000 square microns. The foregoing are examples only, and the cross-sectional area of the channel (e.g., 122) at a proximal opening (e.g., 234) can be in other ranges (e.g., a range defined by any of the endpoints listed above).

In various embodiments of sequestration pens, the length Lₒn of the connection region (e.g., 236) can be in any of the following ranges: about 1-600 microns, 5-550 microns, 10-500 microns, 15-400 microns, 20-300 microns, 20-500 microns, 40-400 microns, 60-300 microns, 80-200 microns, or about 100-150 microns. The foregoing are examples only, and length L_{con} of a connection region (e.g., 236) can be in a different range than the foregoing examples (e.g., a range defined by any of the endpoints listed above).

In various embodiments of sequestration pens the width W_{con} of a connection region (e.g., 236) at a proximal opening (e.g., 234) can be in any of the following ranges: 20-500 microns, 20-400 microns, 20-300 microns, 20-200 microns, 20-150 microns, 20-100 microns, 20-80 microns, 20-60 microns, 30-400 microns, 30-300 microns, 30-200 microns, 30-150 microns, 30-100 microns, 30-80 microns, 30-60 microns, 40-300 microns, 40-200 microns, 40-150 microns, 40-100 microns, 40-80 microns, 40-60 microns, 50-250 microns, 50-200 microns, 50-150 microns, 50-100 microns, 50-80 microns, 60-200 microns, 60-150 microns, 60-100 microns, 60-80 microns, 70-150 microns, 70-100 microns, and 80-100 microns. The foregoing are examples only, and the width W_{con} of a connection region (e.g., 236) at a proximal opening (e.g., 234) can be different than the foregoing examples (e.g., a range defined by any of the endpoints listed above).

In various embodiments of sequestration pens, the width W_{con} of a connection region (e.g., 236) at a proximal opening (e.g., 234) can be at least as largest dimension of a micro-object (e.g., biological cell which may be a T cell, B cell, or an ovum or embryo) that the sequestration pen is intended for. For example, the width W_{con} of a connection region 236 at a proximal opening 234 of an sequestration pen that a droplet will be placed into can be in any of the following ranges: about 100 microns, about 110 microns, about 120 microns, about 130 microns, about 140 microns, about 150 microns, about 160 microns, about 170 microns, about 180 microns, about 190 microns, about 200 microns, about 225 microns, about 250 microns, about 300 microns or about 100-400 microns, about 120-350 microns, about 140-200-200 300 microns, or about 140-200 microns. The foregoing are examples only, and the width W_{con} of a connection region (e.g., 236) at a proximal opening (e.g., 234) can be different than the foregoing examples (e.g., a range defined by any of the endpoints listed above).

In various embodiments of sequestration pens, the width Wₚᵣ of a proximal opening of a connection region may be at least as large as the largest dimension of a micro-object (e.g., a biological micro-object such as a cell) that the sequestration pen is intended for. For example, the width Wₚᵣ may be about 50 microns, about 60 microns, about 100 microns, about 200 microns, about 300 microns or may be in a range of about 50-300 microns, about 50-200 microns, about 50 -100 microns, about 75-150 microns, about 75-100 microns, or about 200-300 microns.

In various embodiments of sequestration pens, a ratio of the length L_{con} of a connection region (e.g., 236) to a width _{Warn} of the connection region (e.g., 236) at the proximal opening 234 can be greater than or equal to any of the following ratios: 0.5, 1.0, 1.5, 2.0, 2.5, 3.0, 3.5, 4.0, 4.5, 5.0, 6.0, 7.0, 8.0, 9.0, 10.0, or more. The foregoing are examples only, and the ratio of the length L_{con} of a connection region 236 to a width Warn of the connection region 236 at the proximal opening 234 can be different than the foregoing examples.

In various embodiments of microfluidic devices 100, 200, 230, 250, 280, 290, 320, 600, 700 Vₘₐₓ can be set around 0.2, 0.3, 0.4, 0.5, 0.6, 0.7, 0.8, 0.9, 1.0, 1.1, 1.2, 1.3, 1.4, or 1.5 μL/sec.

In various embodiments of microfluidic devices having sequestration pens, the volume of an isolation region (e.g., 240) of a sequestration pen can be, for example, at least 5×10⁵, 8×10⁵, 1×10⁶, 2×10⁶, 4×10⁶, 6×10⁶, 8×10⁶, 1×10⁷, 5×10⁷, 1×10⁸, 5×10⁸, or 8×10⁸ cubic microns, or more. In various embodiments of microfluidic devices having sequestration pens, the volume of a sequestration pen may be about 5×10⁵, 6×10⁵, 8×10⁵, 1×10⁶, 2×10⁶, 4×10⁶, 8×10⁶, 1×10⁷, 3×10⁷, 5×10⁷, or about 8×10⁷ cubic microns, or more. In some other embodiments, the volume of a sequestration pen may be about 1 nanoliter to about 50 nanoliters, 2 nanoliters to about 25 nanoliters, 2 nanoliters to about 20 nanoliters, about 2 nanoliters to about 15 nanoliters, or about 2 nanoliters to about 10 nanoliters.

In various embodiment, the microfluidic device has sequestration pens configured as in any of the embodiments discussed herein where the microfluidic device has about 5 to about 10 sequestration pens, about 10 to about 50 sequestration pens, about 100 to about 500 sequestration pens; about 200 to about 1000 sequestration pens, about 500 to about 1500 sequestration pens, about 1000 to about 2000 sequestration pens, or about 1000 to about 3500 sequestration pens. The sequestration pens need not all be the same size and may include a variety of configurations (e.g., different widths, different features within the sequestration pen.

In some other embodiments, the microfluidic device has sequestration pens configured as in any of the embodiments discussed herein where the microfluidic device has about 1500 to about 3000 sequestration pens, about 2000 to about 3500 sequestration pens, about 2500 to about 4000 sequestration pens about 3000 to about 4500 sequestration pens, about 3500 to about 5000 sequestration pens, about 4000 to about 5500 sequestration pens, about 4500 to about 6000 sequestration pens, about 5000 to about 6500 sequestration pens, about 5500 to about 7000 sequestration pens, about 6000 to about 7500 sequestration pens, about 6500 to about 8000 sequestration pens, about 7000 to about 8500 sequestration pens, about 7500 to about 9000 sequestration pens, about 8000 to about 9500 sequestration pens, about 8500 to about 10,000 sequestration pens, about 9000 to about 10,500 sequestration pens, about 9500 to about 11,000 sequestration pens, about 10,000 to about 11,500 sequestration pens, about 10,500 to about 12,000 sequestration pens, about 11,000 to about 12,500 sequestration pens, about 11,500 to about 13,000 sequestration pens, about 12,000 to about 13,500 sequestration pens, about 12,500 to about 14,000 sequestration pens, about 13,000 to about 14,500 sequestration pens, about 13,500 to about 15,000 sequestration pens, about 14,000 to about 15,500 sequestration pens, about 14,500 to about 16,000 sequestration pens, about 15,000 to about 16,500 sequestration pens, about 15,500 to about 17,000 sequestration pens, about 16,000 to about 17,500 sequestration pens, about 16,500 to about 18,000 sequestration pens, about 17,000 to about 18,500 sequestration pens, about 17,500 to about 19,000 sequestration pens, about 18,000 to about 19,500 sequestration pens, about 18,500 to about 20,000 sequestration pens, about 19,000 to about 20,500 sequestration pens, about 19,500 to about 21,000 sequestration pens, or about 20,000 to about 21,500 sequestration pens.

FIG. 2G illustrates a microfluidic device 280 according to one embodiment. The microfluidic device 280 is illustrated in FIG. 2G is a stylized diagram of a microfluidic device 100. In practice the microfluidic device 280 and its constituent circuit elements (e.g. channels 122 and sequestration pens 128) would have the dimensions discussed herein. The microfluidic circuit 120 illustrated in FIG. 2G has two ports 107 and a flow region 106 with four distinct channels 122. The microfluidic device 280 further comprises a plurality of sequestration pens opening off of each channel 122. In the microfluidic device illustrated in FIG. 2G, the sequestration pens have a geometry similar to the pens illustrated in FIG. 2C and thus, have both connection regions and isolation regions. Accordingly, the microfluidic circuit 120 includes both swept regions (e.g. channels 122 and portions of the connection regions 236 within the maximum penetration depth Dₚ of the secondary flow 244) and non-swept regions (e.g. isolation regions 240 and portions of the connection regions 236 not within the maximum penetration depth Dₚ of the secondary flow 244).

In some embodiments, the chamber (or sequestration pen) can include a holding region (e.g., isolation region) configured to hold a liquid droplet, and one (or more) connection region that fluidically connects the holding region to the microfluidic channel. A first connection region can be configured to allow movement of the liquid droplet between the microfluidic channel and the chamber. When a second connection region is present, it can be configured to allow for fluid flow and pressure relief when a liquid droplet is moved between the microfluidic channel and the holding region. In some embodiments, the enclosure can further include a second microfluidic channel. In such embodiments, the chamber can be connected to both the first microfluidic channel and the second microfluidic channel.

In some embodiments, the microfluidic channel(s) can have a height of about 30 to about 200 microns, or about 50 to about 150 microns, with the height measured in a direction normal to the direction of fluid flow through the channel. In some embodiments, the microfluidic channel(s) has a width of about 50 to about 1000 microns, or about 100 to about 500 microns, with the width measured in a direction normal to the direction of fluid flow through the channel.

In some embodiments, the chamber (or sequestration pen) has a height that is substantially the same as the height of the microfluidic channel(s). For example, the chamber height can be about 30 to about 200 microns, or about 50 to about 150 microns. In some embodiments, the chamber (or holding pen) has a cross-sectional area of about 100,000 to about 2,500,000 square microns, or about 200,000 to about 2,000,000 square microns. In some embodiments, the connection region (first, second, etc.) has a height that is substantially the same as the height of the corresponding chamber and/or the microfluidic channel off of which the connection regions opens. In some embodiments, the connection region has a width of about 50 to about 500 microns, or about 100 to about 300 microns.

In some embodiments, the microfluidic device includes a culture chamber (e.g., a sequestration pen) suitable for culturing biological micro-objects. The culture chamber can be located within the enclosure, and can be is connected to a microfluidic channel. When the culture chamber is located within the enclosure, the enclosure can include a perfusion microfluidic channel configured to flow fresh culture medium past the culture chamber such that nutrients in the fresh culture medium and waste products in the culture chamber can be exchanged (e.g., by diffusion of nutrients into the culture chamber and diffusion of waste products out into the culture medium). The perfusion channel can be separate from the microfluidic channel connected to the droplet generator.

H. Surface Modification.

Surfaces of materials, devices, and/or apparatuses for manipulation and storage of biomaterials may have native properties that are not optimized for short and/or long term contact with such material, which may include but is not limited to micro-objects (including but not limited to biological micro-objects such as biological cells), biomolecules, fragments of the biomolecules or biological micro-objects, and any combination thereof. It may be useful to modify one or more surfaces of a material, device or apparatus to decrease one or more undesired phenomena associated with a native surface in contact with one or more biomaterials. In other embodiments, it may be useful to enhance surface properties of the material, device, and/or apparatus to introduce a desired characteristic to the surface, thereby broadening the handling, manipulation or processing capabilities of the material, device, and/or apparatus. To that end, molecules which can modify a surface to either decrease undesired properties or introduce desirable properties are needed.

1. Compounds useful for Modification of Surfaces.

In various embodiments, a surface modifying compound may include a surface modifying ligand which may be a non-polymeric moiety such as an alkyl moiety or a substituted alkyl moiety, such as a fluoroalkyl moiety (including but not limited to a perfluoroalkyl moiety) which covalently modifies the surface to which it is attached. The surface modifying compound also includes a connecting moiety, which is the group which covalently attaches the surface modifying ligand to the surface, as shown schematically in Equation 1. The covalently modified surface has the surface modifying ligand attached via a linking group, which is the product of the reaction of the connecting moiety with functional groups of the surface (including hydroxide, oxide, amine or sulfur).

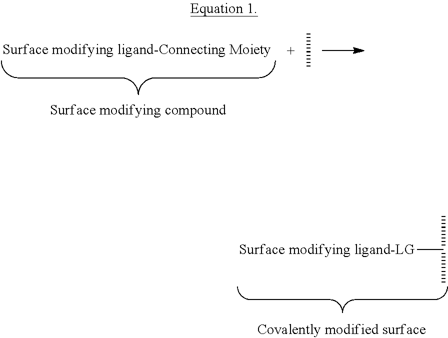

In some embodiments, the surface modifying compound may include carbon atoms forming a linear chain (e.g., a linear chain of at least 10 carbons, or at least 14, 16, 18, 20, 22, or more carbons) and may be an unbranched alkyl moiety. In some embodiments, the alkyl group may include a substituted alkyl group (e.g., some of the carbons in the alkyl group can be fluorinated or perfluorinated). In some embodiments, the alkyl group may include a first segment, which may include a perfluoroalkyl group, joined to a second segment, which may include a non-substituted alkyl group, where the first and second segments may be joined directly or indirectly (e.g., by means of an ether linkage). The first segment of the alkyl group may be located distal to the linking group, and the second segment of the alkyl group may be located proximal to the connecting moiety.

In various embodiments, the surface modifying compound may have a structure of Formula I:

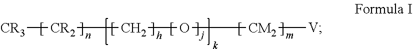

wherein a connecting moiety V is —P(O)(OH)Q- or —Si(T)₂W; W is -T, —SH, or —NH₂ and is the moiety configured to connect to the surface; Q is —OH and is the moiety configured to connect to the surface; and T is OH, OC₁₋₃alkyl, or Cl. R is hydrogen or fluorine and M is hydrogen or fluorine. Each instance of h is 0 or an integer of 2 or 3; j is 0 or 1; k is 0 or is 1; m is 0 or an integer of 1 to 25; and n is 0 or an integer of 1 to 25. In some other embodiments, the sum of (n+[(h+j)·k]+m) may be an integer of 11 to 25. In some embodiments, M is hydrogen. In various embodiments, m is 2. In some embodiments, k is 0. In other embodiments, k is 1. In various embodiments, j is 1. For the compound of Formula I, when k is an integer of 1, then m may be at least 2 and M is hydrogen. For the compound of Formula I, when k is 0 and R is fluorine, then m may be at least 2 and M is hydrogen.

In various embodiments, where the surface modifying compound has a structure of Formula I, the connecting moiety V may be —Si(T)₂W, where T and W are defined as above. W may be OC₁₋₃alkyl, or Cl. W may be methoxy, ethoxy or propoxy. In some embodiments, W may be methoxy. T may be may be OC₁₋₃alkyl, or Cl. In various embodiments, connecting moiety V is —Si(OMe)₃. In various other embodiments, V may be —P(O)(OH)Q, where Q is OH.

The surface modifying compound of Formula 1 may have a preferred range of number of atoms making up the linear backbone of the compound. As defined above each of the segments that make up the compound of Formula 1 may have a range of sizes. Accordingly, a compound of Formula 1 may have repeating units as defined above such that (n+[(h+j)·k]+m) is equal to 25, which would yield a total length of 26 atoms, including the terminal CR₃-group, attached to the connecting moiety. In the instance of (n+[(h+j)·k]+m) equal to 25, a variety of different compositions can be encompassed. For instance, the segment —[CR₂]ₙ— may have n=23; —[(CH₂)ₕ—(O)ⱼ]ₖ— may have k=0; and —[CM₂]m- may have m=2. Another instance having the same total (n+[(h+j)·k]+m) equal to 25, may have segment —[CR₂]n- where n=6; —[(CH₂)ₕ—(O)ⱼ]ₖ— where k=3, and includes j=1 and h=2; and —[CM₂]m- may have m=4.

In some embodiments, the sum of (n+[(h+j)·k]+m) may be 11, 13, 15, 17, or 21. In other embodiments, the sum of (n+[(h+j)·k]+m) may be 15 or 17. In yet other embodiments, the sum of (n+[(h+j)·k]+m) may be 13 or 15.

In some embodiments, one or more ether linkages may be present in the compound of Formula I. In some embodiments, j may be 1. In some embodiments, where k and j are both 1, m may be at least two. In some embodiments, where k and j are both 1, h may be 0.

In yet other embodiments, backbone carbons may be fluorinated. In some embodiments, backbone carbons may be perfluorinated, where each R of CR₃—, and/ or —[CR₂]ₙ— and/or —[CM₂]ₘ- may be fluorinated. In some embodiments, a section of the compound may have carbon backbone atoms that are fluorinated and other sections of the compound may have carbon backbone atom that are substituted with hydrogen. For example, in some embodiments, CR₃— and —[CR₂]ₙ— segments may have fluorine nonbackbone substituents (e.g., R is fluorine) while —[CM]ₘ- segments may have hydrogen nonbackbone substituents (e.g., M is hydrogen). In some embodiments, when R is fluorine, then k is 0. In other embodiments, R may be fluorine and k is 1, j is 1 and h is 2. In various embodiments, M may be hydrogen.

In yet other embodiments, the compound of Formula 1 may be synthesized from hydrosilation of an olefin as described below, where m is at least two and M is hydrogen. In some embodiments, m is 2 and M is hydrogen.

Some of the variety of compounds of Formula I may be more readily seen in subsets of compounds described in the following formulae, but these formulae are in no way limiting to the breadth of Formula I.

In some embodiments, the compound of Formula I may include a compound of Formula 110:

CH₃(CH₂)ₘSi(OC₁₋₃alkyl)₃ ; Formula 110

where m is an integer of 9 to 23. In some embodiments, m may be 11, 13, 15, 17, or 19. In some other embodiments m may be 13 or 15.

In other embodiments, the compound of Formula I may include a compound of Formula 111:

CF₃(CF₂)ₙ(CH₂)₂Si(OC₁₋₃alkyl)₃; Formula 111

where n may be an integer of 9 to 22. Alternatively, n may be an integer of 11 to 17. In some other embodiments, n may be 9, 11, 13, or 15. In some embodiments, n may be 13 or 15.

In yet other embodiments, the compound of Formula I may include a compound of Formula 112:

CR₃(CR₂)ₙ(CH2(ₕ(CH₂)ₘSi(OC₁₋₃alkyl)₃; Formula 112

where n is an integer of 3 to 19; his an integer of 2 or 3; and m is an integer of 2 to 18. In some embodiments, R may be fluorine. In some embodiments n may be an integer of 3 to 11, h may be 2, and m may be an integer of 2 to 15.

Alternatively, the compound of Formula I may include a compound of Formula 113:

CR₃(CR₂)ₙ (CM₂)ₘP (O)(OH)₂; Formula 113

where n is an integer of 3 to 21; and m is an integer of 2 to 21. In some embodiments of the compound of Formula 113, R may be fluorine. In some embodiments, M may be hydrogen. In various embodiments, n may be 5, 7, 9, or 11. In other embodiments, m may be 2, 4, 5, 7, 9, 11 or 13.

2. Surfaces for Modification.

A surface capable of being modified by the surface modifying compounds described herein, including a compound of Formula I, may be a metal, metal oxide, glass or polymer. Some materials that may have a covalently modified surface introduced therein in may include but not be limited to silicon and its oxides, silicones, aluminum or its oxide thereof (Al₂O₃), Indium Tantalum Oxide (ITO), titanium dioxide (TiO₂), zirconium oxide (ZrO2), hafnium(IV) oxide (HfO₂), tantalum (V) oxide (Ta₂O₅), or any combination thereof. The surface may be a wafer or sheet of these materials, or may be incorporated within an apparatus or device. In some embodiments, the surface including any of these materials may be incorporated within a microfluidic device as described herein.

Polymers may include any suitable polymer. A suitable polymer may include but is not limited to (e.g. rubber, plastic, elastomer, silicone, organosilicone, such as polydimethylsiloxane (“PDMS”), or the like), which can be gas permeable. Other examples can include molded glass, a patternable material such as a silicone polymer (e.g. photo-patternable silicone or “PPS”), photo-resist (e.g., an epoxy-based photo-resist such as SU8), or the like. In other embodiments, a surface of a material such as a natural fiber or wood may be functionalized by the surface modifying compounds described herein, including a compound of Formula I, to introduce a covalently modified surface.

The surface to be modified may include a nucleophilic moiety including but not limited to hydroxide, amino and thiol. The nucleophilic moiety (e.g., hydroxide (in some embodiments referred to as oxide)) on the surface may react with the surface modifying compounds described herein, including a compound of Formula I, to covalently link the surface modifying ligand to the surface, via a siloxy linking group or phosphonate linking group, to provide the functionalized surface. The surface to be modified may include native nucleophilic moieties, or may be treated with reagents (e.g., piranha solution) or by plasma treatment to introduce nucleophilic moieties (e.g., hydroxide (alternatively referred to as oxide)).

In some embodiments, the surface may be formed from any of the above materials, singly or in any combination. The surface may include a semiconductor substrate. In various embodiments, the surface including a semiconductor substrate may further include a DEP or EW substrate as described herein. In some embodiments, the surface including a semiconductor substrate having a DEP or EW substrate may be part of a microfluidic device as described herein.

In some embodiments, the modified surface may be at least one inward-facing surface of a microfluidic device as described herein. The at least one surface may be part of the flow region of the microfluidic device (which may include a channel) or may include a surface of an enclosed structure such as a pen, which may include a sequestration pen as described herein.

3. Covalently Modified Surface.

A covalently modified surface may include a surface modifying ligand, which may be a non-polymeric moiety such as an alkyl moiety, a substituted alkyl moiety, such as a fluoroalkyl moiety (including but not limited to a perfluoroalkyl moiety) and may be any surface modifying ligand described above, which is covalently bound to the surface via a linking group, which is the moiety resultant from reaction of the connecting moiety with the surface. The linking group may be a siloxy linking group or a phosphonate linking group. Siloxy and phosphonate linking groups are also referred to herein as siloxane and phosphonic acid linking groups, respectively.

In some embodiments, the surface modifying ligand may include carbon atoms forming a linear chain (e.g., a linear chain of at least 10 carbons, or at least 14, 16, 18, 20, 22, or more carbons) and may be an unbranched alkyl moiety. In some embodiments, the alkyl group may include a substituted alkyl group (e.g., some of the carbons in the alkyl group can be fluorinated or perfluorinated). In some embodiments, the alkyl group may include a first segment, which may include a perfluoroalkyl group, joined to a second segment, which may include a non-substituted alkyl group, where the first and second segments may be joined directly or indirectly (e.g., by means of an ether linkage). The first segment of the alkyl group may be located distal to the linking group, and the second segment of the alkyl group may be located proximal to the linking group.

### a) Covalently Modified Surface of Formula II.

In some embodiments, a covalently modified surface has a structure of Formula II:

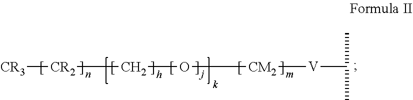

wherein [symbol] is the surface; V is —P(O)(OY)W— or —Si(OZ)₂W. W is —O—, —S—, or —NH— and connects to the surface. Z is a bond to an adjacent silicon atom attached to the surface or is a bond to the surface. Y is a bond to an adjacent phosphorus atom attached to the surface or is a bond to the surface. For the covalently modified surface of Formula II, R, M, h, j, k, m, and n are as defined above for Formula I. When k is an integer of 1, then m is at least 2 and M is hydrogen. When k is 0 and R is fluorine, then m is at least 2 and M is hydrogen. The covalently modified surface of Formula II can be described as a surface modifying ligand attached via a linking group LG, as in Formula IIA, where LG is linked to the surface:

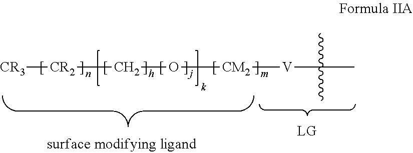

The covalently modified surface may include any surface of Formula II, in any combination, as described above for the surface modifying compound of Formula I.

In some embodiments, the covalently modified surface of Formula II may be a surface of Formula 210:

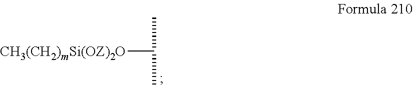

wherein [symbol] is the surface, oxygen attached to the silicon atom is also bound to the surface, and m is an integer of 11 to 23. In some embodiments, m may be 11, 13, 15, 17, or 19. In some other embodiments m may be 13 or 15.

In some other embodiments, the covalently modified surface of Formula II may be a surface of Formula 211:

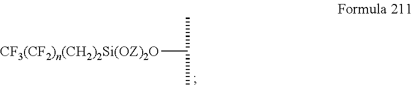

wherein [symbol] is the surface, oxygen attached to the silicon atom is also bound to the surface, and n may be an integer of 9 to 22. Alternatively, n may be an integer of 11 to 17. In some other embodiments, n may be 7, 9, 11, 13, or 15. In some embodiments, n may be 13 or 15.

In yet other embodiments, the covalently modified surface of Formula II may be a surface of Formula 212:

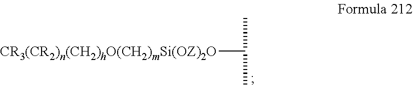

wherein [symbol] is the surface, oxygen attached to the silicon atom is also bound to the surface, and n is an integer of 3 to 21, his an integer of 2 or 3, and m is an integer of 2 to 21. In some embodiments, R may be fluorine. In some embodiments, n may be an integer of 3 to 11, h may be 2, and m may be an integer of 2 to 15.

Alternatively, the covalently modified surface of Formula II may be a surface of Formula 213:

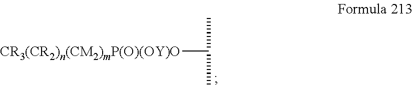

wherein [symbol] is the surface, oxygen attached to the phosphorus atom is also bound to the surface, n is an integer of 3 to 21 and m is an integer of 2 to 21. In some embodiments of the compound of Formula 113, R may be fluorine. In some embodiments, M may be hydrogen. In various embodiments, n may be 5, 7, 9, or 11. In other embodiments, m may be 2, 4, 5, 7, 9, 11 or 13.

In some embodiments, the microfluidic device comprises a flow region fluidically connected to a first inlet and a first outlet, the flow region configured to contain a flow of a first fluidic medium. The microfluidic device may include one or more chambers opening to the flow region. The covalently modified surface may be a covalently modified substrate of the microfluidic device and may underlay the flow region and/or at least one chamber. In some embodiments, all or substantially all the interior surfaces of the microfluidic device configured to face fluid have a covalently modified surface of Formula II.

### b) Additional Hydrophobic Layers

In some embodiments, the microfluidic device comprises a droplet actuation surface comprising a hydrophobic layer which is covalently bonded to a dielectric layer of the device. In some embodiments, the hydrophobic layer is a monolayer. In some embodiments, the hydrophobic layer is a monolayer comprising a surface modifying ligand and a linking group that links the surface modifying ligand to the surface.

In some embodiments, the outer hydrophobic layer of the substrate has a thickness of less than 5 nanometers (e.g., about 1.5 to 3.0 nanometers). In some embodiments, the outer hydrophobic layer of the substrate can be patterned such that select regions are relatively hydrophilic compared to the remainder of the outer hydrophobic layer.

In some embodiments, the outer hydrophobic layer comprises self-associating molecules covalently bonded to the inner dielectric layer (e.g., through a linker) so as to form a densely-packed hydrophobic monolayer. In some embodiments, the self-associating molecules of the hydrophobic monolayer each comprise a siloxane group (e.g., as part of the linker). For example, the siloxane group can have the formula —Si(OZ)₂W— wherein W is —O—, —S—, or —NH— and connects to the surface; and Z is a bond to an adjacent silicon atom attached to the surface (such as through another W bonded directly to the silicon) or is a bond to the surface. In other embodiments, the self-associating molecules of the hydrophobic monolayer each comprise a phosphonic acid group (e.g., as part of the linker). For example, the phosphonic acid group can have the formula —P(O) (OY)W— wherein W is —O—, —S—, or —NH— and connects to the surface; and Y is a bond to an adjacent phosphorus atom attached to the surface (such as through another W bonded directly to the phosphorus) or is a bond to the surface. The siloxane groups or the phosphonic acid groups can be covalently bonded to the surface of the inner dielectric layer, e.g., through an oxygen. In some embodiments, the self-associating molecules of the hydrophobic monolayer each comprise a surface modifying ligand and a linking group that links, either directly or indirectly, the surface modifying ligand to the surface of the inner dielectric layer. The surface modifying ligand can be any surface modifying ligand disclosed herein. For example, the surface modifying ligand can comprise an aliphatic group, such as an alkane group. Thus, for example, the self-associating molecules of the hydrophobic monolayer can be alkyl-terminated siloxane or alkyl-terminated phosphonic acid molecules. The alkyl groups can include a chain (e.g., an unbranched chain) of at least 10 carbons (e.g., at least 12, 14, 16, 18, 20, 22, or more carbons). In other embodiments, the surface modifying ligand can comprise a fluorine-substituted aliphatic group, such as a fluoroalkyl group. Thus, for example, the self-associating molecules can be fluoroalkyl-terminated siloxane or fluoroalkyl-terminated phosphonic acid molecules. The fluoroalkyl groups can include a chain (e.g., an unbranched chain) of at least 10 carbons (e.g., at least 12, 14, 16, 18, 20, 22, or more carbons). In certain embodiments, the fluoroalkyl groups include one or more (e.g., at least 4, 5, 6, 7, 8, 9, 10, 11, 12, or more) perfluorinated carbons. For example, the fluoroalkyl groups can have the chemical formula CF₃-(CF₂)ₘ—(CH₂)ₙ—, wherein m is at least 2, n is at least 2, and m+n is at least 9. In some embodiments, the surface modifying ligand comprises an ether linkage between a first aliphatic group and a second aliphatic group. For example, the first aliphatic group can be an alkyl group and the second aliphatic group can be a fluoroalkyl group (e.g., a perfluoroalkyl group). In certain embodiments, the alkyl or fluoroalkyl group of the surface modifying ligand is unbranched. In some embodiments, the alkyl or fluoroalkyl group of the surface modifying ligand does not contain any cyclic structures.

The surface may be modified with covalently bound molecules having (i) a linker (e.g., as described above) and (ii) an unbranched alkane group (i.e., —(CH₂)ₙ—CH₃, where n=9 or greater, e.g., 11 or 15 or greater). In another aspect, a surface of the chip may be modified with covalently bound molecules having (i) a linker (e.g., as described above), (ii) a short unbranched alkane, and (iii) a perfluoroalkane group (i.e., —(CH₂)n-(CF₂)m-CF₃, wherein n=2 or greater and m=5 or greater, e.g., 7, 9, 11, 13 or greater). In some embodiments, the combination of the short unbranched alkane and the perfluoroalkane group is —(CH₂)₂—(CF₂)₁₃—CF₃. In some embodiments, the unbranched alkane group is C18 group (i.e., —(CH₂)₁₇—CH3). The linker may be a siloxane (e.g., —Si(OZ)₂—O—, where Z is bound to an adjacent Si atom or the surface) or a phosphonic acid (e.g., —P(O)(OY)—, where Y is bound to an adjacent P atom or the surface). In one embodiment, the linker is a siloxane linker.

In some embodiments, the hydrophobic layer is a monolayer comprising a surface modifying ligand and a linking group that links the surface modifying ligand to the surface, having a structure of:

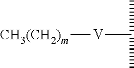

where [symbol] is the surface, V is a linker, m is an integer of 9 or 11 or greater (“SSRL1 coating” hereafter). In some embodiments, V is —Si(OZ)₂W—; W is —O— and connects to the surface; and Z is a bond to an adjacent silicon atom attached to the surface or is a bond to the surface. Alternatively, W can be —O—, —S—, or —NH—. In some embodiments, V is —P(O)(OY)W—; W is —O— and connects to the surface; Y is a bond to an adjacent phosphorus atom attached to the surface or is a bond to the surface. Alternatively, W can be —O—, —S—, or —NH—. In some embodiments, m is an integer of 15 or greater. In some embodiments, m ranges from 12 to 25, 12 to 21, 15 to 25, 15 to 21, 15 to 19, or 16 to 18. In some embodiments, m is 15, 17 or 19. In some embodiments, m is 17.

In some embodiments, the hydrophobic layer is a monolayer comprising a surface modifying ligand and a linking group that links the surface modifying ligand to the surface, having a structure of:

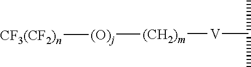

where [symbol] is the surface, V is a linker, n+m+j is 13 or greater, n is at least 5, m is 2 or greater, and j is 0 or 1 (“SSRL2 coating” hereafter). In some embodiments, V is —Si(OZ)₂W—; W is —O— and connects to the surface; and Z is a bond to an adjacent silicon atom attached to the surface or is a bond to the surface. Alternatively, W can be —O—, —S—, or —NH—. In some embodiments, V is —P(O)(OY)W—; W is —O— and connects to the surface; Y is a bond to an adjacent phosphorus atom attached to the surface or is a bond to the surface. Alternatively, W can be —O—, —S—, or —NH—. In some embodiments, n is at least 7, at least 9, at least 11, at least 13, or greater. In some embodiments, m ranges from 2 to 13, 2 to 10, 2 to 8, 2 to 6, or 2 to 4. In some embodiments, m is 2. In some embodiments, wherein n is 11 or 13.

FIG. 2E depicts a cross-sectional view of a microfluidic device 290 having an exemplary covalently linked coating material providing a conditioned surface. As illustrated, the coating materials 298 (shown schematically) can comprise a monolayer of densely-packed molecules covalently bound to both the inner surface 294 of a base 288, which may be a DEP or EW substrate, and the inner surface 292 of a cover 286 of the microfluidic device 290. The coating material 298 can be disposed on substantially all inner surfaces 294, 292 proximal to, and facing inwards towards, the enclosure 284 of the microfluidic device 290, including, in some embodiments and as discussed above, the surfaces of microfluidic circuit material (not shown) used to define circuit elements and/or structures within the microfluidic device 290. In alternate embodiments, the coating material 298 can be disposed on only one or some of the inner surfaces of the microfluidic device 290.

In the embodiment shown in FIG. 2E, the covalently modified surface 298 comprises a monolayer of alkyl-terminated siloxane molecules, each molecule covalently bonded to the inner surfaces 292, 294 of the microfluidic device 290 via a siloxy linker 296. For simplicity, additional silicon oxide bonds are shown linking to adjacent silicon atoms, but the disclosure is not so limited. In some embodiments, the covalently modified surface 298 can comprise a fluoroalkyl group (e.g. a fluorinated alkyl group or a perfluorinated alkyl group) at its enclosure-facing terminus (i.e. the portion of the monolayer of the surface modifying ligand 298 that is not bound to the inner surfaces 292, 294 and is proximal to the enclosure 284). While FIG. 2E is discussed as having an alkyl -terminated modified surface, any suitable surface modifying compound may be used, as described herein.

4. Native Surface.

The at least one surface of the microfluidic device to be modified may be glass, metal, metal oxide or polymer. Some materials that may be incorporated within the microfluidic device and may be modified to have a covalently modified surface of Formula II introduced therein in may include but not be limited to silicon and its oxides, silicones, aluminum or its oxide thereof (Al₂O₃), Indium Tantalum Oxide (ITO), titanium dioxide (TiO₂), zirconium oxide (ZrO2), hafnium(IV) oxide (HfO₂), tantalum (V) oxide (Ta₂O₅), or any combination thereof. Polymers may include any suitable polymer. A suitable polymer may include but is not limited to (e.g. rubber, plastic, elastomer, silicone, organosilicone, such as polydimethylsiloxane (“PDMS”), or the like), which can be gas permeable. Other examples can include molded glass, a patternable material such as a silicone polymer (e.g. photo-patternable silicone or “PPS”), photo-resist (e.g., an epoxy-based photo-resist such as SU8), or the like.

5. Physical and Performance Properties of the Covalently Modified Surface.

In some embodiments, the covalently modified surface may have increased hydrophobic character. The increased hydrophobic character of the modified surface may prevent fouling by biomaterials. Surface fouling, as used herein, refers to the amount of material indiscriminately deposited on the surface of the microfluidic device, which may include permanent or semi-permanent deposition of biomaterials such as protein and degradation products, nucleic acids, and respective degradation products. Such fouling can increase the amount of adhesion of biological micro-objects to the surface. In other embodiments, increased hydrophobic character of a covalently modified surface may decrease adhesion of biological micro-objects on the surface, independently of adhesion initiated by surface fouling.

Modification of the surface may increase the durability, functionality, and/or biocompatibility of the surface. Each of these characteristics may further benefit the viability (including growth rate and/or cell doubling rate), nature of the colony formed upon a covalently modified surface as described herein, including a surface having a structure of Formula II, or portability (including viability upon export) of micro-objects or biomolecules upon the modified surface and within devices and/or apparatuses having a covalently modified surface.

In some embodiments, the covalently modified surface, which may be any surface as described herein, including a surface of Formula II, may have a thickness of less than 10 nm (e.g., less than about 7 nm, less than about 5 nm, or about 1.5 to 3.0 nm). This may provide an advantageously thin layer on the modified surface, particularly in contrast with other hydrophobic materials such as CYTOP®, a perfluoro tetrahydrofuranyl polymer which is spin-coated yielding a typical thickness of about 30 to 50 nm. Data shown in Table 1 is for a silicon/silicon oxide surface which is treated to have a covalently modified surface as shown in the table. Contact angle measurements were obtained using the static sessile drop method. (Drelich, J. Colloid Interface Sci. 179, 37-50, 1996.) Thickness was measured by ellipsometry.

Contact angle hysteresis measurements were performed using a Biotin Scientific contact angle goniometer. Chemically modified OEW surfaces were placed in a bath of 5 cSt silicone oil encased in a transparent holder. A phosphate buffered saline (PBS) droplet was then dispensed onto the surface in the oil. A platinum (Pt) wire electrode was inserted into the droplet, and the sessile water contact angle was measured. Next, an applied AC voltage of 50 Vppk at 30 kHz frequency was applied between the OEW substrate and the Pt wire inserted into the PBS droplet for 10 seconds. Next, the applied voltage was removed, and the contact angle was measured again. The contact angle hysteresis was calculated by subtracting the contact angle at zero bias after applying the 50Vppk AC voltage from the original contact angle at zero bias before applying the voltage.

TABLE 1
Physical data for selected surfaces.

| | | Contact | | |
|---|---|---|---|---|
| | | Angle | | |
| | | (water or | Contact | |
| | | aqueous | angle | |
| No. | Modified Surface | solution) | hysteresis | Thickness |
| 201 | CH₃(CH₂)₁₇—Si(OT)₂O- | 110-112° | 5°, less | Approx. 2 nm |
| | (surface) | | than 10° | |
| 202 | CF₃(CF₂)₁₃(CH₂)₂Si(OT)₂O- | 110-115° | data | Approx. 2 nm |
| | (surface) | | | |
| 203 | CF₃(CF₂)₇(CH₂)₂Si(OT)₂O- | 110-115° | >10° | Approx 1 nm |
| | (surface) | | | |
| 204 | CH₃(CH₂)₂₁Si(OT)₂O- | 110-112° | n/a | Approx. 2- |
| | (surface) | | | 2.5 nm |
| 205 | CH₃(CH₂)₁₅Si(OT)₂O- | 110-112° | >10° | n/a |
| | (surface) | | | |
| 206 | CF₃(CF₂)₅(CH₂)₂O(CH₂)₁₁Si(OT)₂O- | 110-114° | n/a | Approx. 2 nm |
| | (surface) | | | |
| 207 | CH₃(CH₂)₁₇P(O)(OQ)O- | 110° | n/a | n/a |
| | (surface) | | | |
| 208 | CF₃(CF₂)₇(CH₂)₁₁Si(OT)₂O- | 113° | n/a | Approx. 2 nm |
| | (surface) | | | |
| 209 | CF3(CF2)₁₁(CH₂)₂Si(OT)₂O- | 112° | n/a | Approx. 1.5-2 |
| | (surface) | | | nm |

T and Q are as described above.

The contact angles observed for modified surfaces are in contrast to the contact angle for water on a plasma cleaned silicon surface of less than 10 degrees. Each of these surfaces is less wettable than that of the native silicon/silicon oxide surface.

Other analytical methods suitable to characterize the surface can include infrared spectroscopy and/or X-ray photoelectron spectroscopy.

Another desirable characteristic of the modified surfaces of the disclosure is a lack of autofluorescence, which can be dependent upon the chemical nature of the surface modifying compound.

In some embodiments, the covalently modified surface described herein, including a surface of Formula II, may form a monolayer. The uniformity and evenness of a monolayer modified surface may provide advantageous performance, particularly if the monolayer modified surface has other functional attributes. For example, the covalently modified surface described herein, including a surface of Formula II, may also include an electrode activation substrate, and optionally further may include a dielectric layer, as may be found in materials, devices and/or apparatuses having a dielectrophoresis configuration or an electrowetting configuration. The lack of unsaturation of the perfluoroalkyl moieties of the modified surface can minimize “charge trapping” compared to a monolayer containing, for example olefinic or aromatic moieties. Additionally, the densely packed nature of the monolayer formed in the surface described herein, including a surface of Formula II, may minimize the potential for cations to be driven through the monolayer to the underlying metal, metal oxide, glass or polymer substrate. Without being limited by theory, the disruption of the substrate surface by addition of cations to substrate composition may disrupt the electrical properties of the substrate, thereby reducing its ability to function electrokinetically.

Further, the ability to introduce the modified surface via a covalent linkage may increase the dielectric strength of the modified surface and protect the underlying material from breakdown under application of an electric field. The uniformity and thinness of an dielectrophoretic or electrowetting surface of a material, device and/or apparatus having a covalently modified surface described herein, including a surface of Formula II, may further provide advantageous benefit for such modified dielectrophoretic and/or electrowetting surface when the material, device and/or apparatus is optically actuated.

6. Methods of Preparation of the Covalently Modified Surface.

A surface of a material that may be used as a component of a device or apparatus may be modified before assembly of the device or apparatus. Alternatively, partially or completely constructed device or apparatus may be modified such that all surfaces that will contact biomaterials including biomolecules and/or micro-objects (which may include biological micro-objects) are modified at the same time. In some embodiments, the entire interior of a device and/or apparatus may be modified, even if there are differing materials at different surfaces within the device and/or apparatus. In some embodiments, the partially or completely constructed device and/or apparatus may be a microfluidic device as described herein, or a component thereof.

The surface to be modified may be cleaned before modification to ensure that the nucleophilic moieties on the surface are freely available for reaction, e.g., not covered by oils or adhesives. Cleaning may be accomplished by any suitable method including treatment with solvents including alcohols or acetone, sonication, steam cleaning and the like. In some embodiments, the surface to be modified is treated with oxygen plasma treatment which removes contaminants, which at the same time, can introduce additional oxide (e.g., hydroxide) moieties on the surface. This can advantageously provide more sites for modification on the surface, thereby providing a more closely packed modified surface layer.

The surface to be modified may be cleaned before modification to ensure that the nucleophilic moieties on the surface are freely available for reaction, e.g., not covered by oils or adhesives. Cleaning may be accomplished by any suitable method including treatment with solvents including alcohols or acetone, sonication, steam cleaning and the like. In some embodiments, the surface to be modified is treated with oxygen plasma treatment which removes contaminants, which at the same time, can introduce additional oxide (e.g., hydroxide) moieties on the surface. This can advantageously provide more sites for modification on the surface, thereby providing a more closely packed modified surface layer.

In some embodiments, the method of covalently modifying a surface includes the steps of: contacting the surface with a compound of Formula I:

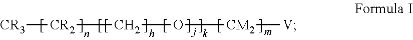

where V is —P(O)(OH)Q or —Si(T)₂W. W is -T, —SH, or —NH₂ and is the moiety configured to connect to the surface. Alternatively, when V is —P(O)(OH)Q, Q is —OH and is the moiety configured to connect to the surface. T is OH, OC₁₋₁₃alkyl, or Cl. Each of R, M, h, j, k, m, and n are as defined above for the compound of Formula I. The sum of (n+[(h+j)·k]+m) is an integer of 11 to 25. In various embodiments, when k is an integer of 1, then m is at least 2 and M is hydrogen; and when k is 0 and R is fluorine, then m is at least 2 and M is hydrogen. The compound of Formula I reacts with a nucleophilic moiety of the surface; and the covalently modified surface is formed. Any combination or subcombination of the compound of Formula I may be used, as described above.

In various embodiments of the method, the covalent modified surface so formed may be a monolayer.

In some embodiments of the method, the compound of Formula I may be a compound of Formula 110:

CH₃(CH₂)ₘSi(OC₁₋₃alkyl)₃ ; Formula 110

where m is an integer of 9 to 23. In some embodiments, m may be 11, 13, 15, 17, or 19. In some other embodiments m may be 13 or 15.

In other embodiments of the method, the compound of Formula I may be a compound of Formula 111:

CF₃(CF₂)ₙ(CH₂)₂Si(OC₁₋₃alkyl)₃; Formula 111

where n is an integer of 9 to 22. Alternatively, n may be an integer of 11 to 17. In other embodiments, n may be an integer of 11 to 17. In some other embodiments, n may be 9, 11, 13, or 15. In some embodiments, n may be 13 or 15.

In yet other embodiments of the method, the compound of Formula I may be a compound of Formula 112:

CR₃(CR₂)ₙ(CH2)ₕO(CH₂)ₘSi(OC₁₋₃alkyl)₃; Formula 112

where n is an integer of 3 to 21; his an integer of 2 or 3; and m is an integer of 2 to 21. In some embodiments, R may be fluorine. In some embodiments n may be an integer of 3 to 11, h may be 2, and m may be an integer of 2 to 15.

Alternatively, the surface may be contacted by a compound of Formula I which may be a compound of Formula 113:

CR₃(CR₂)ₙ(CM₂)ₘP(O)(OH)₂; Formula 113

where n is an integer of 3 to 21; and m is an integer of 2 to 21. In some embodiments of the compound of Formula 113, R may be fluorine. In some embodiments, M may be hydrogen. In various embodiments, n may be 5, 7, 9, or 11. In other embodiments, m may be 2, 4, 5, 7, 9, 11 or 13.

The contacting step may be performed by contacting the surface with a liquid solution containing the compound of Formula I. For example, surfaces may be exposed to solutions containing 0.01 mM, 0.1 mM, 0.5 mM,1 mM, 10 mM, or 100 mM of the compound of Formula I. The reaction may be performed at ambient temperature and may be carried out for a period of time in the range of about 2h, 4h, 8h, 12 h, 18h, 24h, or any value in between. Examples of solvents include but are not limited to: toluene, 1,3 bistrifluorobenzene, or Fluorinert™ (3M) fluorinated solvents. An acid such as acetic acid may be added to the solution to increase the reaction rate by promoting hydrolysis of the trialkoxy groups, if present.

Alternatively, the surface may be contacted with a vapor phase containing the compound of Formula I. In some embodiments, when the reacting step is performed by contacting the surface with the compound of Formula I in the vapor phase, a controlled amount of water vapor is also present. The controlled amount of water vapor may be provided by placing a preselected amount of magnesium sulfate heptahydrate in the same chamber or enclosure with the object having the surface to be modified. In other embodiments, a controlled amount of water may be introduced into the reaction chamber or enclosure via an external water vapor feed. The reaction may take place under reduced pressure, relative to atmospheric pressure. In some embodiments, the reduced pressure may be 100 Torr or less. In other embodiments, the reduced pressure may be less than 10 Torr or less than 1 Torr.

The reaction may be conducted at a temperature in a range from about 150° C. to about 200° C. In various embodiments, the reaction may be conducted at a temperature of about 150° C., 155° C., 160° C., 165° C., 170° C., 175° C., 180° C., 185° C., or about 190° C. The reaction may be permitted to continue for about 2h, 6h, 8h, 18h, 24h, 48h, 72 h, 84h, or more.

In some embodiments, the covalently modified surface may have a structure of Formula II:

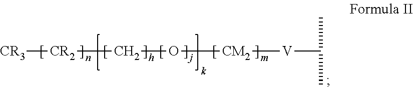

wherein R, M, n, h, j, k, m and V are as described above, in any combination. In some embodiments of the method, the covalently modified surface may have a formula of Formula 210, 211, 212, or 213 as described above, having any combination of permissible elements for each formula.

In various embodiments of the method, the surface may include a nucleophilic moiety selected from the group consisting of hydroxide, amino and thiol. The surface may be a metal, metal oxide, glass, polymer, or any combination thereof. The metal surface may include silicon, silicon oxide, hafnium oxide, indium tantalum oxide, alumina, or any combination thereof.

In various embodiments of the method, wherein the step of forming covalently modified surface may be performed on a DEP substrate or a EW substrate. The step of forming the covalently modified surface may include forming the covalently modified surface on at least one surface of a microfluidic circuit element of a microfluidic device. The microfluidic circuit elements may include walls, flow regions, pens, and electrode activation substrates, including DEP or EW substrates. The surface within the microfluidic circuit which may be covalently modified, may be all or substantially all of the surfaces facing fluid bearing portions of a microfluidic device. For example, in microfluidic devices 200, 230 the inner surface of the top electrode 210, the upper surface of the electrode activation substrate 206, the surfaces of the microfluidic circuit material 116 (See FIGS. 1B, 1E, 2A, 2B), all of which face the microfluidic channel 122 and pens 244, 246, 248 may be modified. Similarly, in FIG. 2D, the inner surfaces of microfluidic circuit material 260, surfaces of isolation structures 272 which define the sequestration pen 266, or all the surfaces facing the microfluidic circuit 262 may be modified covalently by the methods described herein.

I. Immiscible Medium.

Movement of aqueous droplets upon the surface of the substrate may be performed within a water immiscible fluidic medium distributed regionally within one or more flow regions (which may include flow channels) and, if present, within chambers fluidically connected to the flow regions. The water immiscible fluidic medium may have a kinematic viscosity greater than that of a droplet of pure water. The water immiscible fluidic medium may have a kinematic viscosity in the range of about 1 Centistoke (cSt) to about 15 cSt, where 1 cSt is equal to 1 millipascal or to 1 centipoise (CPS). In some embodiments, the water immiscible fluidic medium may have a viscosity in the range of about 3 cSt to about 10 cSt or about 3cSt to about 8 cSt. The water immiscible fluidic medium may be nonflammable at temperatures of at least 100° C. The water immiscible fluidic medium may be non-toxic to living biological cells over the duration of time that biological cells are processed, cultured or stored within the aqueous droplet within the water immiscible fluidic medium.

The water immiscible fluidic medium may have low or very little solubility in water. The water immiscible fluidic medium may dissolve less than about 5%, 4%, 3%, 2%, 1% or less than 1% of its total volume of water, when contacted with a layer of water (e.g., partitioning with water). The water immiscible fluidic medium may not solubilize more than about 5%, about 10% about 15%, about 20%, about 25%, or about 30% of the volume of an aqueous droplet present within the water immiscible fluidic medium at a temperature in the range of about 25° C. to about 38° C. In some embodiments, the water immiscible fluidic medium solubilizes less than about 20% of the volume of an aqueous droplet present within the water immiscible fluidic medium.

The water immiscible fluidic medium may include at least one organic or organosilicon compound having a backbone structure comprising atoms selected from carbon, silicon, and oxygen. In some embodiments, the water immiscible fluidic medium may include more than one organic/organosilicon compound, wherein the more than one compound is a polymeric organic/organosilicon compound having a range of molecular weights of the subunits of the polymeric compound. For example, the polymeric organic/organosilicon compound may have two different sub-units making up the polymer (e.g., a copolymer) and each of the two different sub-units may be present in a range of repeats, having a generic formula AaBb where A and B are two different polymer subunits, and a and b are the number of repeats of each subunit. The number of repeats, a and b, may not be a single integer but may be a range of repeat units.

In other embodiments, the water immiscible fluidic medium including more than one organic/organosilicon compound, may include a mixture of organic compounds, a mixture of organosilicon compounds, or any combination thereof. The water immiscible fluidic medium may include any suitable mixture of compounds having different chemical structures and/or molecular weights that will provide suitable performance.

A compound of the water immiscible fluidic medium may have a molecular weight of less than about 1000 Da, about 700 Da, about 500 Da, or about 350 Da. In other embodiments, the compound(s) of the water immiscible medium may have a higher molecular weight than about 1000Da and still provide suitable performance.

In various embodiments, the organic/organo silicon compound(s) of the water immiscible fluidic medium may have a backbone structure where the atoms making up the backbone are carbon, silicon or oxygen. The substituents of the backbone carbons may be hydrogen or fluorine. In some embodiments, the water immiscible fluidic medium may include one or more organo silicon compounds, where the backbone of the organosilicon compound(s) may include silicon and oxygen atoms. The silicon atoms of the organosilicon compound(s) may have carbon substituents, which in turn may have hydrogen or fluorine sub stituents. In some embodiments, the carbon substituents of an organosilicon compound may be all fluorine (e.g., perfluorinated). In other embodiments, the carbon substituents of an organosilicon compound may be partially fluorinated. In various embodiments, the substituents of carbon atoms of an organosilicon compound may be no more than about 90% fluorine, 80% fluorine, 70% fluorine, 60% fluorine, 50% fluorine, 40% fluorine, 30% fluorine, 20% fluorine or less.

In other embodiments, the organic compound(s) of the water immiscible fluidic medium may have a backbone structure where the atoms making up the backbone are carbon or oxygen. In some embodiments, the substituents of the backbone carbons may be hydrogen or fluorine. In other embodiments, the substituents of the backbone carbons may include an oxygen containing moiety such as an ether, carbonyl, or carbonate component. In some embodiments, the organic compound(s) of the water immiscible fluidic medium may have an all-carbon backbone structure. In some embodiments of the all-carbon backbone structure of the organic compound(s) of the water immiscible fluidic medium may have all fluorine substituents on the carbon atoms (e.g., is perfluorinated). In other embodiments, the substituents of an organic compound may be partially fluorinated (e.g., is not perfluorinated). In various embodiments, the substituents of carbon atoms of an organic compound, including a compound having an all-carbon backbone, may be no more than about 90% fluorine, 80% fluorine, 70% fluorine, 60% fluorine, 50% fluorine, 40% fluorine or less. In some embodiments, a suitable organic compound of the water immiscible fluidic medium may include or may be a monofluoro-substituted hydrocarbon such as 1-fluorooctane, 1-fluorodecane, 1-fluorododecane, or 1-fluorotetradecane.

In other embodiments, the organic compound(s) of the water immiscible fluidic medium may have no fluorine substituents on the carbons, but may have hydrogen substituents. In some embodiments, the organic compound(s) of the water immiscible fluidic medium may have unsaturated carbon-carbon linkages, e.g., an olefinic group either within the backbone carbons or at a terminal position.

In some embodiments, selection of an appropriate compound to be included in the water immiscible fluidic medium will include consideration of other properties of the compound. In various embodiments, a compound suitable for use within a water immiscible fluidic medium will not autofluoresce when illuminated by a laser, structured light projected into a microfluidic device, or daylight/laboratory lighting.

In other embodiments, the nature of the covalently modified hydrophobic surface will influence the selection of suitable compounds for use within the water immiscible fluidic medium. For example, a covalently modified surface may be sufficiently hydrophobic such that a droplet of water within a perfluorinated water immiscible fluidic medium may demonstrate sufficiently high surface tension that the droplet of water may not be movable using an opto-electrowetting configuration as described herein.

In some other embodiments, the nature of the microfluidic circuit material may influence selection of suitable compounds for use within the water immiscible fluidic medium. Swelling of the circuit material by the water immiscible fluidic medium may be kept within acceptable limits. For example, in some embodiments, if the microfluidic circuit material includes SU8 or a photopatternable aryl-substituted organosilicone, then linear hydrocarbon, linear fluorocarbon, or carbon-backbone compounds including cyclic, aryl or heteroaryl groups may be selected for use.

In other embodiments, the microfluidic circuit material may include other materials such as a photopatternable organosilicone containing no aryl substitution, and swelling may be limited to acceptable limits by use of different compounds in the water immiscible fluidic medium. For example, swelling of less than about 40%, 30%, 20%, or 10% compared to pre-exposure to the water immiscible fluidic medium may be acceptable. However, in some embodiments, a compound within the water immiscible fluidic medium that causes swelling may still be selected for use.

In some embodiments, the compound of the water immiscible fluidic medium may be an organic compound having a backbone containing carbon or oxygen atoms. In some embodiments, the organic compound may have a backbone that contains carbon atoms and does not contain oxygen atoms, and further where the carbon atom backbone is branched. In various embodiments, the branched carbon atom backbone of the organic compound of the water immiscible fluidic medium is acyclic. The organic compound of the water immiscible fluidic medium having a branched carbon backbone may further not contain any cyclized moiety.

While the above selection criteria may be used to select one or more compounds to be incorporated within a water immiscible fluidic medium, and eliminate compounds which may not provide acceptable performance, an acceptable water immiscible fluidic medium may be a multi-component mixture, and may include some portion of an individual organic or organosilicon compound that would not provide acceptable performance when used as a sole component of a water immiscible fluidic medium. For example, a component may be too highly fluorinated or may unacceptably swell the micro fluidic circuit material when used alone, but may be used in combination with other organic or organosilicon compounds to form a water immiscible fluidic medium.

Some suitable organic compounds for use in the water immiscible fluidic medium, either singly or in combination of any kind may include isocetane, 2-(Trifluoromethyl)-3-ethoxydodecafluorohexane (HFE-7500, 3M™, Novec™), heptamethyl nonane (HMN), bis(2-ethylhexyl) carbonate(TEGOSOFT® DEC, (Evonik)), and (Tridecafluoro-1, 1, 2, 2,-tetrahydrooctyl) tetramethydisiloxane (Gelest, Cat # SIB1816.0), or silicone oil (5 centistoke viscosity, Gelest Cat. # DMS-T05).

In some embodiments, the nature of the covalently modified hydrophobic surface will influence the selection of suitable compounds for use within the water immiscible fluidic medium. For example, a covalently modified surface may be sufficiently hydrophobic such that a droplet of water within a perfluorinated water immiscible fluidic medium may demonstrate sufficiently high surface tension that the droplet of water may not be movable using an opto-electrowetting configuration as described herein.

For example, with any of the hydrophobic layers comprising an unbranched alkane group of 10 or more carbons described herein (e.g., —(CH₂)₂—CH₃, where n=9 or 11 or 15 or greater), the water immiscible fluidic medium may comprise an organic liquid having a branched carbon and having molecular weight of about 100 to 500 daltons, or about 100 to 400 daltons, or about 100 to 300 daltons, or about 150 to 500 daltons, or about 150 to 400 daltons, or about 150 to 300 daltons. The organic liquid can be partially fluorinated or unfluorinated. In some embodiments, the organic liquid is acyclic (does not comprise a ring in its structure). In some embodiments, the water immiscible fluidic medium consists essentially of or consists of the organic liquid. In some embodiments, the organic liquid is a carbonate or a hydrocarbon. In some embodiments, the organic liquid is bis(2-ethylhexyl) carbonate (e.g., Tegosoft DEC) or heptamethylnonane (HMN). Alternatively, mineral oil can be used.

In another example, with any of the hydrophobic layers comprising a short unbranched alkane and a perfluoroalkane group described herein (e.g., —(CH₂)ₙ—(CF₂)ₘ—CF₃, wherein n=2 or greater and m=11 or greater), the water immiscible fluidic medium may comprise mineral oil or a linear alkane organic liquid of the formula CₓH₍₂ₓ₊₂₎, wherein x is from 9 to 16. In some embodiments, for the linear alkane organic liquid, x is 10, 11, 12, 13, or 14. In some embodiments, the linear alkane organic liquid is dodecane. In some embodiments, the water immiscible fluidic medium consists essentially of or consists of the linear alkane organic liquid.

J. Aqueous Droplet.

The aqueous droplet may contain one or more micro-objects, which may include a biological cell or a bead. The aqueous droplet may contain biological products which may include nucleic acid or protein. In some other embodiments, the aqueous droplet may contain reagents for an assay, which may be any kind of reagent such as an enzyme, an antibody, a fluorescently labeled probe, or a chemical reagent.

1. Surfactant.

In some embodiments, the aqueous droplet may also include a surfactant. The surfactant may increase the portability of the aqueous droplet within the water immiscible fluidic medium. In some embodiments, a suitable surfactant may include a non-ionic surfactant. In various embodiments, a surfactant may be, but is not limited to a polyethylene oxide-polypropylene oxide (PEO-PPO) block copolymer, e.g., a poloxamer such as a Pluronic® block alkylene oxide copolymer, including any of Pluronics F68 (ThermoFisher Cat. # 2400032), L31, or F127; a fatty ester ethoxylated sorbitan such as TWEEN® 20 (polysorbate 20) (Signa Aldrich Cat. # P1379) or TWEEN® 60 (polysorbate 60) (Sigma Aldrich P1629); 2, 4, 7, 9, Tetramethyl-5-decyne-4,7,-diol ethoxylate (TET, Sigma Aldrich Cat #9014-85-1); an ethoxylated nonionic fluorosurfactant such as Capstone® FS-30 (DuPont™, Synquest Laboratories Cat. # 2108-3-38); or N-(1,3-bis(Glucopyranoside)propan-2-yl)-3-Butyl-3-Cyclohexylheptanamide (Cy-Tripglu). In some embodiments, sodium dodecyl sulfate (SDS) may be used as a surfactant. In various embodiments, phosphate buffered saline (PBS) may be used as a surfactant. The surfactant may be added to the aqueous droplet in a range of about 1%, 3%, 5%, 10%, 15%, 20%, about 25% v/v or any value in between. In some embodiments, the surfactant is present (e.g., in a droplet) at a concentration less than or equal to 0.5% v/v, e.g., at a concentration ranging from 0.1% to 0.5%, 0.1% to 0.15%, 0.15% to 0.25%, 0.25% to 0.35%, or 0.35% to 0.5%, or any range defined by two of the foregoing endpoints. In some embodiments, the surfactant is present at about 0.2% v/v. It has been found that surfactant concentrations in such ranges below 0.5% v/v can be effective in preventing undesired adhesion or adsorption of cells and biological molecules to surfaces in the microfluidic device (which can interfere with droplet operations, such as moving the droplet via electrowetting and/or merging one droplet with another) while also avoiding fouling of such surfaces, which may occur at higher concentrations. Additionally, surfactants can also provide beneficial effects with respect to aspects of library preparation and/or amplification methods disclosed herein, as discussed in more detail below.

In some embodiments, the nature of the covalently modified hydrophobic surface will influence the selection of suitable surfactants included in the droplet. Selection of the surfactant(s) can be further influenced by the reagents and procedures being used. Appropriate selection of surfactants can be especially important when relatively high temperatures are used, as the high temperature may render some surfactants less effective in some contexts. Accordingly, the following guidance is provided. For each surfactant mentioned in the following discussion, in some embodiments, the surfactant is present in a droplet (e.g., in a droplet on which a given step is being performed, such as a combined droplet produced by merging a droplet comprising the surfactant and one or more reagents relevant to the step being performed) with a droplet comprising cells and/or nucleic acid) at a concentration less than or equal to 0.5% v/v, e.g., at a concentration ranging from 0.1% to 0.5%, 0.1% to 0.15%, 0.15% to 0.25%, 0.25% to 0.35%, or 0.35% to 0.5%, or any range defined by two of the foregoing endpoints. In some embodiments, the surfactant is present in a droplet at about 0.2% v/v.

For droplets containing cells on surfaces comprising hydrophobic layers comprising an unbranched alkane group of 10 or more carbons described herein (e.g., —(CH₂)ₙ—CH₃, where n=15 or greater), movement of the droplet was found to be facilitated well by TET surfactant. The Cy-Tripglu and PEO-PPO block copolymers (e.g., Pluronics F68, L31, and F127) were also useful in this regard. These same surfactants can also be used in combination with DNA fragmentation reagents/in DNA fragmentation steps.

For droplets containing cells on surfaces comprising hydrophobic layers comprising a short unbranched alkane and a perfluoroalkane group described herein (e.g., —(CH₂)ₙ—(CF₂)ₘ—CF₃, wherein n=2 or greater and m=11 or greater), movement of the droplet was found to be facilitated well by PEO-PPO block copolymers (e.g., Pluronics F68, L31, and F127). TET surfactant was also useful in this regard. These same surfactants can also be used in combination with DNA fragmentation reagents/in DNA fragmentation steps.

For enzymatic lysis of cells using proteinase K or equivalents thereof, surfactants are considered helpful in promoting complete lysis. It was also observed that the presence of a surfactant could improve movement of the droplet via electrowetting and improve the consistency of subsequent nucleic acid fragmentation reactions, where applicable. Non-ionic surfactants, including those with a large polar head group, can be useful for these purposes. A large polar head group can have a size greater than 750 daltons, such as greater than 800, 900, 1000, 1100, 1200, or 1300. In some embodiments, the polar head group is of a size ranging from 750 to 2000 daltons, such as from 750 to 1000, 1000 to 1200, 1200 to 1400, 1400 to 1600, 1600 to 1800, or 1800 to 2000 daltons In some embodiments, the surfactant used in combination with a lysis reagent such as a protease (e.g., proteinase K) is a polysorbate surfactant having a molecular weight of at least 1000 daltons (e.g., polysorbate 20). In some embodiments, the surfactant is octylphenol ethoxylate in which the ethoxylate group has an average length of at least 9 ethyloxide units, or at least 15, 20, 25, 30 or more ethyloxide units, e.g., Triton X-305. In some embodiments, the surfactant is Triton X-100 or Nonidet P-40 (NP-40).

In an A-tailing step (e.g., to prepare DNA for ligation, e.g., to attach adapter or barcode sequences), Cy-Tripglu was useful when the hydrophobic layer comprises an unbranched alkane group of 10 or more carbons described herein (e.g., —(CH₂)ₙ—CH₃, where n=15 or greater). When the hydrophobic layer comprises a short unbranched alkane and a perfluoroalkane group described herein (e.g., —(CH₂)ₙ—(CF₂)ₘ—CF₃, wherein n=2 or greater and m=11 or greater), the surfactant(s) already present from previous steps such as cell movement and lysis (see above) was sufficient, although additional surfactant such as described with respect to cell movement for such surfaces could be included (e.g., to maintain a total surfactant concentration within the 0.1% to 0.5% v/v range) without any significant adverse impact.

For droplets comprising a polymerase and/or in which amplification (e.g., PCR) is performed, the surfactant can be a polysorbate surfactant having a molecular weight of at least 1000 daltons (e.g., polysorbate 20). Polysorbate 20 was effective on either of hydrophobic layers comprising an unbranched alkane group of 10 or more carbons described herein (e.g., —(CH₂)ₙ—CH₃, where n=15 or greater) or a short unbranched alkane and a perfluoroalkane group described herein (e.g., —(CH₂)ₙ—(CF₂)ₘ—CF₃, wherein n=2 or greater and m=11 or greater). PEO-PPO block copolymers (e.g., Pluronics F68, L31, and F127) or TET surfactant could also be used. In some embodiments, a droplet comprising a nucleic acid comprises one or more of (i) a polysorbate (e.g., polysorbate 20) and (ii) TET, Cy-Tripglu, or a PEO-PPO block copolymer (e.g., Pluronics F68, L31, and F127); and a droplet comprising a nucleic acid polymerase comprises a polysorbate (e.g., polysorbate 20). Thus, upon merging such droplets, as in certain methods comprising amplification according to this disclosure, the combined droplet comprises a polysorbate (e.g., polysorbate 20) and optionally one or more of TET, Cy-Tripglu, or a PEO-PPO block copolymer (e.g., Pluronics F68, L31, and F127). The surfactant(s) in the droplet comprising a nucleic acid can be selected based on the guidance provided above.

K. Kits

The disclosure also provides kits that are suitable for transporting micro-objects, biological products, and/or reagents that are compatible with and/or soluble in aqueous media. The kits can comprise any of the microfluidic devices disclosed herein (e.g., microfluidic devices having an enclosure comprising a base and a microfluidic circuit structure, wherein the base comprises a hydrophobic monolayer covalently bonded to at least a portion of an upper surface of the base). The kits can further comprise a fluidic medium that is immiscible with aqueous media, other useful reagents (e.g., surfactants and the like), or any combination thereof.

L. Methods of Manufacturing Microfluidic Devices.

A microfluidic device of the disclosure, such as apparatus 400, can be manufactured by (i) bonding a spacing element 108 to an inner surface 428 of a cover 110 having at least one electrode configured to be connected to an AC voltage source (not shown), (ii) bonding the spacing element 108 (and associated cover 110) to a dielectric surface 414 of a substrate 104 having at least one electrode 418 configured to be connected to an AC voltage source (not shown), whereby the spacing element 108 becomes sandwiched between the inner surface 428 of the cover 110 and the dielectric surface 414 of the substrate 104, with the cover 110 and the substrate 104 oriented substantially parallel to one another, and the substrate 104, spacing element 108, and cover 110 collectively defining an enclosure 435 configured to hold a liquid, and (iii) forming, by vapor deposition, an outer hydrophobic layer 412 on at least a portion of the inner surface 428 of the cover 110 and an out hydrophobic layer 412 on at least a portion of the inner dielectric layer 414 of the substrate 104.

Through vapor deposition of amphiphilic molecules, the hydrophobic layers 422 and 412 can achieve densely packed monolayers in which the amphiphilic molecules are covalently bonded to the molecules of the inner surface 428 of the cover 110 and the inner dielectric surface 414 of the substrate 104, respectively. Any of the self-associating molecules described herein, and equivalents thereof, can be vapor deposited on the inner surfaces of a microfluidic apparatus. To achieve a desirable packing density, self-associating molecules comprising, for example, alkyl-terminated siloxane can be vapor deposited at a temperature of at least 110° C. (e.g., at least 120, 130, 140, 150, 160, etc.), for a period of at least 15 hours (e.g., at least 20, 25, 30, 35, 40, 45, or more hours). Such vapor deposition is typically performed under vacuum and in the presence of a water source, such as magnesium sulfate heptahydrate (i.e., MgSO₄.7H₂0). Typically, increasing the temperature and duration of the vapor deposition produces improved characteristics of the hydrophobic layers 422 and 412. The vapor deposition process can be ootionally improved, for example, by pre-cleaning the cover 110 (with spacing elements 108) and substrate 104. For example, such pre-cleaning can include a solvent bath, such as an acetone bath, an ethanol bath, or a combination thereof. The solvent bath can include sonication. Alternatively, or in addition, such pre-cleaning can include treating the cover 110 (with spacing elements 108) and substrate 104 in an oxygen plasma cleaner. The oxygen plasma cleaner can be operated, for example, under vacuum conditions, at 100W for 60 seconds.

In some embodiments, the microfluidic device can further include a droplet generator. The droplet generator can be configured to selectively provide droplets of one or more liquid media (e.g., aqueous liquid media) into the enclosure or a microfluidic channel within the enclosure. The droplets can contain, for example, micro-objects, such as biological micro-objects (e.g., cells) or beads. Alternatively, or in addition, the droplets can contain reagents, such as lysis buffer, affinity reagents, detectable labels, enzymatic mixtures, etc. FIG. 8 illustrates an example a microfluidic apparatus 800 which comprises an enclosure having microfluidic channels 812, 814 and a plurality of chambers 816, and a droplet generator 806 for providing fluidic droplets 820 to the enclosure. Microfluidic channel 814 is configured to hold a first fluidic medium 824. Typically, the first fluidic medium is a hydrophobic fluid, such as an oil (e.g., a silicone oil or a fluorinated oil). Microfluidic channel 814 is connected to the droplet generator 806 via an interface 808, which allows channel 814 to receive droplets 820 generated by the droplet generator 806. The received droplets 820 comprise a liquid which is immiscible in the first fluidic medium 824. Typically, the received droplets will comprise an aqueous medium, which may contain micro-objects, such as cells or beads, or reagents that are soluble in aqueous media. Micro fluidic channel 814 is also connected to each of the plurality of chambers 816, facilitating movement of received droplets 820 (as well as droplets 832 pulled from a reservoir of fluid immiscible in the first fluidic medium 824) into and between chambers 816.

Microfluidic channel 812 of apparatus 800 is connected to a subset of chambers 816, and thus is indirectly connected to microfluidic channel 814 via such chambers 816. As illustrated, microfluidic channel 812 and the chambers 816 connected thereto contains a fluidic medium 822 which is immiscible in the first fluidic medium 824. Thus, for example, fluidic medium 822 can be an aqueous medium, such as a cell culture medium. When fluidic medium 822 is a cell culture medium, the chambers 816 that contain culture medium can be used as culture chambers for growing cells, and microfluidic channel 812 can be a perfusion channel that provides a flow of fresh culture medium. As discussed herein, the flow of fresh culture medium in a perfusion channel can, via diffusion of molecules between the perfusion channel and a culture chamber, provide nutrients to the chamber and remove waste from the chamber, thus facilitating continued cell growth.

FIG. 9 illustrates another example a microfluidic apparatus 900 which comprises an enclosure having microfluidic channels 812, 814, a first plurality of chambers 916, and a second plurality of chambers 816, and a droplet generator 606 for providing fluidic droplets 620 to the enclosure. FIG. 9 presents a variation on the microfluidic apparatus 800 shown in FIG. 8, wherein chambers 816 contain a medium 822 that is immiscible in the first fluidic medium 824 (located in microfluidic channel 814) and are located directly across microfluidic channel 814 from corresponding chambers 916. This configuration facilitates movement of fluid droplets 832 (optionally containing micro-objects 830 or biological material) from a select chamber 816 to the corresponding chamber 916, where the fluid droplets (and any micro-objects 830 or biological material) can be processed.

Another example a microfluidic apparatus comprises an enclosure having microfluidic channels 812, 814, a first plurality of chambers 916, and a second plurality of chambers 816, and a droplet generator 806 for providing fluidic droplets 820 to the enclosure. This embodiment presents a variation on the microfluidic apparatus 900 shown in FIG. 9, wherein chambers 816 are tapered at one end to facilitate the movement of micro-particles to the interface of the first fluidic medium 824 and the second fluidic medium 822 when the microfluidic apparatus is tilted such that the tapered ends of chambers 816 have a lower potential energy (in the applicable gravitational field) relative to the ends that are not tapered.

The microfluidic circuits formed by the microfluidic channels 812,814 and chambers 816, 916 are merely examples, and many other configurations of channels and chambers are encompassed by the disclosure. For example, in each of apparatuses 800and 900, microfluidic channel 812 and the chambers 816 directly connected to channel 812 are optional features. Thus, apparatuses 800 and 900 can lack perfusion channels and culture chambers.

In embodiments where microfluidic channel 812 is present, the substrate which helps to define channel 812 and/or directly connected chambers 816 (e.g., by forming the base of the channel and/or chambers) can have an electrowetting configuration. Alternatively, however, the substrate which helps to define the channel 812 and/or directly connected chambers 816 can lack an electrowetting configuration (e.g., and instead can have a DEP configuration, or neither an electrowetting nor a DEP configuration). In embodiments in which microfluidic channel 812 is present, and the substrate which helps to define channel 812 and/or directly connected chambers 816 has an electrowetting configuration, the outer hydrophobic surface of the substrate can be patterned to be more hydrophilic than the outer hydrophobic surface of the substrate which helps to define channel 814. The increased hydrophilicity can be achieved, for example, as discussed above.

The droplet generator 806 and any microfluidic circuit to which it provides droplets can be part of a microfluidic device (either an integral part or connected thereto), which can be like any of the microfluidic devices illustrated in the drawings or described herein. Although one droplet generator 806 is shown in FIGS. 8 and 9, more than one such droplet generator 806 can provide droplets to the microfluidic circuit of apparatuses 800 and 900.

The droplet generator 806 itself can include an electrowetting configuration, and can thus comprise a substrate having a photoresponsive layer, as generally described in PCT Application No. PCT/US2016/069579, filed on Dec. 30, 2016. The photoresponsive layer which can comprise a-Si:H (e.g., as illustrated in U.S. Pat. No. 6,958,132), a photo-actuated circuit substrate (e.g., as illustrated in U.S. Patent Application Publication No. 2014/0124370), a phototransistor-based substrate (e.g., as illustrated in U.S. Pat. No. 7,956,339), or an electrically-actuated circuit substrate (e.g., as illustrated in U.S. Patent No. 8,685,344). Alternatively, the droplet generator can have a T- or Y-shaped hydrodynamic structure (e.g., as illustrated in U.S. Patents & Patent Application Publication Nos. 7,708,949, 7,041,481 (reissued as RE41,780), 2008/0014589, 2008/0003142, 2010/0137163, and 2010/0172803). All of the foregoing U.S. patent documents are incorporated by reference herein in their entirety.

As shown, the droplet generator 806 can comprise one or more fluidic inputs 802 and 804 (two are shown but there can be fewer or more) and a fluidic output 208, which can be connected to the microfluidic channel 814. Liquid media 822, 824, biological micro-objects 830, reagents, and/or other biological media can be loaded through the inputs 802 and 804 into the droplet generator 806. The droplet generator 806 can generate and output into the channel 814 droplets 820 of the liquid medium 822 (which can, but need not, contain one or more biological micro-objects 830), reagents, or other biological medium. If the channel 814 has an electrowetting configuration, the droplets 820 can be moved in the channel 814 utilizing electrowetting (or optoelectrowetting). Alternatively, the droplets 820 can be moved in the channel 814 by other means. For example, the droplets 820 can be moved in the channel 814 using fluidic flow, gravity, or the like.

As discussed above, the microfluidic channel 814 and select chambers 816/916 can be filled with a first fluidic medium 824, and microfluidic channel 812 and chambers 816 connected directly thereto can be filled with a second fluidic medium 822. The second fluidic medium 822 (hereinafter an “aqueous medium”) can be an aqueous medium, such as a sample medium for maintaining, culturing, or the like biological micro-objects 830. The first fluidic medium 824 (hereinafter an “immiscible medium”) can be a medium in which the aqueous medium 822 is immiscible. Examples of the aqueous medium 822 and the immiscible medium 824 include any of the examples discussed above for various media.

The droplet generator 806 can be utilized to load biological micro-objects and/or facilitate the running of biochemical and/or molecular biological workflows on the microfluidic apparatus. FIGS. 8 and 9 illustrate non-limiting examples. By using a droplet generator, the apparatus can have an electrowetting configuration throughout the fluidic circuit.

FIGS. 8 and 9 illustrate an example in which the droplet generator 806 generates a droplet 820 comprising a reagent (or other biological material). The reagent-containing droplet 820 can be moved through the microfluidic channel 814 and into one of the chambers 816/916 containing the immiscible medium 824. Prior to or after moving the reagent-containing droplet 820 into one of the chambers 816/916, one or more micro-objects 830 in one or more droplets 832 can be moved into the same chambers 816/916. The reagent-containing droplet 820 can then be merged with the droplet 832 containing the micro-object 830, allowing the reagents of droplet 820 to mix and chemically react with the contents of droplet 832. The one or more micro-object-containing droplets 832 can be supplied by the droplet generator 806 (not shown) or can be obtained from a holding pen 816, as shown in FIGS. 8 and 9. The micro-object 830 can be a biological micro-object, such as a cell, which has optionally been cultured (e.g., in a chamber 816) prior to being moved to the processing chamber 816/916. Alternatively, the micro-object 830 can be a bead, such as an affinity bead that is capable of binding to molecules of interest in a sample (e.g., cell secretions present in sample material 822 after the sample material 822 has been used to culture one or more biological cells). In still other alternatives, the one or more droplets 832 can contain no micro-objects but only aqueous medium, such as sample material 822, e.g., that contains cell secretions after the sample material 822 has been used to culture one or more biological cells.

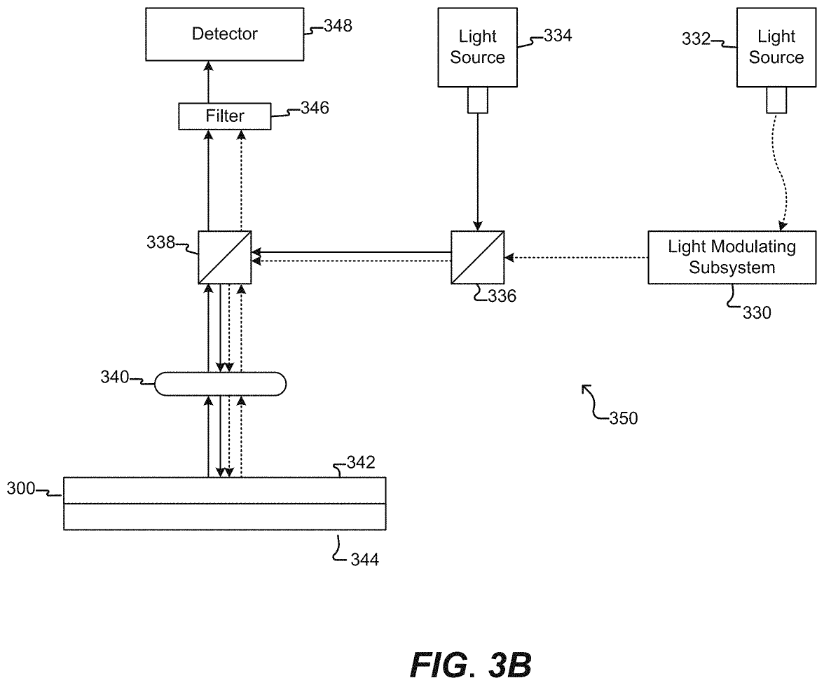

FIG. 10 illustrates an example of a process 1000 that can be performed in a microfluidic device comprising a microfluidic circuit like any of apparatuses 800 and 900.

At step 1002 of the process 100, a biological micro-object can be cultured in a holding pen filled with a sample medium (e.g., cell culture medium). For example, a micro-object 830 of FIGS. 8 and 9 can be biological and can be cultured in its chamber 816. Culturing can be generally as discussed above. For example, culturing can include perfusing the channel 812 with a culture medium 822. Step 1002 can be performed over a specified period of time.

At step 1004, the cultured biological micro-object can be moved from the sample-medium-filled chamber 816 in which it was cultured to a chamber 816/916 filled with a medium in which the sample medium is immiscible. For example, the cultured micro-object 830 can be moved in a droplet 820 or 832 of sample medium 822 from one of the holding pens 816 into one of the holding pens 816/916, as illustrated in FIGS. 8 and 9, as discussed above.

At step 1006, the cultured biological micro-object can be subjected to one or more treatments or processes in the immiscible-medium-filled holding pen. For example, one or more droplets 820 containing one or more reagents can be produced by the droplet generator 806 and moved into an immiscible-medium-filled chamber 816/916 and merged with the droplet 832 containing the cultured biological micro-object 830, as shown in FIGS. 8 and 9 and discussed above. For example, a first reagent-containing droplet 820 can contain a lysing reagent. Merger of the droplet 832 containing the cultured biological micro-object 830 with the first reagent-containing droplet 820 containing lysing reagent, would result in the lysis of the cultured biological micro-object 830. In other words, a combined droplet (not shown) would be formed that contains a cell lysate from the cultured biological micro-object 830. Additional (e.g., second, third, fourth, etc.) reagent-containing droplets 820 could then be merged with the cell lysate-containing new droplet, so as to further process the cell lysate as desired.

In addition or as another example, one or more droplets containing one or more labeled capture micro-objects (not shown) having an affinity for a secretion or other material or materials of interest (e.g., nucleic acids such as DNA or RNA, proteins, metabolites, or other biological molecules) produced the cultured biological micro-object 830 can be generated by the droplet generator 806 and moved into the immiscible-medium-filled pen 816 or 916 and merged with the droplet of sample medium 822 containing the cultured biological micro-object 830 in a similar manner. In cases where the cultured biological micro-object 830 has already been lysed, capture micro-object-containing droplet 820 could contain one or more affinity beads (e.g., having affinity for nucleic acids, such as DNA, RNA, microRNAs, or the like) which, upon merger with the cell lysate-containing droplet in holding pen 816 or 916, could bind to target molecules present in the lysate.

At step 1008, the treated biological micro-object can be optionally processed. For example, if at step 1006, a capture object (not shown) is moved into the immiscible-medium-filled chamber 816/916 with the cultured biological micro-object 830, the chamber 816/916 can be monitored at step 1008 for a reaction (e.g., a fluorescent signal) indicative of a quantity of the material of interest bound to the labeled capture micro-object. Alternatively, such a capture micro-object (not shown) can be removed (e.g., in a droplet 822) from the chamber 816/916 and exported from the microfluidic device (not shown in FIGS. 8 and 9) for subsequent analysis. As yet another example, the treated biological micro-object 830 can be removed (e.g., in a droplet 832) from the chamber 816/916 and exported from the microfluidic device (not shown) for subsequent analysis.

A substrate for a microfluidic device that includes both an electrowetting configuration and a dielectrophoresis (DEP) configuration may be formed as described in PCT/US2016/059234, filed Oct. 27, 2016, published as WO2017/075295, all of the content of which is incorporated by reference for all purposes.

Although specific embodiments and applications of the disclosure have been described in this specification, these embodiments and applications are exemplary only, and many variations are possible. For example, the methods of FIG. 6 can be performed with respect to sample material contain cell secretions (e.g., after the sample material 882 has been used to culture one or more biological cells). In such an embodiment, step 1002 would remain the same, but step 1004 would involve moving droplets 832 which can contain no micro-objects but only aqueous medium, such as sample material 822 containing cell secretions, into immiscible-medium-containing chambers 816/916, and steps 1006 and 1008 would be performed with respect to such aqueous medium-containing droplets 832. Furthermore, the electrowetting configurations discussed herein can be any type of electronic wetting configuration known in the art, examples of which are disclosed in U.S. Pat. No. 6,958,132 (for OEW configurations) and US Patent Application Publication No. US2016/0158748 (for single-sided OEW configurations). Other examples of electrowetting configurations include electrowetting on dielectric (EWOD) devices, which can be electronically controlled, an example of which is disclosed in U.S. Pat. No. 8,685,344. Similarly, the dielectrophoresis configurations discussed herein can be any type of dielectrophoresis configuration known in the art, examples of which are disclosed in US Patent Nos. RE 44,711 (Wu et al.), U.S. Pat. No. 7,956,339 (Ohta et al.), U.S. Pat. No. 6,294,063 (Becker et al.), U.S. Pat. No. 6,942,776 (Medoro), and U.S. Pat. No. 9,403,172 (Wu et al.). All of the foregoing US patent documents are incorporated herein in their entirety by reference.

Description of Reference numbers in Figures

| | |
|---|---|
| Ref Number | description |

FIG. 2E

| | |
|---|---|
| 286 | Cover of microfluidic device |
| 288 | Base of microfluidic device |
| 290 | Microfluidic device |
| 292 | Inner surface of first DEP substrate |
| 294 | Inner surface of second DEP substrate |
| 296 | Siloxy linking group |
| 298 | Conditioned/coated surface |

FIGS. 3A and 3B

| | |
|---|---|
| 300 | Support Structure (“Nest”) |
| 302 | Socket |
| 304 | Electrical Signal Generation Subsystem |
| 306 | Thermal Control Subsystem |
| 308 | Controller |
| 310 | Interface (not shown) |
| 312 | Casing |
| 314 | Fluidic Path |
| 316 | Inlet |
| 318 | Outlet |
| 320 | Microfluidic device |
| 322 | Printed Circuit Board Assembly |
| 324 | Serial Port |
| 330 | Light Modulating Subsystem |
| 332 | (First) light source |
| 334 | Second light source |
| 336 | Beam splitter |
| 338 | 2^{nd} beam splitter or Dichroic filter |
| 340 | Objective |
| 342 | Sample plane |
| 344 | Stage |
| 346 | Dichroic filter |
| 348 | Detector |
| 350 | Microscope |
| 355 | system |

### III. SYSTEMS

A system for transporting micro-objects, biological products, and/or reagents that are compatible with and/or soluble in aqueous media is provided by the disclosure. The system can include, for example, any of the microfluidic devices disclosed herein (e.g., a microfluidic device having an enclosure comprising a base and a microfluidic circuit structure, wherein the base comprises a hydrophobic monolayer covalently bonded to at least a portion of an upper surface of the base). In addition, the system can include a fluidic medium and an aqueous droplet, wherein the fluidic medium and the aqueous droplet are immiscible fluids. The fluidic medium can be any of the immiscible media described herein, and the aqueous droplet can comprise any of the biological materials and/or chemical agents described herein (e.g., proteins, nucleic acids, detergents, surfactants, and the like).

FIGS. 3A through 3B show various embodiments of a system 150 which can be used to operate and observe microfluidic devices (e.g. 100, 200, 230, 280, 250, 290, 320) according to the present disclosure. As illustrated in FIG. 3A, the system 150 can include a structure (“nest”) 300 configured to hold a microfluidic device 100 (not shown), or any other microfluidic device described herein. The nest 300 can include a socket 302 capable of interfacing with the microfluidic device 320 (e.g., an optically-actuated electrokinetic device 100) and providing electrical connections from power source 192 to microfluidic device 320. The nest 300 can further include an integrated electrical signal generation subsystem 304. The electrical signal generation subsystem 304 can be configured to supply a biasing voltage to socket 302 such that the biasing voltage is applied across a pair of electrodes in the microfluidic device 320 when it is being held by socket 302. Thus, the electrical signal generation subsystem 304 can be part of power source 192. The ability to apply a biasing voltage to microfluidic device 320 does not mean that a biasing voltage will be applied at all times when the microfluidic device 320 is held by the socket 302. Rather, in most cases, the biasing voltage will be applied intermittently, e.g., only as needed to facilitate the generation of electrokinetic forces, such as dielectrophoresis or electro-wetting, in the microfluidic device 320.

As illustrated in FIG. 3A, the nest 300 can include a printed circuit board assembly (PCBA) 322. The electrical signal generation subsystem 304 can be mounted on and electrically integrated into the PCBA 322. The exemplary support includes socket 302 mounted on PCBA 322, as well.

Typically, the electrical signal generation subsystem 304 will include a waveform generator (not shown). The electrical signal generation subsystem 304 can further include an oscilloscope (not shown) and/or a waveform amplification circuit (not shown) configured to amplify a waveform received from the waveform generator. The oscilloscope, if present, can be configured to measure the waveform supplied to the microfluidic device 320 held by the socket 302. In certain embodiments, the oscilloscope measures the waveform at a location proximal to the microfluidic device 320 (and distal to the waveform generator), thus ensuring greater accuracy in measuring the waveform actually applied to the device. Data obtained from the oscilloscope measurement can be, for example, provided as feedback to the waveform generator, and the waveform generator can be configured to adjust its output based on such feedback. An example of a suitable combined waveform generator and oscilloscope is the Red Pitaya™.

In certain embodiments, the nest 300 further comprises a controller 308, such as a microprocessor used to sense and/or control the electrical signal generation subsystem 304. Examples of suitable microprocessors include the Arduino™ microprocessors, such as the Arduino Nano™. The controller 308 may be used to perform functions and analysis or may communicate with an external master controller 154 (shown in FIG. 1A) to perform functions and analysis. In the embodiment illustrated in FIG. 3A the controller 308 communicates with a master controller 154 through an interface 310 (e.g., a plug or connector).

In some embodiments, the nest 300 can comprise an electrical signal generation subsystem 304 comprising a Red Pitaya™ waveform generator/oscilloscope unit (“Red Pitaya unit”) and a waveform amplification circuit that amplifies the waveform generated by the Red Pitaya unit and passes the amplified voltage to the microfluidic device 100. In some embodiments, the Red Pitaya unit is configured to measure the amplified voltage at the microfluidic device 320 and then adjust its own output voltage as needed such that the measured voltage at the microfluidic device 320 is the desired value. In some embodiments, the waveform amplification circuit can have a +6.5V to −6.5V power supply generated by a pair of DC-DC converters mounted on the PCBA 322, resulting in a signal of up to 13 V at the microfluidic device 100.

As illustrated in FIG. 3A, the support structure 300 can further include a thermal control subsystem 306. The thermal control subsystem 306 can be configured to regulate the temperature of microfluidic device 320 held by the support structure 300. For example, the thermal control subsystem 306 can include a Peltier thermoelectric device (not shown) and, optionally, a cooling unit (not shown). The Peltier thermoelectric device can have a first surface configured to interface with at least one surface of the microfluidic device 320 or an interposing layer of material (not shown) which ensures that the Peltier thermoelectric device is properly thermally coupled to the microfluidic device 320. The cooling unit can be, for example, a cooling block (not shown), such as a liquid-cooled aluminum block. A second surface of the Peltier thermoelectric device (e.g., a surface opposite the first surface) can be configured to interface with a surface of such a cooling block. The cooling block can be connected to a fluidic path 314 configured to circulate cooled fluid through the cooling block. In the embodiment illustrated in FIG. 3A, the support structure 300 comprises an inlet 316 and an outlet 318 to receive cooled fluid from an external reservoir (not shown), introduce the cooled fluid into the fluidic path 314 and through the cooling block, and then return the cooled fluid to the external reservoir. In some embodiments, the Peltier thermoelectric device, the cooling unit, and/or the fluidic path 314 can be mounted on a casing 312 of the support structure 300. In some embodiments, the thermal control subsystem 306 is configured to regulate the temperature of the Peltier thermoelectric device so as to achieve a target temperature for the microfluidic device 320. Temperature regulation of the Peltier thermoelectric device can be achieved, for example, by a thermoelectric power supply, such as a Pololu™ thermoelectric power supply (Pololu Robotics and Electronics Corp.). In some embodiments, the Peltier thermoelectric device is interposed between a surface of the microfluidic device and a surface of the cooling unit. In some embodiments, the Peltier thermoelectric device and the thermoelectric power supply are mounted on and/or integrated with the support. In some embodiments, at least one of the electrical signal generation subsystem, the thermal control subsystem, and the controller are mounted on and/or integrated with the PCBA. The thermal control subsystem 306 can include a feedback circuit, such as a temperature value provided by an analog circuit. Alternatively, the feedback circuit can be provided by a digital circuit.

In some embodiments, the nest 300 can include a thermal control subsystem 306 with a feedback circuit that is an analog voltage divider circuit (not shown) which includes a resistor (e.g., with resistance 1 kOhm+/-0.1%, temperature coefficient +/−0.02 ppm/CO) and a NTC thermistor (e.g., with nominal resistance 1 kOhm+/−0.01%). In some instances, the thermal control subsystem 306 measures the voltage from the feedback circuit and then uses the calculated temperature value as input to an on-board algorithm, such as a PID control loop algorithm. Output from the PID control loop algorithm can drive, for example, both a directional and a pulse-width-modulated signal pin on a Pololu™ motor drive (not shown) to actuate the thermoelectric power supply, thereby controlling the Peltier thermoelectric device.

In some embodiments, the thermal control subsystem configured to regulate a temperature of the microfluidic device comprises a thermal control circuit to adjust a temperature of the microfluidic device. The thermal control circuit can be configured to follow a three-phase temperature control procedure with rules correlating a temperature value measured by the thermistor with a target temperature and a power output of Peltier thermoelectric device, the rules comprising:
setting the power output to a first value if the difference between the target temperature and the thermistor-measured temperature is larger than N;
setting the power output to a second value lower than the first value if the difference between the target temperature and the thermistor-measured temperature is equal to or smaller than N and larger than M; and
determining the power output by a proportionate-integral-derivative (PID) loop controller with the thermistor-measured temperature as an input if the difference between the target temperature and the thermistor-measured temperature is smaller than or equal to M,
   where M may be in the range of 7° C. to 13° C. and N may be in the range of 2° C. to 4° C. In some embodiments, M is 3° C. and N is 10° C. It should be noted that for purposes of evaluating whether the difference between the target temperature and the thermistor-measured temperature is larger than a given value, the difference is considered in terms of its magnitude (absolute value); that is to say, for example, that both differences of 11° C. and −11° C. relative to a target temperature represent a difference of eleven degrees in magnitude and are considered larger than ten degrees.

A Proportionate-Integral-Derivative (PID) control algorithm is a commonly-used control algorithm, used for closed-loop feedback that minimizes the error between the setpoint value of a given process variable and the current measured value of that variable. The PID control algorithm calculates a correction to system's output based on the value of the error, the integral of the error, and the derivative of the error. Output from the PID control loop algorithm can drive, for example, both a directional and a pulse-width-modulated signal pin on a Pololu™ motor drive (not shown) to actuate the thermoelectric power supply, thereby controlling the Peltier thermoelectric device.

In some embodiments, the first value is 70% to 100% power output of the Peltier thermoelectric device. In some embodiments, the first value is 100% power output. In some embodiments, the second value is a power output value determined from calibration data correlating a plurality of target temperature values correlated with a plurality of power output values.

In some embodiments, the target temperature values correlated to the power output values are determined by equilibrating a calibration chip comprising a thermocouple with the Peltier thermoelectric device at each of the power output values and associating the temperature registered by the thermocouple following equilibration with the power output value. In some embodiments, the plurality of target temperature values comprises at least 4, 5, 6, 7, 8, 9, or 10 values in the range of 0° C. to 100° C. In some embodiments, a power output value corresponding to a target temperature value between values represented in the calibration data is determined by linear interpolation. For example, the calibration data can comprise a series of power output values ranging from −100% (maximum cooling) to 100% (maximum heating) (e.g., at least 4, 5, 6, 7, 8, 9, or 10 values) and the associated equilibrium temperatures determined empirically for each of these values. The values can be, but are not necessarily, evenly distributed over the range of power outputs. From these data, appropriate power output values for any arbitrary temperature from the minimum to maximum observed temperatures can be determined by a suitable approach such as linear interpolation of the calibration data.

In some embodiments, separate sets of calibration data are provided for use in heating or cooling steps. The data for use in heating steps can be generated by first equilibrating at a −100% power output value and progressively increasing the power output to correspond to each power output value being included in the calibration data, equilibrating, and measuring the temperature. Similarly, the data for use in cooling steps can be generated by first equilibrating at a 100% power output value and progressively decreasing the power output to correspond to each power output value being included in the calibration data, equilibrating, and measuring the temperature.

The nest 300 can include a serial port 324 which allows the microprocessor of the controller 308 to communicate with an external master controller 154 via the interface 310 (not shown). In addition, the microprocessor of the controller 308 can communicate (e.g., via a Plink tool (not shown)) with the electrical signal generation subsystem 304 and thermal control subsystem 306. Thus, via the combination of the controller 308, the interface 310, and the serial port 324, the electrical signal generation subsystem 304 and the thermal control subsystem 306 can communicate with the external master controller 154. In this manner, the master controller 154 can, among other things, assist the electrical signal generation subsystem 304 by performing scaling calculations for output voltage adjustments. A Graphical User Interface (GUI) (not shown) provided via a display device 170 coupled to the external master controller 154, can be configured to plot temperature and waveform data obtained from the thermal control subsystem 306 and the electrical signal generation subsystem 304, respectively. Alternatively, or in addition, the GUI can allow for updates to the controller 308, the thermal control subsystem 306, and the electrical signal generation subsystem 304. In some embodiments, an external master controller comprises a graphical user interface configured to receive operator input and for processing and transmitting the operator input to the controller for controlling one or both of the electrical signal generation subsystem and the thermal control subsystem. In some embodiments, the controller is configured to transmit to the external master controller data and/or information sensed or received, or otherwise calculated based upon data or information sensed or received, from one or both of the electrical signal generation subsystem and the thermal control subsystem.

As discussed above, system 150 can include an imaging device 194. In some embodiments, the imaging device 194 comprises a light modulating subsystem 330 (See FIG. 3B). The light modulating subsystem 330 can include a digital mirror device (DMD) or a microshutter array system (MSA), either of which can be configured to receive light from a light source 332 and transmits a subset of the received light into an optical train of microscope 350. Alternatively, the light modulating subsystem 330 can include a device that produces its own light (and thus dispenses with the need for a light source 332), such as an organic light emitting diode display (OLED), a liquid crystal on silicon (LCOS) device, a ferroelectric liquid crystal on silicon device (FLCOS), or a transmissive liquid crystal display (LCD). The light modulating subsystem 330 can be, for example, a projector. Thus, the light modulating subsystem 330 can be capable of emitting both structured and unstructured light. One example of a suitable light modulating subsystem 330 is the Mosaic™ system from Andor Technologies™. In certain embodiments, imaging module 164 and/or motive module 162 of system 150 can control the light modulating subsystem 330.

In certain embodiments, the imaging device 194 further comprises a microscope 350. In such embodiments, the nest 300 and light modulating subsystem 330 can be individually configured to be mounted on the microscope 350. The microscope 350 can be, for example, a standard research-grade light microscope or fluorescence microscope. Thus, the nest 300 can be configured to be mounted on the stage 344of the microscope 350 and/or the light modulating subsystem 330 can be configured to mount on a port of microscope 350. In other embodiments, the nest 300 and the light modulating subsystem 330 described herein can be integral components of microscope 350.

In certain embodiments, the microscope 350 can further include one or more detectors 348. In some embodiments, the detector 348 is controlled by the imaging module 164. The detector 348 can include an eye piece, a charge-coupled device (CCD), a camera (e.g., a digital camera), or any combination thereof. If at least two detectors 348 are present, one detector can be, for example, a fast-frame-rate camera while the other detector can be a high sensitivity camera. Furthermore, the microscope 350 can include an optical train configured to receive reflected and/or emitted light from the micro fluidic device 320 and focus at least a portion of the reflected and/or emitted light on the one or more detectors 348. The optical train of the microscope can also include different tube lenses (not shown) for the different detectors, such that the final magnification on each detector can be different.

In certain embodiments, imaging device 194 is configured to use at least two light sources. For example, a first light source 332 can be used to produce structured light (e.g., via the light modulating subsystem 330) and a second light source 334 can be used to provide unstructured light. The first light source 332 can produce structured light for optically-actuated electrokinesis and/or fluorescent excitation, and the second light source 334 can be used to provide bright field illumination. In these embodiments, the motive module 164 can be used to control the first light source 332 and the imaging module 164 can be used to control the second light source 334. The optical train of the microscope 350 can be configured to (1) receive structured light from the light modulating subsystem 330 and focus the structured light on at least a first region in a microfluidic device, such as an optically-actuated electrokinetic device, when the device is being held by the nest 300, and (2) receive reflected and/or emitted light from the microfluidic device and focus at least a portion of such reflected and/or emitted light onto detector 348. The optical train can be further configured to receive unstructured light from a second light source and focus the unstructured light on at least a second region of the microfluidic device, when the device is held by the nest 300. In certain embodiments, the first and second regions of the microfluidic device can be overlapping regions. For example, the first region can be a subset of the second region.

In FIG. 3B, the first light source 332 is shown supplying light to a light modulating subsystem 330, which provides structured light to the optical train of the microscope 350 of system 355 (not shown). The second light source 334 is shown providing unstructured light to the optical train via a beam splitter 336. Structured light from the light modulating subsystem 330 and unstructured light from the second light source 334 travel from the beam splitter 336 through the optical train together to reach a second beam splitter (or dichroic filter 338, depending on the light provided by the light modulating subsystem 330), where the light gets reflected down through the objective 336 to the sample plane 342. Reflected and/or emitted light from the sample plane 342 then travels back up through the objective 340, through the beam splitter and/or dichroic filter 338, and to a dichroic filter 346. Only a fraction of the light reaching dichroic filter 346 passes through and reaches the detector 348.

In some embodiments, the second light source 334 emits blue light. With an appropriate dichroic filter 346, blue light reflected from the sample plane 342 is able to pass through dichroic filter 346 and reach the detector 348. In contrast, structured light coming from the light modulating subsystem 330 gets reflected from the sample plane 342, but does not pass through the dichroic filter 346. In this example, the dichroic filter 346 is filtering out visible light having a wavelength longer than 495 nm. Such filtering out of the light from the light modulating subsystem 330 would only be complete (as shown) if the light emitted from the light modulating subsystem did not include any wavelengths shorter than 495 nm. In practice, if the light coming from the light modulating subsystem 330 includes wavelengths shorter than 495 nm (e.g., blue wavelengths), then some of the light from the light modulating subsystem would pass through filter 346 to reach the detector 348. In such an embodiment, the filter 346 acts to change the balance between the amount of light that reaches the detector 348 from the first light source 332 and the second light source 334. This can be beneficial if the first light source 332 is significantly stronger than the second light source 334. In other embodiments, the second light source 334 can emit red light, and the dichroic filter 346 can filter out visible light other than red light (e.g., visible light having a wavelength shorter than 650 nm).

### IV. NUCLEIC ACID SYNTHESIS OR AMPLIFICATION IN MICROFLUIDIC DEVICES

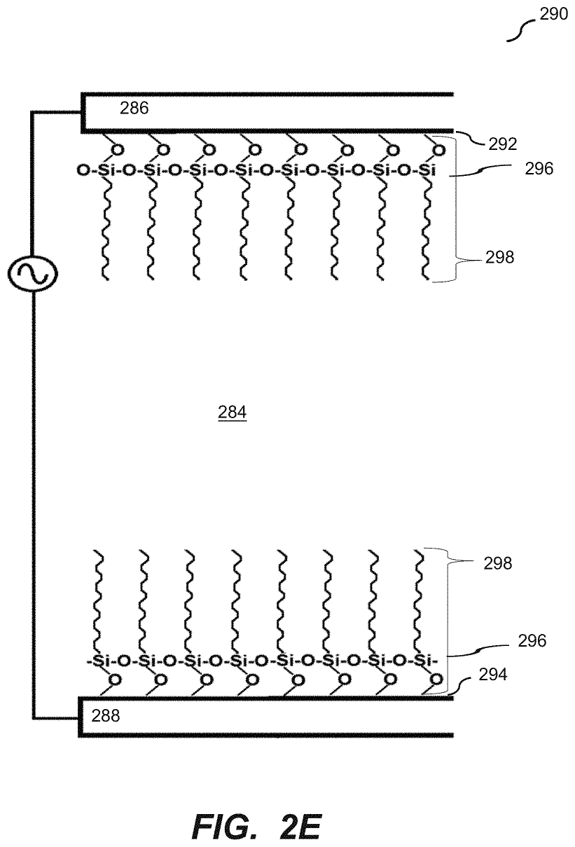

In some embodiments, methods disclosed herein comprise performing nucleic acid synthesis (e.g., reverse transcription or amplification, such as PCR, e.g., qPCR) in a droplet upon the droplet actuation surface of a microfluidic device. The microfluidic device can have any of the features described herein with respect to microfluidic devices. Exemplary embodiments of microfluidic devices, and methods of using same, are also provided in the Numbered Embodiments section below. The ability to generate precisely sized droplets within the system (as shown in FIG. 7D) is useful to the methods of nucleic acid synthesis and amplification disclosed herein. Methods of generating precisely sized droplets have been described, for example, in PCT Publication No. WO 2017/117567 (Bao et al.), the entire contents of which are incorporated herein by reference.

In some embodiments, methods disclosed herein comprise merging a (first) droplet comprising nucleic acid with a (second) droplet comprising a nucleic acid polymerase, and a buffer and precursors (e.g., nucleotides, primers, etc.) that support a polymerase activity of the nucleic acid polymerase and incubating the combined droplet upon the droplet actuation surface, under conditions that promote amplification of the nucleic acid. The second droplet can be merged with the first droplet by applying an electrowetting force to the second and/or the first droplet. In some embodiments, the nucleic acid polymerase is suitable for performing a reverse transcription reaction. Alternatively, the nucleic acid polymerase can be suitable for performing polymerase chain reaction (PCR) or for performing a whole genome amplification reaction. In some embodiments, the second droplet and/or the combined droplet comprises oligonucleotides (e.g., primers) suitable for initiating nucleic acid amplification. The oligonucleotides can include a nucleic acid-based bar code and/or a poly-dT sequence. At least some of the oligonucleotides can be linked to one or more capture beads.

In some embodiments, incubating the combined droplet under conditions that promote amplification comprises adjusting the temperature of the microfluidic device to a first temperature that is sufficient to cause the nucleic acid originating from the first droplet to denature (partially or fully). The first temperature can be at least about 85° C. (e.g., at least about 88° C., about 90° C., about 92° C., about 93° C., about 94° C., about 95° C., or greater).

In some embodiments, incubating the combined droplet under conditions that promote amplification comprises adjusting the temperature of the microfluidic device to a second temperature that promotes priming of the nucleic acid originating from the first droplet and/or the template-based extension of the primed nucleic acid. The second temperature can be about 35° C. to about 75° C. or 40° C. to about 75° C. (e.g., about 50° C. to about 70° C., or about 55° C. to about 65° C.). In some embodiments, such as embodiments involving whole genome amplification, the second temperature can be about 35° C. to about 60° C. (e.g., about 35° C. to about 45° C., or about 45° C. to about 55° C.). In some embodiments, such as embodiments involving PCR, the second temperature can be about 45° C. to about 75° C. (e.g., about 45° C. to about 55° C., about 50° C. to about 60° C., about 55° C. to about 65° C., about 60° C. to about 70° C., or about 65° C. to about 75° C.).

In some embodiments, incubating the combined droplet under conditions that promote amplification comprises: adjusting the temperature of the microfluidic device to a second temperature that promotes priming of the nucleic acid originating from the first droplet; and adjusting the temperature of the microfluidic device to a third temperature that promotes the template-based extension of the primed nucleic acid. The second temperature can be about 35° C. to about 67° C. or 50° C. to about 67° C. (e.g., about 55° C. to about 65° C., or about 58° C. to about 62° C.); and/or the third temperature can be about 50° C. to about 80° C. or 65° C. to about 80° C. (e.g., about 70° C. to about 78° C., or about 72° C. to about 76° C.). In some embodiments, such as embodiments involving whole genome amplification, the second temperature can be about 35° C. to about 60° C. (e.g., about 35° C. to about 45° C., or about 45° C. to about 55° C.). In some embodiments, such as embodiments involving PCR, the second temperature can be about 45° C. to about 67° C. (e.g., about 45° C. to about 55° C., about 50° C. to about 60° C., about 55° C. to about 65° C., or about 60° C. to about 67° C.). In some embodiments, such as embodiments involving whole genome amplification, the third temperature can be about 50° C. to about 75° C. (e.g., about 50° C. to about 60° C., or about 60° C. to about 75° C.). In some embodiments, such as embodiments involving PCR, the third temperature can be about 65° C. to about 80° C. (e.g., about 65° C. to about 75° C., about 67° C. to about 78° C., about 70° C. to about 80° C., or about 70° C. to about 74° C.).

In some embodiments, incubating the combined droplet under conditions that promote amplification comprises cycling the temperature of the microfluidic device between the first and second temperatures. In other embodiments, incubating the combined droplet under conditions that promote amplification comprises cycling the temperature of the microfluidic device between the first, second, and third temperatures. For example, at least 10 cycles can be performed (e.g., at least 5, 6, 7, 8, 9, 10, 11, 12, 13, 14, 15, 16, 17, 18, 19, 20, or more cycles are performed).

In some embodiments, a three-phase temperature control procedure is used to adjust the temperature of the microfluidic device using a Peltier thermoelectric device. The procedure can comprise setting the power output of the Peltier thermoelectric device to a first value if the difference between the target temperature and a measured temperature (e.g., by a thermistor associated with the microfluidic device) is larger than N; setting the power output to a second value lower than the first value if the difference between the target temperature and the thermistor-measured temperature is equal to or smaller than N and larger than M; and determining the power output by a proportionate-integral-derivative (PID) loop controller with the thermistor-measured temperature as an input if the difference between the target temperature and the thermistor-measured temperature is smaller than or equal to M, where M may be in the range of 7° C. to 13° C. and N may be in the range of 2° C. to 4° C. In some embodiments, M is 3° C. and N is 10° C. The procedure can have any of the additional features described with respect to the thermal control circuit configured to follow rules corresponding to such a procedure in the section concerning Systems.

In some embodiments, qPCR is performed. For example, a detection reagent can be provided together with the amplification reagents and signal from the detection reagent (e.g., fluorescence) indicative of the quantity of DNA present can be measured as the reaction proceeds. In some embodiments, the detection reagent is an intercalating dye.

In some embodiments, an amplification reaction other than PCR is performed. Based on the teachings provided herein, one skilled in the art can adapt procedures for any number of nucleic acid amplification approaches to be performed within a microfluidic device described herein. Exemplary additional amplification approaches include NASBA (nucleic acid sequence based amplification), SDA (strand displacement amplification), LAMP (loop-mediated isothermal amplification), RCA (rolling circle amplification), and TMA (transcription-mediated amplification. See, e.g., U.S. Pat. No. 5,705,365 (TMA); U.S. Pat. No. 6,326,173 and Journal of Virological Methods 151:283-293 (2008) (NASBA); U.S. Pat. No. 5,648,211 (SDA); U.S. Pat. No. 6,410,278 (LAMP); and U.S. Pat. No. 6,287,824 (RCA). One skilled in the art will understand what reagents are appropriate to provide. Each of these methods involves DNA synthesis, and as such involves the use of DNA Polymerases, nucleotides, and divalent cations (supplied as a salt), particularly magnesium, in a solution conducive to DNA polymerization and in which the template is present. The methods vary in terms of providing additional catalytic activities, the use of thermocycling or isothermal incubation, and the use and structure of primers.

A. Electrowetting Microfluidic Device Design Functional at a Broad Range of Temperatures

A microfluidic device having an electrowetting configuration may be provided for preparing sequencing libraries and/or amplifying nucleic acid, e.g., from a small number of selected cells (e.g., 10-100 cells) in a cost-efficient and high-throughput manner. Use of agents can be minimized and automatic workflow can be achieved by performing the workflow on the microfluidic device according to the present disclosure. In doing so, we have found it significant that the reagents located within aqueous droplet can be formulated so as not foul the surface of the microfluidic device having the electrowetting configuration. Guidance in this regard is provided in the discussion of surfactants above.

Further, the electrowetting device can be thermally cycled between low temperatures and high temperatures near the freezing and boiling points of water at sea level (for example, 4° C. to 98° C.) while avoiding breakdown of the hydrophobic layer, such as areas wherein fluid can directly contact the semi-conductive layer underneath the hydrophobic layer, resulting in an electrical short) and the resulting trapping (or “pinning”) of droplets to the breakdown points.

Features that can contribute to functionality of the microfluidic device and performance of the methods described herein while minimizing breakdown of the hydrophobic layer are described above and exemplified in the Examples and Numbered Embodiments below.

### V. NUCLEIC ACID LIBRARY PREPARATION IN MICROFLUIDIC DEVICES

Any kind of DNA library preparation protocol may be adapted for use within the microfluidic device having an optoelectronic wetting configuration, and several different versions are described herein. Such DNA library preparation protocol includes commercially available KAPA Hyper Plus (Roche) and Nextera™ XT (Illumina).

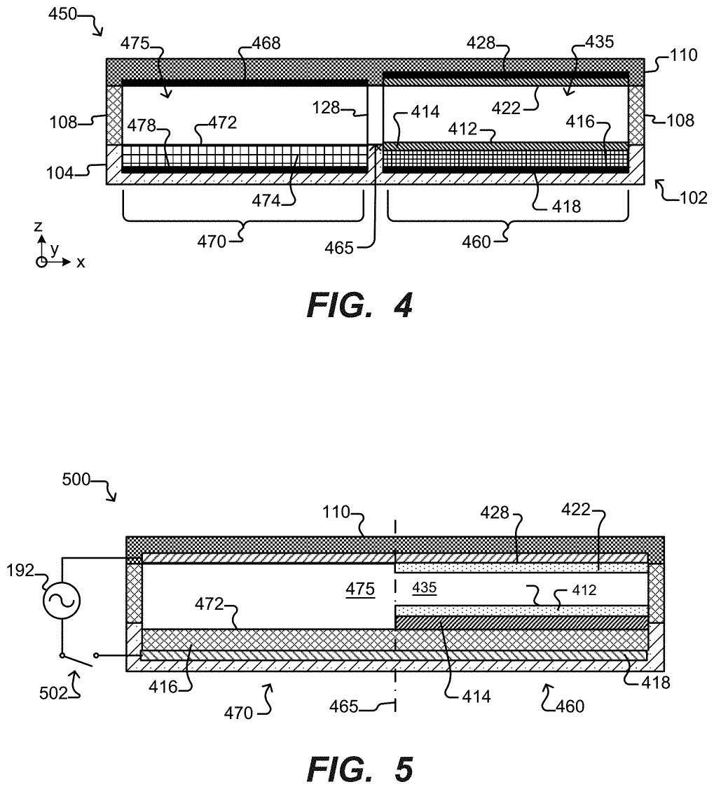

FIG. 11 shows several steps of the method of providing a sequencing ready genomic DNA, which may be obtained from either RNA or DNA. The ability to generate precisely sized droplets within the system is useful to the methods herein (as shown in FIG. 7D. Methods of generating precisely sized droplets have been described, for example, in PCT Publication No. WO 2017/117567 (Bao et al.), the entire contents of which are incorporated herein by reference.

A. Culturing Cells

In some embodiments, cells are cultured in the microfluidic device (FIG. 11, optional step 1110). In some embodiments, the microfluidic chip includes a first section that has an electrowetting (EW) configuration and a second section that includes a dielectrophoresis (DEP) configuration for cell culture within the device. Alternatively, two separate chips may be provided such that a DEP chip is connected to a EW chip (e.g., by an export/import tube). Cells can be cultured in sequestration pens in the DEP section of the chip (or DEP chip), as described in e.g., WO 2016/141343. Cultured cells can be assayed in their sequestration pens to identify cells of interest, as described, e.g., in PCT/US2014/061837, published as WO 2015/061497; PCT/US2014/061848, published as WO 2015/061506; PCT/US2015/027795, published as WO 2017/181135, by epitope labeling (e.g., with fluorescently labeled antibodies), or any other microfluidic assay known in the art.

Cells of interest then can be selectively exported from their corresponding sequestration pens, optionally pooled, and transported to the EW section of the chip (or EW chip). The cells can be encapsulated in a droplet surrounded by a water immiscible medium (e.g., oil or organic liquid) at the DEP/EW interface. The cell selection can be based on rate of cell growth, morphology, assay results, or any comb thereof. As discussed above, the droplet comprising cells can further comprise a surfactant, which can aid in movement of the droplet.

B. Lysing Cells

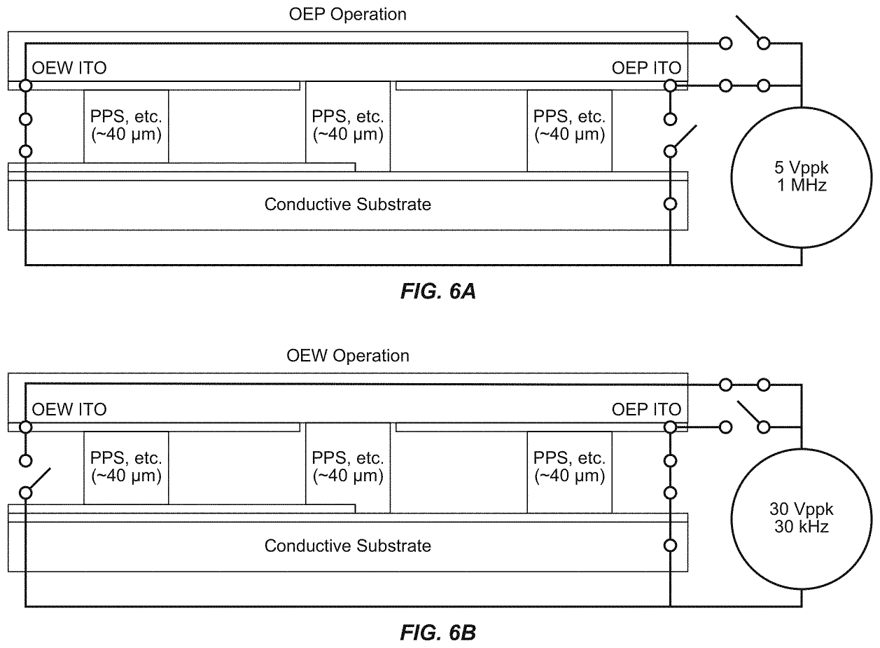

In some embodiments, the method comprises lysing one or more cells in an EW section of a microfluidic device (or an EW microfluidic device) (FIG. 11, step 1120). Lysis may be performed with or without a prior culturing step. In some embodiments, a first droplet containing one or more cells is merged with a second droplet containing a lysing reagent to form a first combined droplet. As an example, the first droplet can be 10 nL in volume and can contain 5-100 cells, 10-50 cells, or about 30 cells, and the second droplet can be 10 nL in volume; however, different droplet sizes, different numbers of cells, and different ratios of first droplet volume to second droplet volume can be used. In one embodiment, as shown in FIG. 12 (a single cell lysis is conducted in which the cell is lysed within 30 seconds), a first droplet containing a single cell is merged with a second droplet containing a cell lysing agent to form a combined droplet, and the combined droplet was incubating to achieve lysis of the single cell. The arrow in FIG. 12 indicates the position of the cell in the first droplet and the combined droplet. The cell disappears in the combined droplet during the course of the incubation.

Examples of a suitable lysing agent include proteases such as proteinase K, including a heat sensitive version of proteinase K, which is commercially available. Conditions for lysis can be varied depending on a concentration of the lysing agent and a ratio of the first droplet volume to the second droplet volume. For example, cells can be incubated with 1mg/mL proteinase K at 50° C. -65° C. for about 20-40 (e.g., about 30) minutes. The second droplet contains 2mg/mL proteinase K if a ratio of the first droplet volume to the second droplet volume is 1:1.

The lysing reagent is an agent that can be inactivated/neutralized. For example, proteinase K can be heat inactivated, e.g., at 85° C. -95° C. for about 15-25 (e.g., 20) minutes.

A surfactant in the first droplet can prevent cells from sticking to the microfluidic device's surfaces (surfactant selection can be influenced by the chemical structure of the hydrophobic layer of the device, as discussed in detail herein).

A surfactant in the second droplet (lysing reagent droplet) is used to prevent the reagents in the second droplet and the first combined droplet from sticking to (or “fouling”) the microfluidic device surfaces. For example, 0.1-0.5% (e.g., 0.2%) polysorbate having a molecular weight of at least 750 daltons, such as polysorbate 20 (Tween 20®), may be used to improve lysis performance and mobility of the first combined droplet (see, e.g., Example 3-B below). Any non-ionic detergent with a large polar group could be substituted (e.g., an oxtylphenol ethoxylate, optionally where the ethoxylate group has an average length of at least 9 ethyloxide units, or at least 15, 20, 25, 30 or more ethyloxide units, such as Triton X-305, Triton X-100, or the like, or a nonyl phenoxypolyethoxylethanol, optionally where the polyethylene glycol chain has a length of at least 9 ethyoxide units, or at least 15, 20, 25, 30 or more ethyloxide units, such as NP-40).

C. Fragmenting DNA

In some embodiments, the method further comprises fragmenting DNA (e.g., gDNA) released by cell lysis (FIG. 11, step 1130). The nucleic acid fragments produced by fragmenting the nucleic acid from the one or more biological cells may have an average size of about 300 to about 600 bases or base pairs. The first combined droplet (generated in step 1120) is mixed with a third droplet containing double-stranded DNA-fragmenting reagent to form a second combined droplet. The DNA-fragmenting agent may comprise a DNA cutting enzyme, optionally in combination with a DNA nicking enzyme. Examples of DNA cutting enzyme include a fragmentase (e.g., commercially available KAPA Fragmentase; NEBNext dsDNA Fragmentase). Alternatively, one or a mixture of endonucleases/restriction enzymes may be used. The second combined droplet is incubated with an appropriate temperature and time, depending on the reagent used, the amount of DNA, and other considerations, e.g., at about 30° C. to about 42° C. (e.g., about 35° C. to about 39° C., or about 37° C.), for at least about 10 minutes (e.g., about 10 to 20 minutes, about 12 to about 18 minutes, or about 15 minutes). For example, The second combined droplet is incubated at 37° C. for about 15 minutes.

Then, the fragmentation reaction is stopped by, for example, raising the temperature to 65° C. (thereby denaturing fragmentase enzyme(s)). In some embodiments, the droplet containing the double-stranded DNA cutting reagent includes a surfactant. Appropriate surfactants are discussed above in the section concerning aqueous droplets.

D. Adding Adapters to DNA Fragments

The method may further comprise adding adapters to DNA fragments (FIG. 11, step 1140). In some embodiments, the adapters are added in a two-step process.

In a first step, 3′ A nucleotide overhangs are generated at the ends of the DNA fragments. The second combined droplet (from step 1130) is merged with a fourth droplet containing an A-tailing enzyme (e.g., a polymerase with A-tailing activity, such as Taq polymerase) and appropriate reagents to form a third combined droplet. In some embodiments, the fourth droplet comprises Taq polymerase and a mixture of dNTPs. The third combined droplet is incubated for an appropriate time and temperature, e.g., about 60° C. to about 70° C. (e.g., about 62° C. to about 68° C., or about 65° C.), for at least about 15 minutes (e.g., about 15 to 45 minutes, about 20 to about 40 minutes, about 25 to about 35 minutes, or about 30 minutes). For example, the third combined droplet is incubated at 65° C. for 30 minutes. Polymerases other than Taq polymerase can be used (e.g., as provided in the commercially available KAPA A-tailing mixture).

The second step is to ligate double-stranded adapters having a 5′ T nucleotide overhang at one or both ends. The third combined droplet (from step 1140A) is merged with a fifth droplet comprising a ligase, the double-stranded adapters, and appropriate reagents (e.g., ATP) to form a fourth combined droplet. In some embodiments, the ligase is T4 ligase. The fourth combined droplet is incubated for appropriate time and temperature, e.g., about 15° C. to about 25° C. (e.g., about 18° C. to about 22° C., or about 20° C.) for at least about 10 minutes (e.g., about 10 to about 20 minutes, about 12 to about 18 minutes, or about 15 minutes). Ligases other than T4 can be used. The ligase may be inactivated by adjusting the temperature of the microfluidic device to a temperature of about 80° C. to about 90° C. (e.g., about 82° C. to about 88° C., or about 85° C.), optionally for at least about 10 minutes (e.g., about 10 to about 20 minutes, about 12 to about 18 minutes, or about 15 minutes).

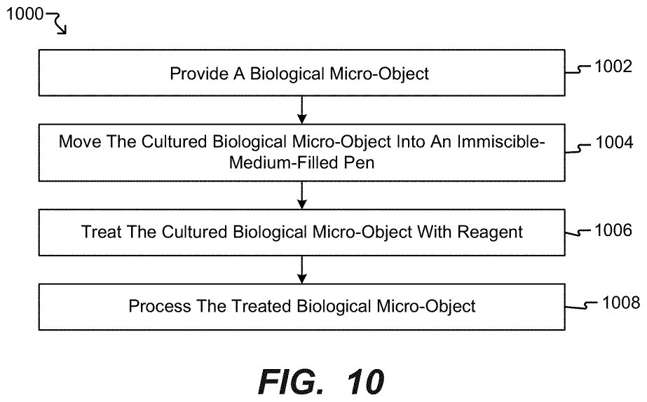

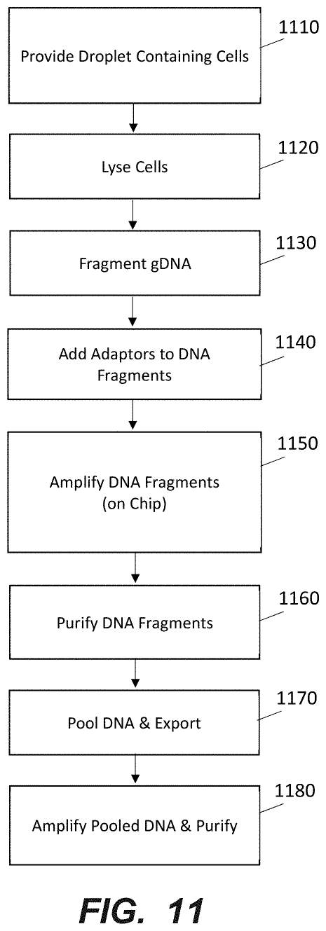

Each adapter can include a unique barcode, and/or a target sequence for amplification. Combinations of barcodes can be used with different samples so that each sample is uniquely labeled. An example of barcoding is described in Examples 2-C and 2-D below and also in FIGS. 15 and 16.

The droplet containing the polymerase/A-tailing mixture can include a surfactant. Appropriate surfactants are discussed above in the section concerning aqueous droplets. In some embodiments, the same type of surfactant used in moving cell-containing droplets in prior step 1110 is used.

E. Tagmentation (Alternative for Fragmentating and Adding Adapters)

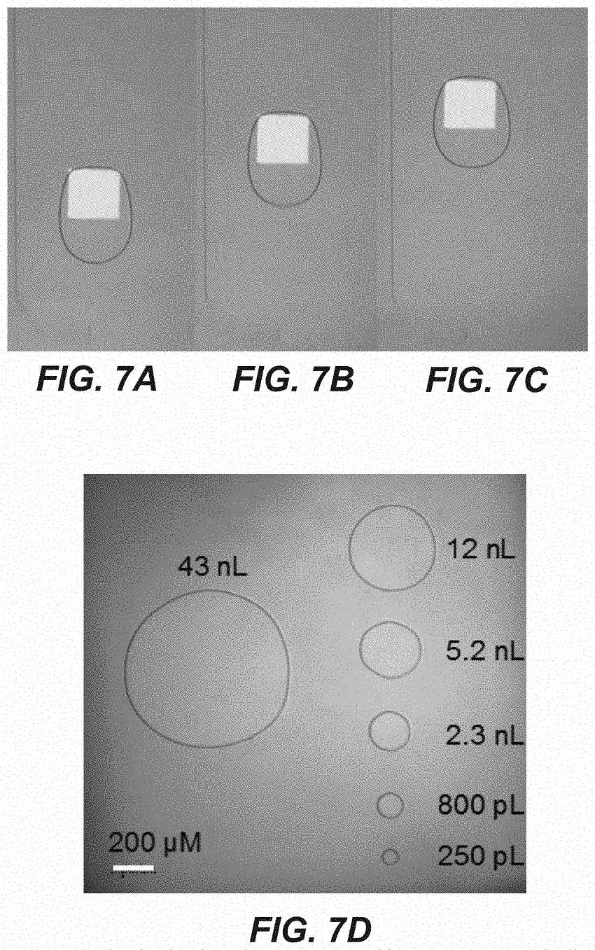

Alternatively, fragmentation and adding adapters to DNA fragments (steps 1130 and 1140) can be combined into a tagmentation step, which is a process that fragments DNA and tags the DNA with adapter sequences in a single step (as depicted in FIG. 13). In some embodiments, the method further comprises mixing the first combined droplet with a third droplet containing a transposase and other reagents to form a second combined droplet. The transposase is pre-loaded with two double-stranded oligos having adapter sequences. A commercially available transposase may be used, e.g., from the Nextera transposome mix (Illumina). The stoichiometric ratio of tagmentation mix can be determined based on the number of cells/number of DNA molecules and concentration of transposomes.

The reaction temperature and time may vary depending on the other conditions regarding the droplet. The incubation temperature and time may be about 50° C. to about 60° C. (e.g., about 52° C. to about 58° C., or about 55° C.), and at least about 3 minutes (e.g., about 3 to 7 minutes, about 4 to about 6 minutes, or about 5 minutes). For example, the second combined droplet may be incubated at 55° C. for 5 minutes.

In some embodiments, the method further comprises mixing the second combined droplet with a fourth droplet containing a tagmentation stop buffer to form a third combined droplet. The reaction may be neutralized shortly after the incubation using tagmentation stop buffer, for example, after 5 minutes of incubation. The tagmentation stop buffer denatures the transposase. For the stop buffer, 0.1%42% SDS, Nextera NT buffer or the like may be used.

Although Nextera tagmentation adapter sequences do not include barcodes, barcodes may be added if desired through an additional PCR amplification step. It is advisable to purify tagmented DNA in the third combined droplet before performing PCR amplification, as tagmentation stop buffer present in the droplet may otherwise interfere with PCR. In some embodiments, magnetic beads are used to purify DNA. Methods of purifying DNA on chip have been described, for example, in U.S. Patent Application Publication No. 2015/0038344, the entire contents of which are incorporated herein by reference.

F. DNA Fragment Amplification (FIG. 11, step 1150) and Reagents thereof

In some embodiments, DNA is amplified following adapter attachment. Amplification may be performed within the microfluidic device (FIG. 11, step 1150) or after exporting the DNA.

Amplification procedures are discussed in detail in the section above concerning nucleic acid synthesis. The fourth combined droplet containing DNA fragments from step 1140B, or if tagmentation is performed, the third combined droplet prior to amplification is purified. The purified DNA droplet (or the fourth combined droplet from step 1140B) is merged with a sixth droplet containing an amplification mixture to form a fifth combined droplet. Then, temperature cycling on the fifth combined droplet is performed. For the DNA amplification, a high-fidelity DNA polymerase (e.g., KAPA HiFi polymerase, or a thermostable DNA polymerase comprising 3′ to 5′ editing exonuclease activity or the like) can be used. The times for each cycle may vary, including the time for temperature increase/decrease. The standard temperature cycle may include 95° C. for 70 seconds, 55° C. for 30 second, 72° C. for 50 seconds. Depending on the desired amount of amplification, temperature cycling can be performed with at least 10, 20, or 30 cycles, or about 10 to 20 cycles, or about 12 to 15 cycles. In some embodiments, 4-15 cycles are performed. In some embodiments, 4-6 cycles or 10-14 cycles are performed. In some embodiments, 12 cycles are performed.

For DNA fragments from step 1140B, each primer may include a sequence complementary to an adapter target sequence and, optionally, a sequence that can be used for further amplification and/or sequencing (e.g., Nextera P5 and P7 sequences). For DNA fragments produced by tagmentation, each primer may include a barcode sequence located between the adapter target sequence and the sequence useful for further amplification and/or sequencing.

The amplification mix can include a surfactant, e.g., to prevent DNA and DNA polymerase from fouling surfaces. For example, 0.1%-0.5% (or 0.2%) Tween-20 is preferred. Alternatively, 0.1%-0.5% (or 0.2%) of a PEO-PPO block co-polymer can be used (e.g., Pluronic F68, Pluronic F127). Alternatively, 0.1%-0.5% (or 0.2%) of 2,4,7,9-tetramethyl-5-decyne-4,7-diol ethoxylate (TET) can be used. Additional relevant discussion of surfactants is provided within the section concerning aqueous droplets.

The amplification conditions can be applied to the amplification of any of the nucleic acids (or fragments thereof), such as the amplifications described in below-numbered embodiments 160-165 and 167-169.

G. Subsequent Steps

Amplified DNA fragments can be purified (FIG. 11, step 1160) essentially as discussed above. The amplified fragments can be exported from the microfluidic device before or after purification.

As an alternative to amplification within the microfluidic device, DNA fragments can be pooled and exported out of the chip (FIG. 11, step 1170) followed by amplification and purification of pooled DNA fragments (FIG. 11, step 1180). Off-chip amplification and purification may be performed by standard techniques. The amplified and purified DNA fragments are ready for sequencing, which can be performed by standard genomic sequencing techniques, e.g., on a next generation sequencing platform, such as the Illumina MySeq, etc.

H. cDNA Library Preparation

In some embodiments, a cDNA library is prepared. Following lysis as described above, the first combined droplet can be merged with a third droplet of aqueous medium to form a second combined droplet, wherein the third droplet comprises a reverse transcriptase and suitable reagents (e.g., dNTPs and oligo-dT for use as a primer). The second combined droplet can be incubated to permit reverse transcription, thereby forming cDNA. Incubating can comprise adjusting the temperature of the microfluidic device to a temperature of about 50° C. to about 60° C. (e.g., about 52° C. to about 58° C., or about 55° C.), for at least about 1 minute (e.g., about 1 to 5 minutes, about 1 to about 3 minutes, or about 2 minutes); and adjusting the temperature of the microfluidic device to a temperature of about 37° C. to about 45° C. (e.g., about 40° C. to about 43° C., or about 42° C.), for at least about 45 minutes (e.g., at least about 50, about 55, about 60 minutes, or more). The oligo-dT can further comprise a 5′ sequence useful as a primer binding site for downstream steps, or be linked to a bead, such as a magnetic bead. In further steps, droplets comprising cDNA can be amplified by merging with a droplet comprising an amplification mixture, e.g., including appropriate primers for the PCR stage of RT-PCR and otherwise essentially as described above. The same steps described above following amplification can be performed to complete preparation of a cDNA library.

### VI. EXAMPLES

The systems used in these examples included microfluidic devices (Berkeley Lights, Inc.) having at least 12 chambers fluidically connected to a flow path, and at least one inlet and one outlet for introduction and export of fluidic media, droplets containing cells, reagents and/or prepared samples according to the experiments. The chambers have a volume of about 80 nanoliters. The device has substrates configured to provide electrowetting, where at least the surfaces of the substrates included covalently modified surfaces. The covalently modified surfaces were selected from one of the two following modifications:
1. Dimethoxy (3, 3, 4, 4, 5, 5, 6, 6, 7, 7, 8, 8, 9, 9, 10, 10, 11, 11, 12, 12, 13, 13, 14, 14, 15, 15, 16, 16, 16-nonacosafluorohexadecyl)siloxy-linked moieties (an example of SSRL2)
2. Octadecyl siloxy-linked moieties (an example of SSRL1)
   Additionally, moieties comprising CF₃(CF₂)ₙ—(O)ᵢ—(CH₂)ₘ—V, wherein V is a siloxy linker attached to the surface and either (i) n=11, m=2, j=0 or (ii) n=5, m=13, j=1, were also made and tested, and found to permit acceptable droplet operations similar to at least some of those described below. In general, organic liquids and surfactants similar to those used with SSRL2 can be used with these surface modifications, all of which comprise a series of perfluorinated carbons.

The aqueous immiscible medium used to fill the chambers and the flow path of the microfluidic device was selected from one of the following materials:
1. 2-(Trifluoromethyl)-3-ethoxydodecafluorohexane (HFE-7500, 3M™, Novec™)
2. Heptamethyl nonane (HMN or isocetane)
3. bis(2-ethylhexyl) carbonate (TEGOSOFT® DEC, (Evonik))
4. (Tridecafluoro-1, 1, 2, 2, -tetrahydrooctyl) tetramethydisiloxane (Gelest, Cat # SIB1816.0)
5. Silicone oil (5 centistoke viscosity, Gelest Cat. # DMS-T05).

Surfactants may be added to the water-immiscible fluidic medium. In some embodiments, a suitable surfactant may be a non-ionic surfactant, such as sorbitane monooleate (Span 80, Aldrich Cat. # 1338-43-8).

The system also included an optical instrument manufactured by Berkeley Lights, Inc. to control the microfluidic device. The instrument included: a mounting stage for the device coupled to a temperature controller; a pump and fluid medium reservoir component; and an optical train including a camera and a structured light source suitable for activating the optoelectronic wetting substrates within the device. The instrument also included a movable magnet under the microfluidic device.

Cells. Cells used in all experiments were a B-lymphocyte cell line (Coriell Institute, Cat. # GM12878).

### A. Example 1

### Preparation of an Electrowetting Microfluidic Device having Modified Interior Surfaces.

A microfluidic device (Berkeley Lights, Inc.) having a base that included an electrode activation substrate having a semiconductive layer of photosensitive silicon and a dielectric layer having an upper surface of alumina, a cover having a glass support with an ITO electrode, and microfluidic circuit material of photopatterned silicone separating the base and the cover, was treated in an oxygen plasma cleaner (Nordson Asymtek) for 1 min, using 100W power, 240 mTorr pressure and 440 sccm oxygen flow rate. The plasma-treated microfluidic device was treated in a vacuum reactor with trimethoxy (3, 3, 4, 4, 5, 5, 6, 6, 7, 7, 8, 8, 9, 9, 10, 10, 11, 11, 12, 12, 13, 13, 14, 14, 15, 15, 16, 16, 16)-nonaicosafluorohexadecyl)silane (0.3g, details of synthesis as described in WO 2017/205830, published Nov. 30, 2017) in a foil boat in the bottom of the vacuum reactor in the presence of magnesium sulfate heptahydrate (0.5g, Acros), as a water reactant source, in a separate foil boat in the bottom of the vacuum reactor. The chamber was then pumped to 750 mTorr using a vacuum pump and sealed. The vacuum reactor was placed within an oven heated to 180° C. for 24-48 h. After cooling to room temperature and introducing argon to the evacuated chamber, the microfluidic device having an outer hydrophobic layer of dimethoxy (3, 3, 4, 4, 5, 5, 6, 6, 7, 7, 8, 8, 9, 9, 10, 10, 11, 11, 12, 12, 13, 13, 14, 14, 15, 15, 16, 16, 16-nonacosafluoro-hexadecyl)siloxy moieties on all interior surfaces was removed from the reactor. Following removal, the microfluidic device was primed with silicone oil (5 centistoke viscosity, Gelest Cat. # DMS-T05) prior to use.

FIGS. 7A-7C are successive photographic images of a droplet of water being moved around upon the hydrophobic layer (i.e., the droplet actuation surface), within an immiscible silicone oil phase. The droplet demonstrated excellent ability to be moved using the optically actuated electrowetting configuration and droplet actuation surface of the microfluidic device.

### B. Example 2

### DNA Sequencing Library Preparation

FIG. 11 shows an exemplary workflow for providing a nucleic acid sequencing library, which may be obtained from either RNA or DNA. The ability to generate precisely sized droplets within the system is useful to the methods herein, as shown in FIG. 7D.

Culture Cells on Chip (FIG. 11, optional step 1110)

A microfluidic device (chip) including a first section that has an electrowetting (EW) configuration and a second section that includes a dielectrophoresis (DEP) configuration can be used to culture cells. Alternatively, two separate chips may be provided such that a DEP chip is connected to an EW chip (e.g., by an export/import tube). Cells are cultured in sequestration pens in the DEP section of the chip (or DEP chip), as described in e.g., WO 2016/141343. Cultured cells can be assayed in their sequestration pens to identify cells of interest, as described, e.g., in PCT/US2014/061837, published as WO 2015/061497; PCT/US2014/061848, published as WO 2015/061506; PCT/US2015/027795, published as WO 2017/181135, by epitope labeling (e.g., with fluorescently labeled antibodies), or any other microfluidic assay known in the art.

Cells of interest then can be selectively exported from their corresponding sequestration pens, optionally pooled, and transported to the EW section of the chip (or EW chip). The cells can be encapsulated in a droplet surrounded by a water immiscible medium or oil at the DEP/EW interface. Cell selection can be based on rate of cell growth, morphology, assay results, or any combination thereof.

Lyse Cells (FIG. 11, step 1120)

Cell lysis was performed in an electrowetting section of a chip (or an EW chip). A first droplet containing cells was merged with a second droplet containing a lysing reagent to form a first combined droplet. As an example, the first droplet can be 10 nL in volume and can contain 5-100 cells, 10-50 cells, or about 30 cells, and the second droplet can be 10 nL in volume; however, different droplet sizes, different numbers of cells, and different ratios of first droplet volume to second droplet volume can be used.

An appropriate surfactant in the first droplet can prevent cells from adhering to the microfluidic device's surfaces. See the guidance regarding surfactant selection provided herein.

Examples of a suitable lysing agent include a protease such as proteinase K and more heat sensitive versions of proteinase K, which are commercially available. Conditions for lysis can be varied depending on a concentration of the lysing agent and a ratio of the first droplet volume to the second droplet volume. For example, cells can be incubated with 1mg/mL proteinase K at 50° C. -65° C. for 30 minutes; to expose cells to this concentration of proteinase K, the second droplet can be provided with 2mg/mL proteinase K if the volume ratio of the first droplet to the second droplet is 1:1.

The lysing reagent can be an agent that can be inactivated/neutralized. For example, proteinase K can be heat inactivated, e.g., at 85° C. -95° C. for up to 20 minutes.

A surfactant in the second droplet (lysing reagent droplet) was used to prevent the reagents and/or cellular material in the second droplet and the first combined droplet from sticking (or “fouling”) to the microfluidic device surfaces. For example, 0.1-0.5% (e.g., 0.2%) polysorbate 20 (Tween 20®) may be used to improve lysis performance and mobility of the first combined droplet. Any non-ionic detergent with a large polar group could be substituted, such as octylphenol ethoxylate, wherein the ethoxylate group has an average length of at least 9 ethyloxide units, or at least 15, 20, 25, 30 or more ethyloxide units (e.g., Triton X-305 or Triton X-100), octylphenoxypolyethoxyethanol (e.g., NP-40).

Fragment genomic DNA (FIG. 11, step 1130)

The genomic DNA released by cell lysis was fragmented. The first combined droplet (generated in step 1120) was mixed with a third droplet containing double-stranded DNA cutting reagent to form a second combined droplet. Examples of DNA cutting reagent include a fragmentase (e.g., commercially available KAPA Fragmentase; NEBNext dsDNA Fragmentase). Alternatively, one or a mixture of endonucleases/restriction enzymes may be used.

The second combined droplet was incubated at 37° C. for 15 minutes or longer. Then, the fragmentation reaction was stopped by, for example, raising the temperature to 65° C. (thereby denaturing the DNA cutting reagent).

Modifications of fragmentation mix and ligation mix were developed specifically for use with the modified surfaces (SSRL1 or SSRL2) as described herein and below in Tables 3 and 4.

The droplet containing the double-stranded DNA cutting reagent included a surfactant. The surfactant varies depending on the reagent and the surface coating of the microfluidic device. For example, for SSRL1, TET surfactant was used (essentially no fouling was observed, even at high temperature); PEO-PPO block co-polymers (e.g., Pluronics F68, L31, and F127) and N-(1,3-bis(Glucopyranoside)propan-2-yl)-3-Butyl-3-Cyclohexylheptanamide (e.g., Cy-Tripglu (formerly called Tritop)) were also used successfully. For SSRL2, PEO-PPO block co-polymers (e.g., Pluronics F68, L31, F127) and TET surfactant both worked well.

Adding adapters to DNA fragments (FIG. 11, step 1140)

After a fragmentase (or mixture of restriction endonucleases) is used at step 1130, adapters are added to DNA fragments in a two-step process:

The first step is to generate 3′A nucleotide overhang at the ends of the DNA fragments. The second combined droplet (from step 1130) is merged with a fourth droplet containing a polymerase/A-tailing enzyme to form a third combined droplet. For example, the fourth droplet can include Taq polymerase, a suitable Taq buffer, and a mixture of all nucleotides. The third combined droplet is incubated for an appropriate time and temperature, e.g., 65° C. for 30 minutes. Polymerases other than Taq polymerase can be used (e.g., KAPA A-tailing mixture).

The second step is to ligate double-stranded adapters having a 5′ T nucleotide overhang at one or both ends. The third combined droplet (from step 1140A) is merged with a fifth droplet containing a ligase (and ATP) to form a fourth combined droplet. For example, the fifth droplet can include T4 ligase. The fourth combined droplet is incubated for appropriate time and temperature, e.g., 20° C. for 15 minutes. Ligases other than T4 can be used.

Each adapter can include a unique barcode, and/or a target sequence for amplification. Combinations of barcodes can be used with different samples so that each sample is uniquely labeled, as described herein and illustrated in FIGS. 15 and 16. This allows fragments from different samples to be pooled and processed in parallel while retaining information about which sample produced particular sequence reads.

The droplet containing the polymerase/A-tailing mixture includes a surfactant. The surfactant varies depending on the surface coating of the microfluidic device. For example, 0.1-0.5% (e.g., about 0.2%) Cy-Tripglu (Tritop) was used successfully with the SSRL1 coating. With the SSRL2 coating, the surfactant from the previous steps can be sufficient. Alternatively, the same type of surfactant used in moving cell-containing droplets in prior step 1110 may be used, e.g., to maintain a constant overall concentration of surfactant.

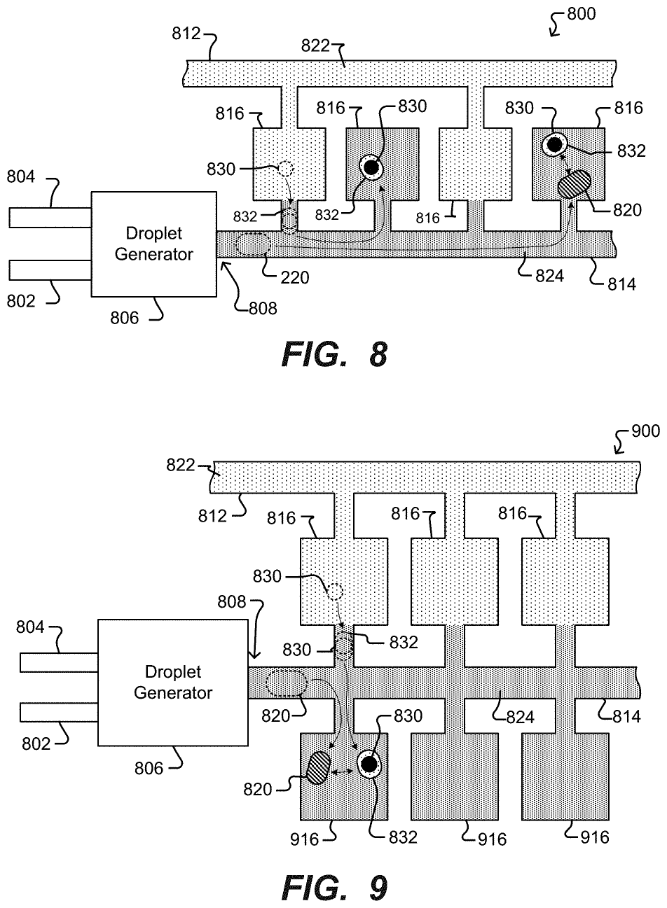

Tagmentation (alternative with combined fragmentation and adapter addition) (FIGS. 13 and 14)

Alternatively, steps 1130 (fragmentation) and 1140 (adding adapters to DNA fragments) of FIG. 11 can be combined into a single tagmentation step. As shown in FIG. 13, DNA transposomes with adapters are combined with genomic DNA, simultaneously fragmenting and tagging DNA in a single step.

FIG. 14 shows a first combined droplet containing about 10 lysed cells (10 nl cells and 10 nl lysis buffer), a second droplet containing 10 nl tagmentase, a third droplet containing 20 nl tagmentation buffer, and a fourth droplet containing 10 nl fragmentation stop buffer (NT buffer). A second droplet containing 10 nl tagmentase was merged with a third droplet containing 20 nl tagmentation buffer to form a combined tagmentation droplet. The tagmentase (Nextera transposase, Illumina) was pre-loaded with two double-stranded oligos having adapter sequences. The combined tagmentation droplet containing 30 nl tagmentation mix was merged with the first droplet containing about 10 lysed cells (10 nl cells and 10 nl lysis buffer) to form a second combined droplet. The second combined droplet was incubated at 55° C. for 5 minutes and cooled down to 14° C. Next, the second combined droplet was merged with a fourth droplet containing 10 nl of tagmentation stop buffer (Nextera NT buffer) to form a third combined droplet. The tagmentation stop buffer denatures the tagmentase.

Barcoding and Tailing/ Bead Based Barcoding Protocols were developed to introduce barcodes to nucleic acid fragments, adapted to be modified to contain the barcodes. Barcoding can be performed using beads. The resulting amplification via qPCR demonstrated the ability to amplify via a PCR under thermal cycling conditions. An example of barcoding and tailing is described in Examples 2-B and FIGS. 15-16.

On-Chip DNA Fragment Amplification (FIG. 11, step 1150)

On-Chip amplification is performed as follows. The fourth combined droplet containing DNA fragments from step 1140B, or if tagmentation is performed, the third combined droplet prior to amplification is purified. The purified DNA droplet (or the fourth combined droplet from step 1140B) is merged with a sixth droplet containing an amplification mixture to form a fifth combined droplet. Then, temperature cycling on the fifth combined droplet is performed. For DNA amplification, a high-fidelity DNA polymerase (e.g., KAPA HiFi polymerase, or the like) is used. The times for each cycle may vary, including the time for temperature increase/decrease. The standard temperature cycle may include 95° C. for 70 seconds, 55° C. for 30 seconds, 72° C. for 50 seconds. Depending on the desired amount of amplification, temperature cycling can be performed with 4-15 cycles. In some embodiments, 4-6 cycles or 10-14 cycles are performed. In some embodiments, 12 cycles of thermal cycling are performed.

For DNA fragments from step 1140B, each primer may include a sequence complementary to an adapter target sequence and, optionally, a sequence that can be used for further amplification and/or sequencing (e.g., P5 and P7 sequences in primers available from Illumina). For DNA fragments produced by tagmentation, each primer may include a barcode sequence located between the adapter target sequence and the sequence useful for further amplification and/or sequencing.

The amplification mix includes a surfactant to prevent DNA and DNA polymerase from fouling surfaces. For example, 0.1%45% (or 0.2%) Tween-20 was found to be effective. Alternatively, 0.1%-0.5% (or 0.2%) of a PEO-PPO block co-polymer (e.g., Pluronic F68, Pluronic F127) or 0.1%-0.5% (or 0.2%) of 2,4,7,9-tetramethyl-5-decyne-4,7-diol ethoxylate (TET) can be used.

Subsequent Steps

Amplified DNA fragments were purified (FIG. 11, step 1160). DNA fragments were pooled and exported out of the chip (FIG. 11, step 1170) followed by amplification and purification of pooled DNA fragments (FIG. 11, step 1180). Off-chip amplification and purification may be performed according to standard procedures.

Bead Based Purification (FIG. 11, step 1160) The amplified fragments were pooled and treated to remove excess primers and other contaminants after export from the microfluidic chip. Examples of beads useful for such purification include 15 μm carboxyl-coated magnetic beads (Spherotech). The 15 μm carboxyl-coated magnetic beads were also shown to be capable of purifying the sequencing library materials on chip. Carboxyl coated beads were added to droplets containing amplified DNA fragments and the combined droplets were incubated in the pens for 5 minutes at room temperature; 80% ethanol was introduced to wash the beads. Another example of beads for use in purification is 1 μm SPRI magnetic beads.

Elution (FIG. 11, step 1170) The purified DNA sequencing libraries were eluted from the purification beads (off chip) by incubating them in water for 2 minutes at room temperature.

Quantification. Protocols were developed to permit on-chip quantification. DNA was aliquoted and incubated with fluorescent dye for quantification (e.g., incubated for 3 minutes at room temperature). An example of quantification is described in Example 2-F.

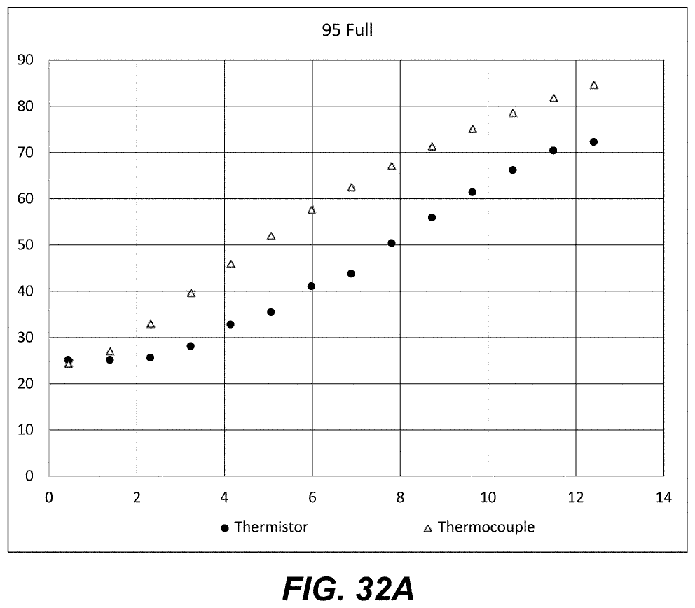

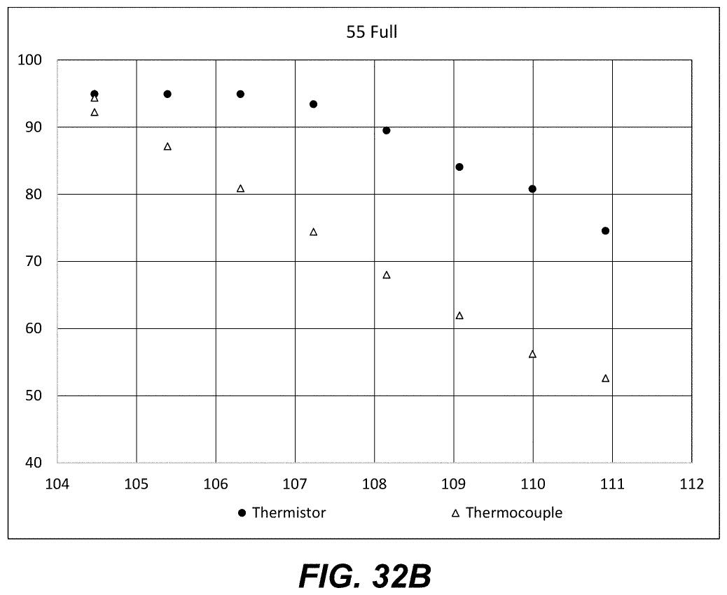

Sequencing Results. FIG. 30 shows a nucleic acid sequencing library sample obtained from cDNA prepared on a microfluidic chip having an electrowetting configuration based on the above described method. That sample, derived from 60 cells, was sequenced via SCRB-seq. The results of the number of unique genes identified in the sequencing run is shown in the graph of FIG. 31, and was compared to the number of genes identified for single cell sequencing runs.

### C. Example 2-A

### DNA Library Preparation Workflow Modified for Surface Conditions

The KAPA Hyper Plus Workflow DNA library preparation protocol was adapted for use within a microfluidic device having an optoelectronic wetting configuration, as shown in Tables 2-4, below. Table 2 represents a general workflow, while Tables 3 and 4 show workflows that were optimized for microfluidic devices having SSRL1 and SSRL2 surface coatings, respectively.

TABLE 2
Reagents and steps used in KAPA protocol (Fragmentation, end repair, ligation).

| Workflow | | |
|---|---|---|
| (incubation time/temperature) | Droplet Size | Reagent Mix |
| Separate cells into droplet | 7 nl | |
| Make Lysis Mix | 7 nl | 5 μl lysis enzyme |
| | | 50 μl buffer (EDTA−) (TW+) |
| Merge with Lysis droplet | 7 nl + 7 nl | |
| Incubate 30 mins at 50° C. | | |
| Incubate 20 mins at 85° C. | | |
| Set to Room temperature 25° C. | | |
| Prepare fragmentation mix droplet | 6 nl | 6.6 μl fragmentase |
| | | 3.3 μl fragmentation buffer |
| Merge with fragmentation Mix | 14 nl + 6 nl | |
| droplet | | |
| Incubate 15 mins at 37° C. | | |
| Prepare A-tailing mix | 4 nl | 3 μl end repair enzyme |
| | | 7 μl end repair buffer |
| Merge with A-tailing mix | 20 nl + 4 nl | |
| Incubate 30 mins at 65° C. | | |
| Set to Room temperature | | |
| Prepare adapter ligation mix | 20 nl | 1 μl adapter stock (no dilution) |
| | | 2 μl DNA ligase |
| | | 6 μl ligation buffer |
| | | 1 μl water |
| Merge with adapter ligation mix | 24 nl + 20 nl | |
| Incubate 15 mins at 20° C. | | |
| Incubate 15 mins at 85° C. | | |
| Export droplets (44 nl vol. each) | | |

TABLE 3
Reagents used in Revised KAPA protocol for
Surface 1 (SSRL1 coating) described above

| Workflow | | Reagent Mix/On Chip mixing |
|---|---|---|
| (incubation time/temperature) | Droplet Size | condition |
| Room temp (Peltier off) | | |
| Separate cells into droplet | 7 nl | PBS + 0.2% F68 |
| Make Lysis Mix | 7 nl | 5 μl lysis enzyme |
| | | 50 μl buffer (EDTA−) (TW+) |
| Merge with Lysis droplet | 7 nl + 7 nl | Mixing droplet for 30 seconds |
| Incubate 30 mins at 50° C. | | Mixing droplets during incubation |
| Incubate 20 mins at 85° C. | | No Mix |
| Set to Room temperature | | |
| Prepare fragmentation mix | 6 nl | 6.6 μl fragmentase |
| droplet | | 3.3 μl fragmentation buffer |
| | | 0.2 μl 10% F68 |
| Set temperature to 14° C. | | |
| Merge with fragmentation Mix | 14 nl + 6 nl | Mixing droplet for 30 seconds |
| droplet | | |
| Incubate 40 mins at 37° C. | | Mixing droplets during incubation |
| Set temperature to 14° C. | | |
| Prepare A-tailing mix | 4 nl | 3 μl end repair enzyme |
| | | 7 μl end repair buffer |
| Merge with A-tailing mix | 20 nl + 4 nl | Mixing droplet for 30 seconds |
| Incubate 30 mins at 65° C. | | Mixing droplets during incubation |
| Set to Room temperature | | |
| Prepare adapter ligation mix | 20 nl | 1 μl adapter stock (no dilution) |
| | | 2 μl DNA ligase |
| | | 6 μl ligation buffer |
| | | 1 μl water |
| Merge with adapter ligation | 24 nl + 20 nl | |
| mix | | |
| Incubate 30 mins at 20° C. | | Mixing droplets during incubation |
| Incubate 15 mins at 85° C. | | No Mix |
| Export droplets (44 nl vol. | | |
| each) | | |

TABLE 4
Reagents used in Revised KAPA protocol for
Surface 2 (SSRL2 coating) described above

| Workflow | | Reagent Mix/On Chip mixing |
|---|---|---|
| (incubation time/temperature) | Droplet Size | condition |
| Room temp (Peltier off) | | |
| Separate cells into droplet | 7 nl | PBS + 0.2% F68 |
| Make Lysis Mix | 7 nl | 5 μl lysis enzyme |
| | | 50 μl buffer (EDTA−) (TW0.5+) |
| Merge with Lysis droplet | 7 nl + 7 nl | Mixing droplet for 30 seconds |
| Incubate 30 mins at 50° C. | | Mixing droplets during incubation |
| Incubate 20 mins at 85° C. | | No Mix |
| Set to Room temperature | | |
| Prepare fragmentation mix | 6 nl | 6.6 μl fragmentase |
| droplet | | 3.3 μl fragmentation buffer |
| | | 0.4 μl 5% TET |
| Set temperature to 14° C. | | |
| Merge with fragmentation | 14 nl + 6 nl | Mixing droplet for 30 seconds |
| Mix droplet | | |
| Incubate 40 mins at 37° C. | | Mixing droplets during incubation |
| Set temperature to 14° C. | | |
| Prepare A-tailing mix | 4 nl | 3 μl End repair enzyme |
| | | 7 μl End repair buffer |
| | | 0.4 μl 5% Tritop |
| Merge with A-tailing mix | 20 nl + 4 nl | Mixing droplet for 30 seconds |
| Incubate 30 mins at 65° C. | | Mixing droplets during incubation |
| Set to Room temperature | | |
| Prepare adapter ligation mix | 20 nl | 1 μl adapter stock (no dilution) |
| | | 2 μl DNA ligase |
| | | 6 μl ligation buffer |
| | | 1 μl water |
| Merge with adapter ligation | 24 nl + 20 nl | |
| mix | | |
| Incubate 30 mins at 20° C. | | Mixing droplets during incubation |
| Incubate 15 mins at 85° C. | | No Mix |
| Export droplets (44 nl vol. | | |
| each) | | |

### D. Example 2-B

### Barcoding and Tailing

Each adapter can include a unique barcode and/or a target sequence for amplification. Combinations of barcodes can be used with different samples so that each sample is uniquely labeled. As shown in FIG. 15, the amplification step uses primers 1520 and 1515 comprising adapters 1520a and 1515c, barcodes (also known as indexes) 1520b and 1515b, and 3′ ends 1520c and 1515a that anneal to the insert DNA 1510. The PCR step thus adds index adapter sequences on both ends of the DNA, resulting in product 1530.

A combination of barcodes was used as follows: with one of Barcode 1, 2, or 3 on one side and one of Barcode 4, 5, 6, or 7 on the other side, a total of 12 distinct combinations of barcodes could be provided. As shown in FIG. 16, droplets having either nucleic acid fragments or adapters are staged within corresponding sequestration pens for use in a method of amplifying and/or barcoding nucleic acids. For example, droplets comprising primers with 2 barcodes 1660 and 1670 for one side and droplets comprising three barcodes 1665, 1675, and 1685 for the other side are provided to be merged with sample droplets 1650 within pens 1616 comprised within part of a microfluidic device 1600. Droplets are brought to the pens via channel 1642. PCR amplification may be performed with the PCR thermal cycle: 72° C. for 3 mins, 95° C. for 30 seconds, thermal cycles (95° C. for 10 sec, 55° C. for 30 sec, 72° C. for 30 sec), 72° C. for 5 min. At the end, the samples were held at 10° C.

### E. Example 2-C

### Bead-Based Barcoding

One example of bead-based barcoding during PCR for OEW library preparation is as follows. The first barcode was immobilized on beads (via streptavidin or biotin) to barcode each droplet/pool. The second barcode was provided in solution to barcode each chip/experiment to increase sequencing multiplexing possibilities. Additionally, P5 and P7 primers in solution in the primer mix (suppression PCR) can be added.

Examples of beads for use in barcording include QuantumPlex™M (which consists of five populations of ˜6 μm superparamagnetic microspheres encoded with different intensities of Starfire Red™, Item No. 252, Bangs), FSO6F Flash Red, FSO5F Flash Red, FSO6F Envy Green, FSO7F Dragon Green (Bangs), FH-10062-2 Purple (Spherotech), and 2008 Blue (Phosphorex).

### F. Example 2-D

### Effects of Surfactants on On-Chip Lysis

The effects of surfactants on the cell lysis step was investigated. Lysis, fragmentation and ligation was conducted according to the KAPA protocols as described above in Example 2-A. 0.2-0.5% Tween-20 surfactant was included in the ligation mix.

Then, fragmented and ligated products were amplified off chip as follows. The droplet was brought up to 10 ul in volume with water. 8 ul of AMpure beads were used to clean the reaction. 8.2 ul of water was used to isolate DNA from beads. The isolated DNA were put into 20 μl PCR mix (2×10 μl) (which requires 15 cycles). In the PCR mix, 2 ul Illumina PCR primers (20 uM) and 8 ul of workflow elution were included. After PCR was conducted, the amplified DNA samples were collected and BioAnalyzer was run on them to investigate the quality of the DNA fragments.

The results from BioAnalyzer are as shown in FIG. 21. Each graph shows the size distribution of nucleic acid fragments resulting from the on chip fragmentation of genomic DNA (average sizes: 454 bp, 475 bp, 385 bp, and 900 bp, respectively). When the surfactant (0.2-0.5% Tween-20) was added to the lysis reagent mix, it yielded smaller sized product with more consistency. Further, it was observed that the lysis performance was improved so a lower amount of cell debris was seen in droplets. Further, the droplets showed better movement after lysis.

These results showed that while the protease alone may work for cell lysis, use of surfactants such as a polysorbate (polysorbate 20) improved efficiency and consistency in production of suitable sized products as the surfactant reduced interface interactions (among glass, oil, and surface area of the droplet) and thus decreases the chance of undesired absorption of DNA or enzymes.

### G. Example 2-E

### Amplification of Tagmented and Fragmented Nucleic Acids

Two different amplification methods where nucleic acids are tagmented (Nextera XT) or randomly fragmented and adapted (KAPA Hyper Plus) were modified to be suitable for the micro fluidic chip having a surface according to Surface #1 (SSRL1 coating) with fluorinated oil.

One of the protocols developed to amplify fragments derived from the tagmentation regime is as follows.

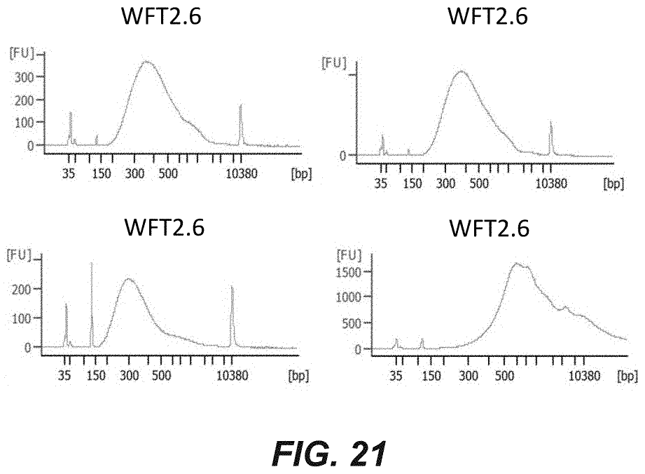

Nextera XT libraries were prepared off chip and quantified off chip to control for template amount. On-chip fragment amplification was conducted with 90 pg template per 20 nl of PCR mix droplet (4.5 ng/μl). Purification of PCR product was performed with 4 μl diluted exported droplet and 8 μl beads (AMPure purification kit) prior to quantification. Then, the eluted amount of 4 μl was aliquoted to 2 μl for fluorescence quantification (Qubit) and 1 μl for Bioanalyzer, and the quantification results were 0.785 ng/μl and 1.06 ng/μl, respectively, corresponding to amplified DNA amounts of 3.032 ng and 4.24 ng, respectively, indicating that on-chip amplification had occurred (FIGS. 23A and 23B).

The on-chip PCR was performed on a droplet originally containing ˜20 cells, which was merged with a ˜50 nl droplet containing PCR mix (Trusight Rapid Capture kit (NLM +i5 +i7)). After 18 cycles, the combined droplets were exported and purified with 1.8× AMpure XP purification beads. The off-chip PCR was performed with a NPM PCR mix and 18 cycles, followed by purification with 1.8× AMpure XP beads. The resulting product was quantified to be 45 ng/μl by fluorescence quantification (Qubit). The high quantity of 45 ng/μl after the additional 18 cycles of PCR performed off chip show the utility of pre-amplification on the chip. Although amplification on chip is not necessary, it increases the amount of sample available for sequencing and, when used to add barcodes, facilitates the pooling of samples and related increases in sample recovery after cleaning off chip. While this example describes 18 cycles of on chip PCR, the advantages that come from increasing the amount of sample available and addition of barcodes (if needed) can be achieved with just a few on chip PCR cycles (e.g., 3 or more cycles, 3 to 10 cycles, 4 to 8 cycles, or 5 to 6 cycles.)

The above amplification method can be applied to provide whole genome analysis of an amplified tagmented library. FIG. 23C shows the sequencing-ready DNA library obtained from the above amplification method. Table 5 shows the analysis of the sequencing results (MiSeq, Illumina) obtained from use of this sequencing library.

TABLE 5

| | Reads | Percentage |
|---|---|---|
| Total PF | 24,044,703 | 100.00% |
| Paired | 24,034,668 | 99.96% |
| Read 1 | 12,017,334 | 49.98% |
| Read 2 | 12,017,334 | 49.98% |
| Aligned | 22,884,397 | 95.17% |
| Properly Paired | 22,496,832 | 98.31% |
| Singletons | 72,812 | 0.32% |
| Secondary Alignments | 10035 | 0.04% |
| Supplementary Alignments | 0 | 0.00% |
| Duplicates | 21,974,053 | 96.02% |

One example of the protocols developed to amplify fragments derived from the fragmentation/ligation regime is as follows.

A purified library from the KAPA workflow was prepared off-chip with fragments up to 400 bp in size, and droplets were prepared to include 10 pg DNA per 50 nl droplet. (1) An amplification mixture (KAPA PCR mix) and (2) the same amplification mix further combined with 1 mg/ml BSA and 0.2% Pluronic F68 surfactant was prepared and mixed with the DNA droplets off-chip, and the combined droplet was introduced into the microfluidic chip.

On-chip PCR was performed for 15 cycles, and the combined droplets containing the amplified DNA were exported. 50 ul of oil with the droplets were mixed with 100ul DNA column binding buffer, and the mixture was vortexed for 15 seconds and then spun in a centrifuge for 1 min. The aqueous phase of the mixture was added to the separation column, and DNA was isolated and quantified, the result of which is shown in Table 6. When the amplification mix did not contain surfactants, on-chip PCR showed no detectable yield. In contrast, when surfactants were included in the amplification mix, the yields increased significantly.

TABLE 6
Effect of addition of BSA + F68 on PCR yield

| | Experimental Condition | | | |
|---|---|---|---|---|
| | | | Number of | Yield |
| Pen # | PCR mix | Additional Reagents | Cycles | (ng) |
| 1 | KAPA | 1 mg/ml BSA + 0.2% F68 | 15 | 3.09 |
| 2 | KAPA | 1 mg/ml BSA + 0.2% F68 | 15 | 1.24 |
| 3 | KAPA | 1 mg/ml BSA + 0.2% F68 | 15 | 3.72 |
| 4 | KAPA | 1 mg/ml BSA + 0.2% F68 | 15 | 3.00 |
| 5 | KAPA | 1 mg/ml BSA + 0.2% F68 | 15 | 5.73 |
| 6 | KAPA | 1 mg/ml BSA + 0.2% F68 | 15 | 2.14 |
| 7 | KAPA | 1 mg/ml BSA + 0.2% F68 | 15 | 2.89 |
| 8 | KAPA | 1 mg/ml BSA + 0.2% F68 | 15 | 1.26 |
| 9 | KAPA | 1 mg/ml BSA + 0.2% F68 | 15 | 1.84 |
| 10 | KAPA | 1 mg/ml BSA + 0.2% F68 | 15 | 2.71 |
| 11 | KAPA | N/A | 15 | 0.00 |
| 12 | KAPA | N/A | 15 | 0.00 |
| 13 | KAPA | N/A | 15 | 0.00 |
| 14 | KAPA | N/A | 15 | 0.00 |
| 15 | KAPA | N/A | 15 | 0.00 |
| 16 | KAPA | N/A | 15 | 0.00 |

Further, the effect of Tween-20 surfactant on on-chip PCR yield was determined with the SSRL2 surface. PCR products were produced and quantified as described above.

TABLE 7
Effect of addition of Tween-20 on PCR
yield on the chip with Surface #2

| | Experimental Condition | | | |
|---|---|---|---|---|
| | | | Number of | Yield |
| Pen # | PCR mix | Additional Reagents | Cycles | (ng) |
| 1 | KAPA | 0.2% Tween-20 | 15 | 4.05 |
| 3 | KAPA | 0.2% Tween-20 | 15 | 5.88 |
| 5 | KAPA | 0.2% Tween-20 | 15 | 3.36 |
| 6 | KAPA | 0.2% Tween-20 | 15 | 2.50 |
| 23 | KAPA | 0.2% Tween-20 | 15 | 4.26 |
| 25 | KAPA | 0.2% Tween-20 | 15 | 3.39 |
| 26 | KAPA | 0.2% Tween-20 | 15 | 3.54 |
| 28 | KAPA | 0.2% Tween-20 | 15 | 2.89 |
| | | Off-chip Control | | 2.73 |
| | | Off-chip Control | | 2.89 |

As shown above in Table 7, as compared to off-chip controls, the yields were higher when a surfactant (Tween-20) was used. This result also shows that on-chip products had slightly higher average yield than off-chip controls. Using Pluronic F68 as the surfactant was also effective (not shown). The surfactant is thought to decrease molecular interactions at interfaces (cover surface, droplet-oil interface, substrate surface) and prevent high failure rate of on-chip PCR.

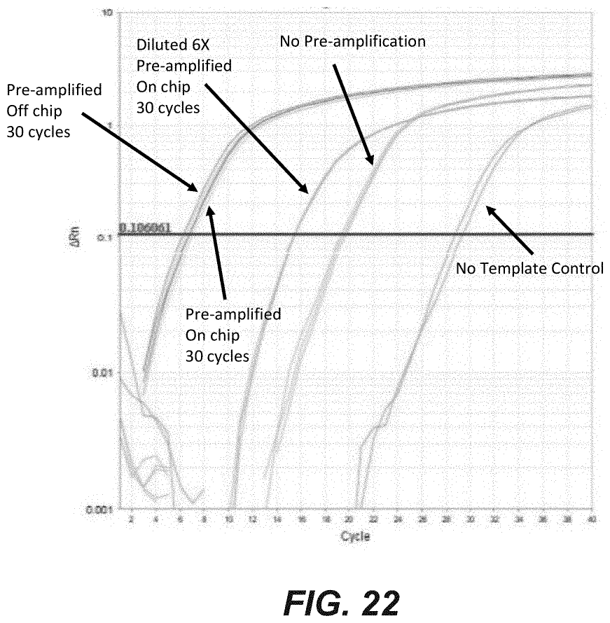

FIGS. 24A-27 show the analysis metrics comparing sequencing libraries processed on chip using the Nextera workflow and the KAPA workflow. The two methods provide generally equivalent results.

FIGS. 24A and 24B show fluorometric traces of fluorescently stained products obtained from the Nextera and Kapa workflows, respectively. Marker peaks are visible at approximately 35 and 10380 bp. At right in each panel, a grayscale heat map is shown corresponding to the densitometric trace, with the top band corresponding to the ˜10380 bp marker. The vertical axis is in arbitrary fluorescence units. The results show that a range of insert sizes were produced, with peaks near 700 bp (Nextera) and 400 bp (Kapa).

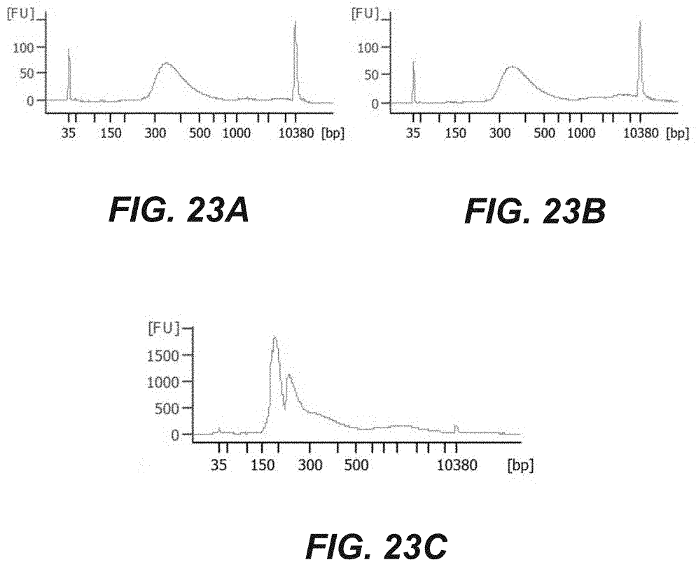

FIGS. 25A and 25B show histograms of insert size (gray) for reads obtained from sequencing libraries from the Nextera and Kapa workflows, respectively (see count values in left vertical axis). The dashed curves show the cumulative fraction of reads greater than the insert size on the horizontal axis (see right vertical axis). The horizontal axis is in base pairs. In both cases, the peak insert size based on read length was near 200 bp.

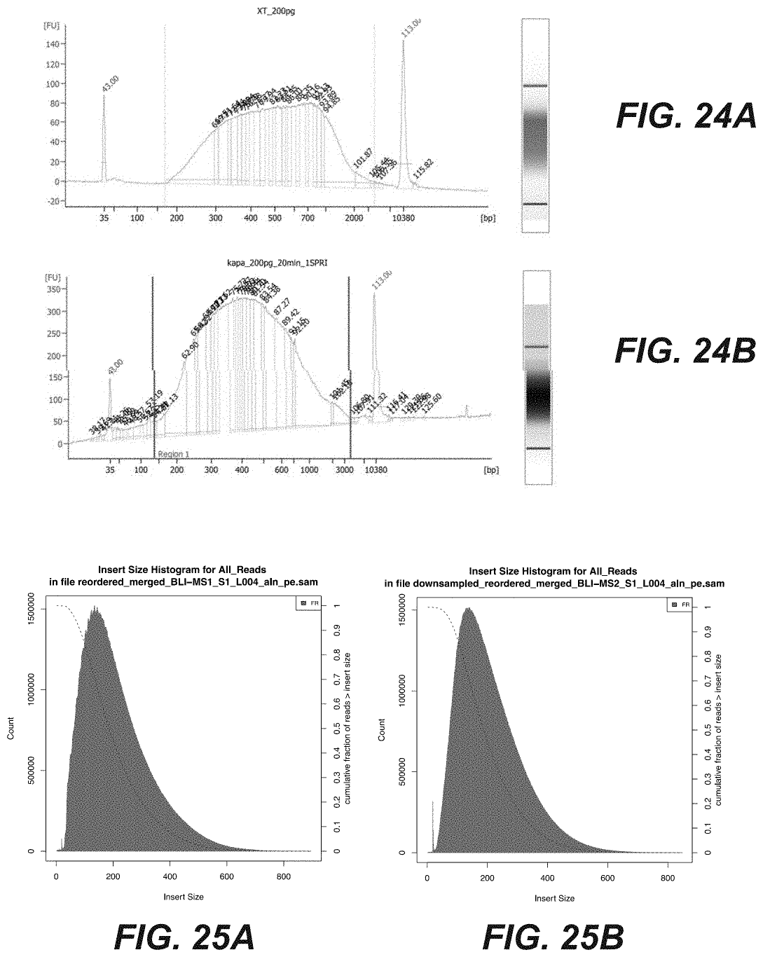

FIGS. 26A and 26B show mean quality by cycle for reads obtained from sequencing libraries from the Nextera and Kapa workflows, respectively. Mean quality values were above 30 across all cycles tested.

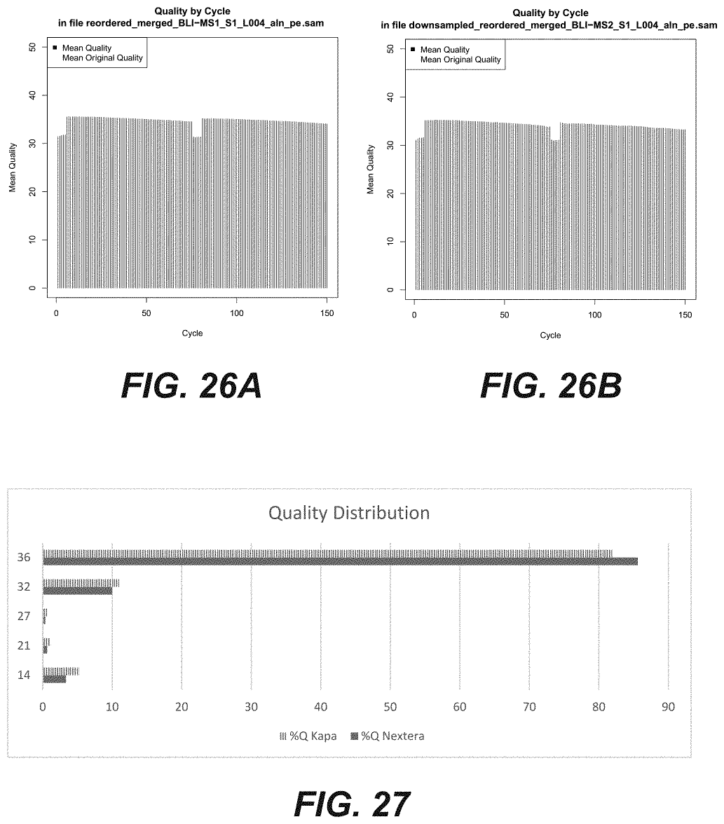

FIG. 27 shows quality distribution for reads obtained from sequencing libraries from the Nextera and Kapa workflows. For both libraries, quality was >30 for >80% of reads.

### H. Example 2-F

### On-Chip Quantification

Methods for quantifying the amplified nucleic acids on chip were developed.

A DNA mix was prepared with a dsDNA ladder (Life Technologies 1kb plus ladder) in a reverse transcription buffer containing 0.2% 2, 4, 7, 9-Tetramethyl-5-decyne-4, 7-diol-ethoxylate (TET). DNA aliquots of 0 ng/μl, 1 ng/μl, 5 ng/μl, 10 ng/μl, and 30 ng/μl were loaded in the pens and were washed twice with water. A dsDNA dye (1/100 Quant-iT™ High Sensitive Assay, Invitrogen Cat# Q33120) in RT Buffer with 0.2% TET was loaded into the pens and the DNA aliquots were incubated for 3 minutes at room temperature.

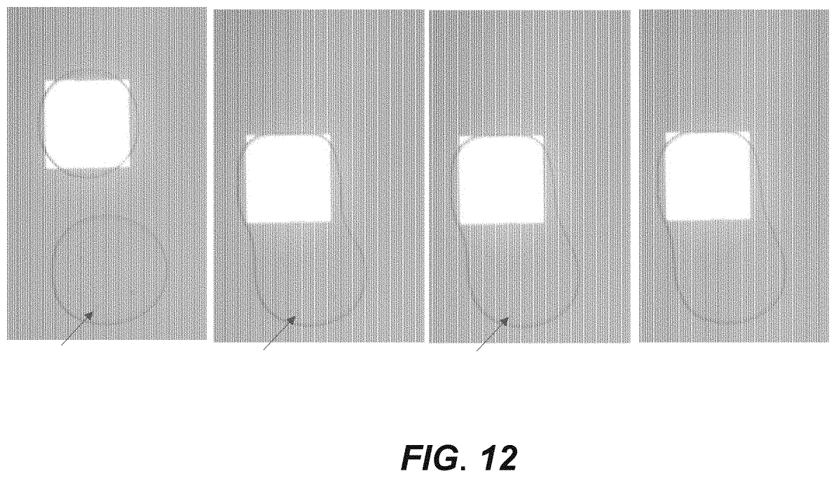

FIG. 17 shows on-chip quantification of an amount of nucleic acid in a droplet. For example, given the concentration of DNA mix being 1 ng/μl, a 10 nl droplet contains 10 pg of DNA therein.

### I. Example 2-G

### Sequencing Results

An example of results of a cDNA QC of a library prepared using the electrowetting based lysis and barcoding is shown on FIG. 30. That sample, derived from 60 cells, was sequenced. The results of the number of unique genes identified in the sequencing run is shown in the graph of FIG. 31 and was compared to the number of genes identified for single cell sequencing runs (1-12).

### J. Example 3

### Nucleic Acid Amplification

Lysis. Generally, cell lysis conditions will depend on whether DNA or RNA is desired. If RNA is desired, lysis may be performed at room temperature or at a temperature less than 50° C., if using a proteinase K lysis buffer. The lysis reaction may be stopped by addition of stop lysis reagents as is known in the art, which may obviate the need for a high temperature inactivation of proteinase K. Alternatively, other lysis buffers may be used that do not require heating or high temperature inactivation. Lysis procedures for obtaining DNA are discussed above in detail.

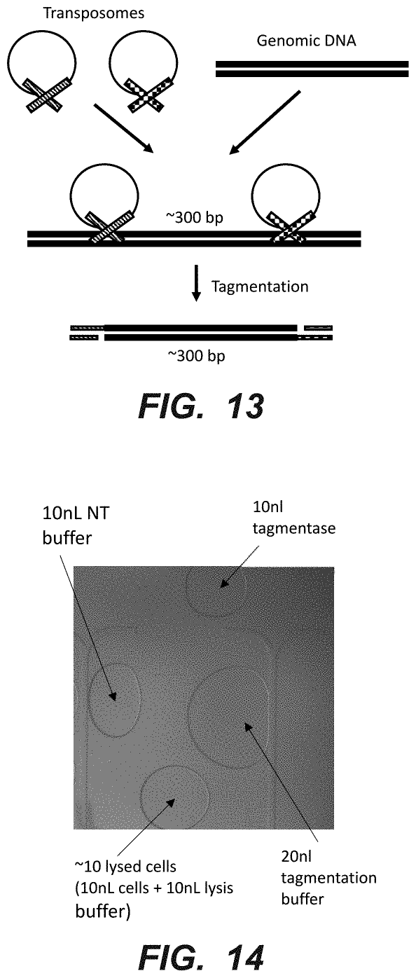

On-Chip qPCR. The ability to quantify PCR reagents and DNA samples within the microfluidic environment permitted quantitative polymerase chain reaction (qPCR) experiments to be successfully performed, as shown in FIGS. 18-20.

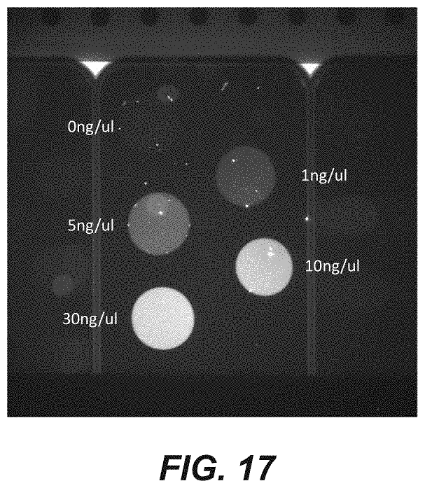

FIG. 18 shows fluorescence images before and after on-chip amplification (qPCR) of nucleic acid in droplets located in a microfluidic device. The results from on-chip qPCR experiment (FIG. 19) shows the fluorescence level of a droplet containing nucleic acids as a function of on-chip amplification. With additional temperature control and correction (see below Example 4), the temperature of a microfluidic device was properly regulated (FIG. 20), resulting in no overshooting/undershooting and increased yields from PCR increased.

Further, FIG. 22 shows off chip qPCR results obtained for nucleic acid samples that were (i) previously amplified on chip for 30 cycles or (ii) previously amplified on chip for 30 cycles, then diluted six fold, according to another embodiment of the disclosure. The qPCR samples are compared to various controls, including a nucleic acid sample that was previously amplified off chip for 30 cycles, a nucleic acid sample that was exported from a microfluidic chip without previous amplification, and a no template control. FIG. 22 shows that 30 cycles of on chip amplification produce approximately the same amount of PCR product as 30 cycles of off chip amplification.

Amplification introducing barcodes. FIG. 13 shows protocols developed to introduce barcodes to nucleic acid fragments, adapted to be modified to contain the barcodes, and the resulting amplification via qPCR which demonstrated the ability to amplify via a PCR under thermal cycling conditions.

Amplification on beads to introduce barcodes. protocols developed to introduce barcodes and/or primers by amplification on beads were described above (See FIGS. 15 and 16).

Purification. Methods of purifying the amplified nucleic acids can be performed as described above.

### K. Example 3-A

### On-Chip Reverse Transcription

On-chip reverse transcription was performed as follows: 20 μl of 2× reaction mixture was prepared including 8 ul 5× RT buffer, 3 ul poly(d1) primer, 3 ul template switching oligonucleotide (TSO), 2 ul dNTPs, 1.8 ul reverse transcription enzyme, 1.8 ul 100 ml MgCl₂, 0.4 ul TET (surfactant). This reaction mixture was combined on chip with an equal volume sized droplet containing 500 pg of OKT3 cDNA, 0.2% RNAseOUT™, and 0.2% TET. At this concentration, a 20 nl droplet is estimated to contain 10 pg of total RNA. Heat cycle was performed at 55° C. for 2 min (Dt annealing) and then 42° C. for 1 hour. Droplets were moved out of pen and 11 droplets were exported, 377 nL total. To visualize exported droplets, 2 ul of water containing phenol red dye was added to tube and spun down in centrifuge. The droplet turns bright red as the dye was mixed with the reverse transcription mix. 1 ul of droplet was added to a first cDNA amplification PCR product. 1.3 ul was added to a second cDNA amplification PCR product. 20 cycles of SMART-sequence amplification were performed.

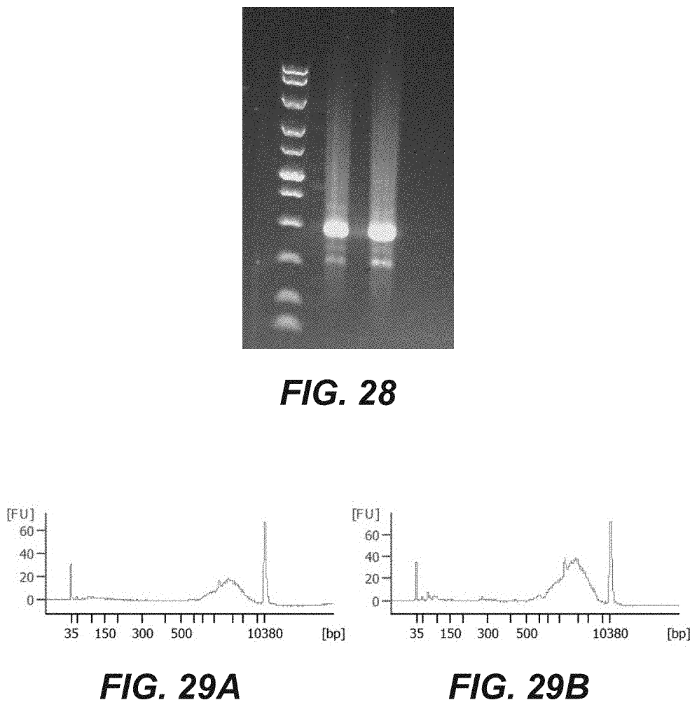

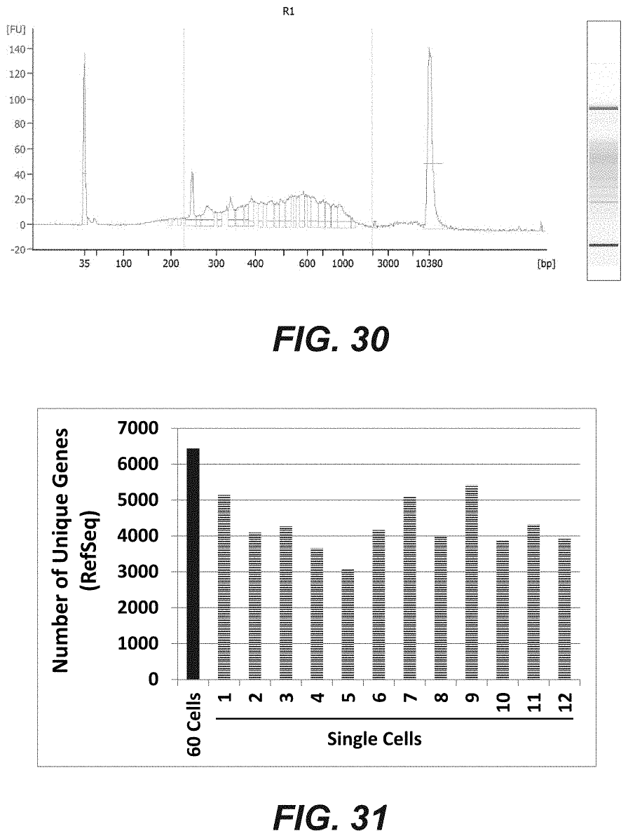

The amplified product was recovered by Quibit. The yield from the first amplification was 1.53 ng of cDNA, and the yield from the second amplification was 3.13 ng of cDNA. To visualize the cDNA quality the first test, PCR was performed from each amplification product for the presence of mouse Kappa chain. As shown in FIG. 28, both products showed strong bands in the gel electrophoresis, which confirms the strong presence of cDNA. In addition, the samples were analyzed using an Agilent Bioanalyzer (Agilent, Böblingen, DE) after speeding vacuuming the samples down to 2 ul and loading 1 ul of each sample. The corresponding results from both products can be seen from FIGS. 29A and 29B, which confirms the strong presence of cDNA and their respective size.

### L. Example 4

### Temperature Control

This example concerns improvements in temperature control for a microfluidic device undergoing temperature shifts driven by a Peltier thermoelectric device. The Peltier used in this experiment was DigiKey part number 102-1674-ND (see the www.digikey.com website at /product-detail/en/cui-inc/CP60333/102-1674-ND/1747366 for details). The specs indicate a maximum power draw of 50W to 90W.

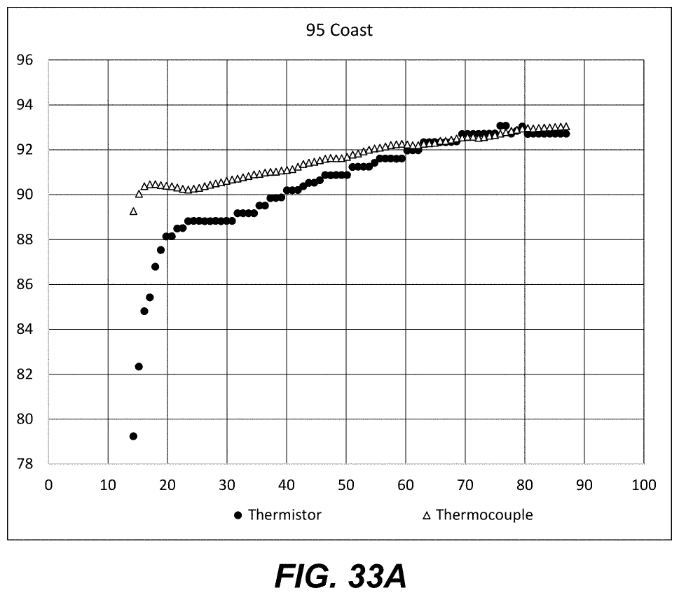

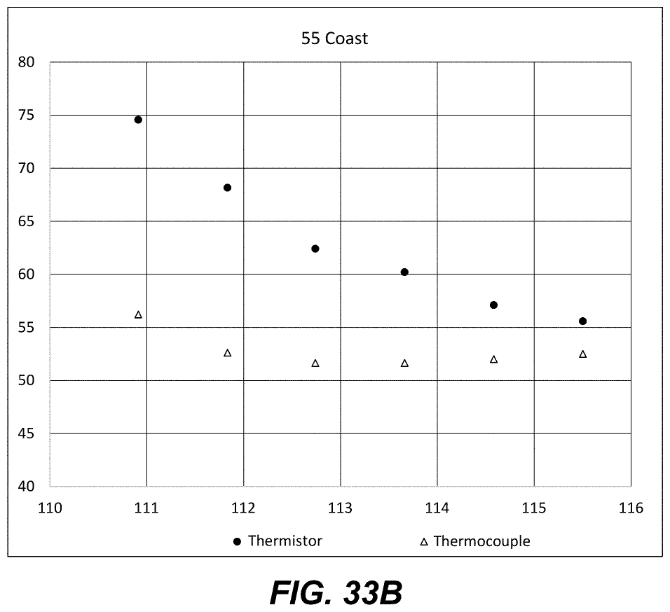

Initial experiments used a PID control loop algorithm to determine the power output value for the Peltier based on target temperature and current temperature as measured by a thermistor. It was observed that the actual temperature of the microfluidic device could overshoot the target temperature both during heating and cooling (not shown), which could compromise performance, e.g., both at high-temperature steps such as denaturation steps (in that excessive heat could reduce polymerase activity or increase degradation of the hydrophobic layer) and lower temperature steps such as primer annealing (in that lower temperature could promote mispriming and loss of specificity). See FIGS. 32A and 32B. These results were generated using a system comprising “calibration chip” in place of a microfluidic device, in which, in addition to the thermistor typically used for temperature determination, a thermocouple was present in the calibration chip. The temperature registered by the thermocouple on the calibration chip was higher than the thermistor temperature during the heating step of FIG. 33A (from ambient temperature toward 95° C.) and lower during the cooling step of FIG. 33B (from 95° C. toward 55° C.), consistent with the overshooting problem noted above.

To address temperature overshooting, the three-phase temperature control procedure described in the Systems section above was developed, i.e., comprising setting the power output to a first value if the difference between the target temperature and the thermistor-measured temperature is larger than N; setting the power output to a second value lower than the first value if the difference between the target temperature and the thermistor-measured temperature is equal to or smaller than N and larger than M; and determining the power output by a proportionate-integral-derivative (PID) loop controller with the thermistor-measured temperature as an input if the difference between the target temperature and the thermistor-measured temperature is smaller than or equal to M, where M may be in the range of 7° C. to 13° C. or 5° C. to 15° C. and N may be in the range of 2° C. to 4° C. or 1° C. to 5° C. The second value was determined from calibration data correlating target temperatures to power output values for the Peltier. Calibration data for a representative system are shown below. The calibration data were determined by equilibrating the system at each progressively higher power output value and measuring the resulting temperature from the thermocouple of a calibration chip, and are intended for use in heating steps. A corresponding data set for cooling steps was also generated by starting at a high (i.e., hot) power output value and progressively reducing it (not shown). Because individual systems may differ slightly in details such as efficiency of heat transfer between a microfluidic device and the Peltier, it can be advisable to generate calibration data for a particular system. Power output values corresponding to temperatures between those shown in Table 8 can be determined using linear interpolation or other known curve-fitting methods.

TABLE 8
Exemplary calibration data for Peltier power output
values and thermocouple (on-chip) temperatures

| Power output value (%) | Thermocouple temperature (° C.) |
|---|---|
| −100 | −9.8 |
| −76 | −0.9 |
| −52 | 7.8 |
| −28 | 15.9 |
| −4 | 23.5 |
| 20 | 46.5 |
| 28 | 55.1 |
| 36 | 63.0 |
| 44 | 70.8 |
| 52 | 78.1 |
| 60 | 85.2 |
| 68 | 93.4 |
| 76 | 100.2 |
| 84 | 106.2 |
| 92 | 112.8 |
| 100 | 118.8 |

Results obtained in a heating step toward 95° C. and a cooling step toward 55° C. using the three-phase temperature control procedure are shown in FIGS. 33A and 33B, wherein M was 3° C. and N was 10° C. It can be seen that the differential between the thermistor and the thermocouple temperatures was smaller decreased with time as the temperature approached the target.

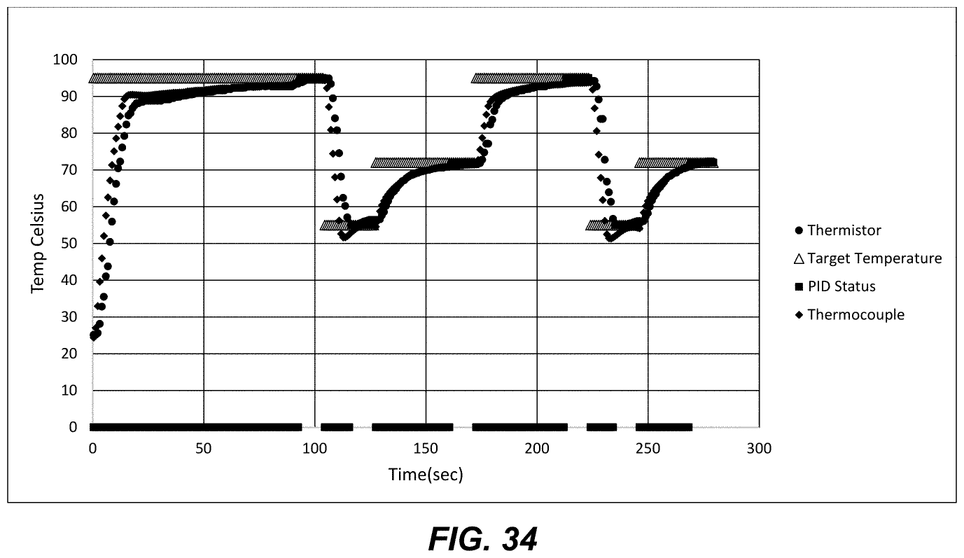

Results from a more complex series of temperature shifts are shown in FIG. 34. The horizontal segments of overlaid triangles represent the target temperature, and it can be seen that essentially no overshooting occurred during heating steps and only minimal overshooting occurred during cooling steps according to the thermocouple data. Additionally, the thermistor and thermocouple data tracked together fairly closely. The PID status symbols indicate when the procedure used (PID status equal to target temperature) or did not use (PID status equals 0) the PID control loop algorithm.

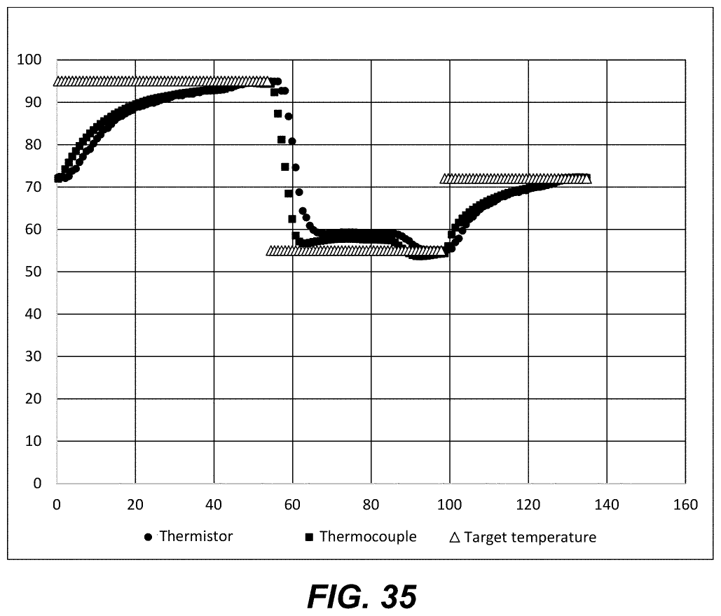

Data from a further experiment using a similar temperature control procedure wherein M was 3° C. and N was 10° C. are shown in FIG. 35.

It is expected that similar results would be obtained within the ranges of 10° C. plus or minus 5° C. for N and 3° C. plus or minus 2° C. for M.

### VII. NUMBERED EMBODIMENTS

The embodiments disclosed herein include the following:
1. A microfluidic device having an electrowetting configuration, the microfluidic device comprising:

a droplet actuation surface, a substrate having a dielectric layer and a first electrode configured to be connected to an AC voltage source, and a second electrode configured to be connected to the AC voltage source,

wherein the dielectric layer is electrically coupled to the first electrode,

wherein the droplet actuation surface comprises a hydrophobic layer covalently bonded to the dielectric layer, and

wherein, when the first electrode and the second electrode are connected to opposing terminals of the AC voltage source, the substrate is capable of applying an electrowetting force to aqueous droplets in contact with the droplet actuating surface.
2. The micro fluidic device of embodiment 1, wherein the microfluidic device further comprises a cover and at least one spacing element,

wherein the substrate and the cover are substantially parallel to one another and joined together by the spacing element so as to define an enclosure configured to hold a liquid,

wherein the droplet actuation surface defines, in part, the enclosure, and

wherein the cover comprises the second electrode and a surface of the second electrode defines, in part, the enclosure.
3. The micro fluidic device of embodiment 1, wherein the microfluidic device has a single-sided electrowetting configuration.
4. The microfluidic device of embodiment 3, wherein the second electrode is a mesh electrode comprised by the substrate.
5. The microfluidic device of any one of embodiments 1 to 4, wherein the microfluidic device has an opto-electrowetting (OEW) configuration.
6. The microfluidic device of any one of embodiments 1 to 4, wherein the microfluidic device has an electrowetting on dielectric (EWOD) configuration.
7. The microfluidic device of any one of embodiments 1 to 6, wherein the microfluidic device comprises a first section having the electrowetting configuration and a second section having a dielectrophoresis (DEP) configuration.
8. The microfluidic device of any one of embodiments 1 to 7, wherein the hydrophobic layer comprises self-associating molecules covalently bonded to a surface of the dielectric layer, to thereby form a densely packed hydrophobic monolayer thereon.
9. The microfluidic device of any one of embodiments 1 to 8, wherein the hydrophobic layer is a monolayer formed from molecules each comprising a surface modifying ligand and a linking group that links the surface modifying ligand to the surface, wherein the droplet actuation surface has a structure of Formula II:

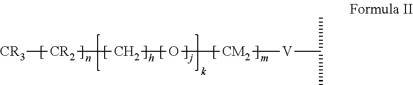

wherein [symbol] is a surface of the dielectric layer;

V is —P(O)(OY)W— or —Si(OZ)₂W—;

W is —O—, —S—, or —NH— and connects to the surface;

Z is a bond to an adjacent silicon atom attached to the surface or is a bond to the surface;

Y is a bond to an adjacent phosphorus atom attached to the surface or is a bond to the surface;

R is hydrogen or fluorine;

M is hydrogen or fluorine;

h is 0 or an integer of 2 or 3, j is 1, and k is 0 or 1;

m is 0 or an integer of 1 to 20;

n is 0 or an integer of 1 to 20;

the sum of (n+[(h+j)·k]+m) is an integer of 11 to 25;

when k is 1, then m is at least 2 and M is hydrogen; and

when k is 0 and R is fluorine, then m is at least 2 and M is hydrogen.
10. The microfluidic device of embodiment 9, wherein V is —Si(OZ)₂W—.
11. The microfluidic device of embodiment 9, wherein V is —P(O)(OY)W—.
12. The microfluidic device of any one of embodiments 9 to 11, wherein n is an integer of 1 to 20, and wherein R is hydrogen.
13. The micro fluidic device of embodiment 12, wherein m is an integer of 1 to 20, and wherein M is hydrogen.
14. The microfluidic device of embodiment 13, wherein m is 2.
15. The microfluidic device of any one of embodiments 9 to 11, wherein n is an integer of 1 to 20, and wherein R is fluorine.
16. The microfluidic device of embodiment 15, wherein m is an integer of 1 to 20, and wherein M is hydrogen.
17. The microfluidic device of embodiment 16, wherein m is 2.
18. The microfluidic device of any one of embodiments 9 to 17, wherein k is 1.
19. The microfluidic device of any one of embodiments 9 to 17, wherein k is 0.
20. The microfluidic device of any one of embodiments 9 to 19, wherein the sum of (n+[(h+j)·k]+m) is an integer of 13 to 19.
21. The microfluidic device of any one of embodiments 1 to 20, wherein the hydrophobic layer of the droplet actuation surface has a thickness of less than 5 nanometers.
22. The microfluidic device of any one of embodiments 1 to 21, wherein the dielectric layer comprises a first layer of dielectric material comprising an oxide.
23. The micro fluidic device of embodiment 22, wherein the oxide is a metal oxide.
24. The micro fluidic device of embodiment 23, wherein the metal oxide is aluminum oxide.
25. The microfluidic device of any one of embodiments 22 to 24, wherein the first layer of dielectric material is formed by atomic layer deposition.
26. The microfluidic device of any one of embodiments 22 to 25, wherein the dielectric layer further comprises a second layer of dielectric material, and wherein the hydrophobic layer is covalently bonded to the first layer of dielectric material.
27. The microfluidic device of embodiment 26, wherein the second layer of dielectric material comprises an oxide or a nitride.
28. The microfluidic device of embodiment 27, wherein the second layer of dielectric material comprises silicon dioxide or silicon nitride.
29. The microfluidic device of any one of embodiments 26 to 28, wherein the second layer of dielectric material is formed by plasma enhanced chemical vapor deposition (PECVD).
30. The microfluidic device of any one of embodiments 22 to 29, wherein the first layer of dielectric material comprises first and second sublayers of dielectric materials, wherein the first sublayer is covalently bonded to the hydrophobic layer.
31. The microfluidic device of embodiment 30, wherein the first sublayer of dielectric material comprises silicon oxide.
32. The micro fluidic device of embodiment 30 or 31, wherein the second sublayer of dielectric material comprises aluminum oxide.
33. The microfluidic device of any one of embodiments 30 to 32, wherein the first sublayer of dielectric material is deposited by ALD and/or wherein the second sublayer of dielectric material is deposited by ALD.
34. The microfluidic device of any one of embodiments 30 to 33, wherein the first sublayer of dielectric material has a thickness of about 2 nm to about 10 nm.
35. The microfluidic device of any one of embodiments 22 to 34, wherein the first layer of dielectric material has a thickness of about 10 nm to about 20 nm.
36. The microfluidic device of any one of embodiments 1 to 35, wherein the dielectric layer has a thickness of at least about 40 nanometers.
37. The microfluidic device of embodiment 36, wherein the dielectric layer has a thickness of about 40 nanometers to about 120 nanometers.
38. The microfluidic device of any one of embodiments 1 to 37, wherein the substrate of the microfluidic device further comprises a photoresponsive layer having a first side that contacts the dielectric layer and a second side that contacts the first electrode.
39. The microfluidic device of embodiment 38, wherein the photoresponsive layer comprises a layer of hydrogenated amorphous silicon (a-Si:H).
40. The microfluidic device of embodiment 39, wherein the photoresponsive layer further comprises an array of transistors, and wherein the layer of hydrogenated amorphous silicon has a first side the forms the first side of the photoresponsive layer and a second side that contacts the array of transistors.
41. The microfluidic device of embodiment 40, wherein the transistors of the array are phototransistors.
42. The microfluidic device of embodiment 40, wherein the transistors are controllably connectable to the first electrode via a phototransistor switch.
43. The microfluidic device of any one of embodiments 38 to 42, wherein the photoresponsive layer has a thickness of at least 900 nanometers.
44. The microfluidic device of embodiment 43, wherein the layer of hydrogenated amorphous silicon has a thickness of about 900 to 1100 nanometers.
45. The microfluidic device of any one of embodiments 1 to 44, wherein the first electrode comprises a layer of indium-tin-oxide (ITO).
46. The microfluidic device of any one of embodiments 1 to 45, wherein the first electrode comprises a layer of electrically conductive silicon.
47. The microfluidic device of any one of embodiments 1 to 46, wherein the microfluidic device comprises a plurality of first electrodes, each first electrode configured to be connected to one or more AC voltage source(s).
48. The microfluidic device of embodiment 47, wherein each first electrode of the plurality is connectable to one of the one or more AC voltage source(s) via a transistor switch.
49. The microfluidic device of any one of embodiments 2 to 48, wherein the cover has an inward-facing surface that defines, in part, the enclosure, the inward-facing surface of the cover having an inner layer and a hydrophobic layer, wherein the hydrophobic layer of the cover comprises self-associating molecules covalently bonded to a surface of the inner layer of the cover, to thereby form a densely packed hydrophobic monolayer thereon.
50. The microfluidic device of embodiment 49, wherein the self-associating molecules of the hydrophobic monolayer of the cover each comprise a surface modifying ligand and a linking group that links the surface modifying ligand to the surface of the inner layer of the cover, wherein the inward-facing surface of the cover has a structure of Formula II:

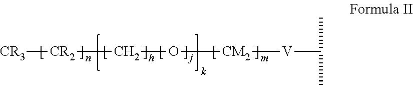

wherein [symbol] is a surface of the dielectric layer;

V is —P(O)(OY)W— or —Si(OZ)₂W—;

W is —O—, —S—, or —NH— and connects to the surface;

Z is a bond to an adjacent silicon atom attached to the surface or is a bond to the surface;

Y is a bond to an adjacent phosphorus atom attached to the surface or is a bond to the surface;

R is hydrogen or fluorine;

M is hydrogen or fluorine;

h is 0 or an integer of 2 or 3; j is 1; and k is 0 or 1;

m is 0 or an integer of 1 to 20;

n is 0 or an integer of 1 to 20;

the sum of (n+[(h+j)·k]+m) is an integer of 11 to 25;

when k is 1, then m is at least 2 and M is hydrogen; and

when k is 0 and R is fluorine, then m is at least 2 and M is hydrogen.
51. The micro fluidic device of embodiment 50, wherein the self-associating molecules of the hydrophobic monolayer of the cover are the same as the self-associating molecules of the hydrophobic monolayer of the droplet actuating surface of the substrate.
52. The microfluidic device of any one of embodiments 49 to 51, wherein the hydrophobic layer of the inward-facing surface of the cover has a thickness of less than 5 nanometers.
53. The microfluidic device of any one of embodiments 49 to 53, wherein the inner layer of the cover is an inner dielectric layer.
54. The microfluidic device of embodiment 53, wherein the cover further comprises a photoresponsive layer.
55. The microfluidic device of any one of embodiments 49 to 54, wherein the cover comprises a plurality of second electrodes, each electrode configured to be connected to one or more AC voltage source(s).
56. The microfluidic device of any one of embodiments 2 to 55, wherein the at least one spacing element comprises a silicon-based organic polymer.
57. The microfluidic device of embodiment 56, wherein the silicon-based organic polymer is selected from the group consisting of polydimethylsiloxane (PDMS) and photo-patternable silicone (PPS).
58. The microfluidic device of any one of embodiments 2 to 57, wherein the at least one spacing element comprises SU-8.
59. The microfluidic device of any one of embodiments 2 to 58, wherein the at least one spacing element has a thickness of at least 30 microns.
60. The microfluidic device of any one of embodiments 2 to 59, wherein the at least one spacing element defines one or more microchannels within the enclosure.
61. The microfluidic device of embodiment 60, wherein the at least one spacing element further defines a plurality of chambers and/or sequestration pens within the enclosure.
62. The microfluidic device of any one of embodiments 1 to 61, wherein the dielectric layer has an impedance of about 50 kOhms to about 150 kOhms.
63. A method of processing biological cells in a microfluidic device having an electrowetting configuration, the method comprising:

disposing a first droplet of aqueous medium upon a droplet actuation surface of the microfluidic device, wherein the first droplet comprises one or more biological cells, and wherein the micro fluidic device further comprises
a substrate having a dielectric layer and a first electrode configured to be connected to an AC voltage source, and
a second electrode configured to be connected to the AC voltage source,
wherein the dielectric layer is electrically coupled to the first electrode,
wherein the droplet actuation surface comprises a hydrophobic layer covalently bonded to the dielectric layer, and
wherein, when the first electrode and the second electrode are connected to opposing terminals of the AC voltage source, the substrate is capable of applying an electrowetting force to aqueous droplets in contact with the droplet actuating surface;

merging the first droplet with a second droplet of aqueous medium to form a first combined droplet, wherein the second droplet comprises a cell lysing agent;

incubating the first combined droplet upon the droplet actuation surface for a first period of time sufficient to lyse the one or more biological cells; and

inactivating the cell lysing agent.
64. The method of embodiment 63, wherein the microfluidic device is a microfluidic device of any one of embodiments 1 to 62.
65. The method of embodiment 63 or 64, wherein the hydrophobic layer comprises self-associating molecules covalently bonded to a surface of the dielectric layer, to thereby form a densely packed hydrophobic monolayer thereon.
66. The method of any one of embodiments 63 to 65, wherein the dielectric layer comprises a first layer of dielectric material comprising aluminum oxide.
67. The method of embodiment 66, wherein the first layer of dielectric material is formed by atomic layer deposition (ALD).
68. The method of embodiment 66 or 67, wherein the dielectric layer further comprises a second layer of dielectric material, wherein the hydrophobic layer is covalently bonded to the first layer of dielectric material, and wherein the second layer of dielectric material comprises silicon dioxide or silicon nitride deposited by PECVD.
69. The method of any one of embodiments 66 to 68, wherein the first layer of dielectric material comprises first and second sublayers of dielectric materials, wherein the first sublayer comprises silicon oxide and is covalently bonded to the hydrophobic layer, wherein the second sublayer of dielectric material comprises aluminum oxide, and wherein the first sublayer of dielectric material is deposited by ALD and/or wherein the second sublayer of dielectric material is deposited by ALD.
70. The method of any one of embodiments 66 to 69, wherein the dielectric layer has an impedance of about 50 kOhms to about 150 kOhms.
71. A method of processing biological cells in a microfluidic device having an electrowetting configuration, the method comprising:

disposing a first droplet of aqueous medium upon a droplet actuation surface of the microfluidic device, wherein the first droplet comprises one or more biological cells, and wherein the micro fluidic device further comprises
a substrate having a dielectric layer and a first electrode configured to be connected to an AC voltage source, and
a second electrode configured to be connected to the AC voltage source,
wherein the dielectric layer is electrically coupled to the first electrode,
wherein the droplet actuation surface comprises a hydrophobic layer covalently bonded to the dielectric layer,
wherein the hydrophobic layer is a monolayer formed from molecules each comprising a surface modifying ligand and a linking group that links the surface modifying ligand to the surface, each molecule having a structure of:

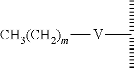

wherein:
[symbol] is the surface;
V is a linker;
m is an integer of 9 or greater; and
wherein, when the first electrode and the second electrode are connected to opposing terminals of the AC voltage source, the substrate is capable of applying an electrowetting force to aqueous droplets in contact with the droplet actuating surface;

merging the first droplet with a second droplet of aqueous medium to form a first combined droplet, wherein the second droplet comprises a cell lysing agent;

incubating the first combined droplet upon the droplet actuation surface for a first period of time sufficient to lyse the one or more biological cells; and

inactivating the cell lysing agent.
72, The method of embodiment 71, wherein the microfluidic device is a microfluidic device of any one of embodiments 1 to 62.
73. The method of embodiment 71 or 72, wherein V is —Si(OZ)₂W—; W is —O— and connects to the surface; and Z is a bond to an adjacent silicon atom attached to the surface or is a bond to the surface.
74, The method of embodiment 71 or 72, wherein V is —P(O)(OY)W—; W is —O— and connects to the surface; and Y is a bond to an adjacent phosphorus atom attached to the surface or is a bond to the surface.
75. The method of any one of embodiments 71 to 74, wherein m is an integer of 15 or greater.
76. The method of any one of embodiments 71 to 75, wherein m ranges from 9 to 25, 12 to 25, 12 to 21, 15 to 25, 15 to 21, 15 to 19, or 16 to 18.
77. The method of embodiment 76, wherein m is 15, 17 or 19. 78, The method of embodiment 76, wherein m is 17.
79. The method of any one of embodiments 71 to 78, further comprising filling the enclosure, or a portion thereof, with a first liquid medium which is immiscible with the first and second droplets, wherein the enclosure is filled with the first liquid medium prior to disposing the first droplet upon the droplet actuation surface, and wherein the first liquid medium comprises an organic liquid having a branched carbon backbone.
80. The method of embodiment 79, wherein the organic liquid has a molecular weight of about 100 to 500 daltons, or about 100 to 400 daltons, or about 100 to 300 daltons, or about 150 to 500 daltons, or about 150 to 400 daltons, or about 150 to 300 daltons.
81. The method of embodiment 79 or 80, wherein the first liquid medium consists essentially of or consists of the organic liquid.
82. The method of any one of embodiments 79 to 81, wherein the organic liquid is a carbonate or a hydrocarbon.
83. The method of embodiment 82, wherein the organic liquid is bis(2-ethylhexyl) carbonate or heptamethylnonane.
84. A method of processing biological cells in a microfluidic device having an electrowetting configuration, the method comprising:

disposing a first droplet of aqueous medium upon a droplet actuation surface of the microfluidic device, wherein the first droplet comprises one or more biological cells, and wherein the micro fluidic device further comprises
a substrate having a dielectric layer and a first electrode configured to be connected to an AC voltage source, and
a second electrode configured to be connected to the AC voltage source,
wherein the dielectric layer is electrically coupled to the first electrode,
wherein the droplet actuation surface comprises a hydrophobic layer covalently bonded to the dielectric layer,
wherein the hydrophobic layer is a monolayer formed from molecules each comprising a surface modifying ligand and a linking group that links the surface modifying ligand to the surface, each molecule having a structure of:

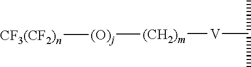

wherein:
[symbol] is the surface;
V is a linker;
n+m+j is 13 or greater, n is 5 or greater, m ranges from 2 to 13, and j is 0 or 1; and
wherein, when the first electrode and the second electrode are connected to opposing terminals of the AC voltage source, the substrate is capable of applying an electrowetting force to aqueous droplets in contact with the droplet actuating surface;

merging the first droplet with a second droplet of aqueous medium to form a first combined droplet, wherein the second droplet comprises a cell lysing agent;

incubating the first combined droplet upon the droplet actuation surface for a first period of time sufficient to lyse the one or more biological cells; and

inactivating the cell lysing agent.
85. The method of embodiment 84, wherein the microfluidic device is a microfluidic device of any one of embodiments 1 to 62.
86. The method of embodiment 84 or 85, wherein V is —Si(OZ)₂W—; W is —O— and connects to the surface; and Z is a bond to an adjacent silicon atom attached to the surface or is a bond to the surface.
87. The method of embodiment 84 or 85, wherein V is —P(O)(OY)W—; W is —O— and connects to the surface; and Y is a bond to an adjacent phosphorus atom attached to the surface or is a bond to the surface.
88. The method of any one of embodiments 84 to 87, wherein n is 7 or greater, 9 or greater, 11 or greater, or 13 or greater.
89, The method of any one of embodiments 84 to 88, wherein m ranges from 2 to 10, 2 to 8, 2 to 6, or 2 to 4.
90. The method of embodiment 89, wherein m is 2.
91. The method of any one of embodiments 88 to 90, wherein n is 11, 13, or 15.
92. The method of embodiment 91, wherein n is 13.
93. The method of any one of embodiments 84 to 92, further comprising filling the enclosure, or a portion thereof, with a first liquid medium which is immiscible with the first and second droplets, wherein the enclosure is filled with the first liquid medium prior to disposing the first droplet upon the droplet actuation surface, wherein the first liquid medium comprises mineral oil or a linear alkane organic liquid of the formula CₓH₍₂ₓ₊₂₎, wherein x is from 9 to 16.
94. The method of embodiment 93, wherein x is 10, 11, 12, 13, or 14.
95. The method of embodiment 93, wherein the linear alkane organic liquid is dodecane.
96. The method of any one of embodiments 93 to 94, wherein the first liquid medium consists essentially of or consists of the linear alkane organic liquid.
97. The method of any one of embodiments 71 to 96, wherein the first droplet further comprises a surfactant.
98. The method of embodiment 97, wherein the surfactant is non-ionic.
99. The method of embodiment 97, wherein the surfactant is TET surfactant.
100. The method of embodiment 97, wherein the surfactant is N-(1,3-bis(Glucopyranoside)propan-2-yl)-3-Butyl-3-Cyclohexylheptanamide (Cy-Tripglu).
101. The method of embodiment 97, wherein the surfactant is a polyethylene oxide-polypropylene oxide (PEO-PPO) block copolymer.
102. The method of embodiment 101, wherein the PEO-PPO block copolymer is a poloxamer.
103. The method of embodiment 101, wherein the poloxamer is Pluronic F68, L31, or F127.
104. The method of any one of embodiments 97 to 103, wherein the surfactant is present at a concentration less than or equal to 0.5% v/v.
105. The method of embodiment 104, wherein the surfactant is present at a concentration ranging from 0.1% to 0.5%, 0.1% to 0.15%, 0.15% to 0.25%, 0.25% to 0.35%, or 0.35% to 0.5%.
106. The method of any one of embodiments 71 to 105, wherein the dielectric layer comprises one or more dielectric materials.
107. The method of any one of embodiments 71 to 106, wherein the dielectric layer comprises two or more layers of dielectric material that form a dielectric stack.
108. The method of any one of embodiments 71 to 107, wherein the dielectric layer comprises a first layer of dielectric material, and wherein the first layer of dielectric material comprises a metal oxide deposited by ALD.
109. The method of embodiment 108, wherein the metal oxide is aluminum oxide.
110. The method of embodiment 108 or 109, wherein the first layer of dielectric material comprises a first sublayer of metal oxide deposited by ALD, optionally about 1 nm to about 10 nm thick (e.g., about 2 nm to about 5 nm thick), and a second sublayer of silicon oxide deposited by ALD, optionally about 1 nm to about 10 nm thick (e.g., about 2 nm to about 5 nm thick), wherein the surface of the second sublayer is covalently bound to the hydrophobic layer.
111. The method of any one of embodiments 106 to 109, wherein the dielectric stack further comprises a second layer of dielectric material.
112. The method of embodiment 111, wherein the second layer of dielectric material comprises silicon oxide or silicon nitride deposited by PECVD.
113. The method of any one of embodiments 71 to 105, wherein the dielectric layer consists of a single layer of metal oxide deposited by ALD.
114. The method of embodiment 113, wherein the metal oxide is aluminum oxide.
115. The method of embodiment 107, wherein the dielectric stack comprises:
   a first layer of silicon oxide or silicon nitride deposited by PEVCD;
   a second layer of metal oxide deposited by ALD on the first layer; and
   a third layer of silicon oxide deposited by ALD on the second layer, wherein the surface of the third layer opposite to the second layer defines the outermost surface of the dielectric stack.
116. The method of embodiment 115, wherein the second layer has a thickness of about 1 nm to 10 nm.
117. The method of embodiment 116, wherein the second layer has a thickness of about 2 nm to 5 nm.
118. The method of any one of embodiments 115 to 117, wherein the third layer has a thickness of about 1 nm to 10 nm.
119. The method of embodiment 118, wherein the third layer has a thickness of about 2 nm to 5 nm.
120. The method of any one of embodiments 71 to 119, wherein the dielectric layer or the dielectric stack has a thickness of at least about 40 nm.
121. The method of embodiment 120, wherein the dielectric layer or the dielectric stack has a thickness of about 40 nm to about 120 nm.
122. The method of any one of embodiments 71 to 121, wherein the dielectric layer or the dielectric stack has an impedance of about 50 kOhms to about 150 kOhms.
123. The method of embodiment 122, wherein the dielectric layer or the dielectric stack has an impedance of about 100 kOhms.
124. The method of any one of embodiments 71 to 123, wherein the second droplet is merged with the first droplet by applying an electrowetting force to the second and/or the first droplet.
125. The method of any one of embodiments 71 to 124, wherein the second droplet further comprises a surfactant.
126. The method of embodiment 125, wherein the surfactant in the second droplet is non-ionic and comprises a polar head group of a size greater than 750 daltons, optionally wherein the polar head group size is greater than 800, 900, 1000, 1100, 1200, or 1300 daltons.
127. The method of embodiment 126, wherein the polar head group is of a size ranging from 750 to 2000 daltons, optionally wherein the size ranges from 750 to 1000, 1000 to 1200, 1200 to 1400, 1400 to 1600, 1600 to 1800, or 1800 to 2000 daltons.
128. The method of embodiment 125, wherein the surfactant in the second droplet is a polysorbate, optionally polysorbate 20, or an octylphenol ethoxylate, wherein the ethoxylate group has an average length of at least 9 ethyloxide units, or optionally at least 15, 20, 25, 30 or more ethyloxide units.
129. The method of any one of embodiments 71 to 128, wherein the cell lysing agent is a protease, optionally wherein the protease is proteinase K.
130. The method of any one of embodiments 71 to 129, wherein the cell lysing agent is inactivated by heating.
131. The method according to any of embodiments 71 to 130, the method further comprising fragmenting nucleic acid from the one or more biological cells, thereby producing nucleic acid fragments.
132. The method of embodiment 131, wherein the nucleic acid is DNA, genomic DNA, mitochondrial DNA, or any combination thereof.
133. The method of embodiment 131 or 132, wherein the nucleic acid is fragmented with a fragmenting agent, and optionally wherein the fragmenting agent comprises a base, restriction enzyme, fragmentase, or transposase.
134. The method of embodiment 133, wherein the nucleic acid is contacted with the fragmenting agent by merging the first combined droplet with a third droplet comprising the fragmenting agent, thereby forming a second combined droplet.
135. The method of embodiment 134, wherein the third droplet further comprises a surfactant, optionally wherein the surfactant is a surfactant as recited in any one of embodiments 98-105.
136. The method of embodiment 134, further comprising incubating the second combined droplet upon the droplet actuation surface for a period of time sufficient to fragment DNA released by the one or more lysed biological cells.
137. The method of any one of embodiments 131 to 136, wherein the nucleic acid fragments produced by fragmenting the nucleic acid from the one or more biological cells have an average size of about 300 to about 600 bases or base pairs.
138. The method of any one of embodiments 133 to 137, wherein the DNA-fragmenting agent comprises a transposase and oligonucleotide adapters.
139. The method of embodiment 138, wherein the transposase is a Tn5 transposase.
140. The method of any one of embodiments 134 to 139, wherein incubating the second combined droplet comprises adjusting the temperature of the microfluidic device to a temperature of about 50° C. to about 60° C. (e.g., about 52° C. to about 58° C., or about 55° C.), optionally for at least about 3 minutes (e.g., about 3 to 7 minutes, about 4 to about 6 minutes, or about 5 minutes).
141. The method of any one of embodiments 134 to 140, further comprising merging the second combined droplet with a fourth droplet of aqueous medium to form a third combined droplet, wherein the fourth droplet comprises an inhibitor of the DNA-fragmenting agent.
142. The method of embodiment 141, wherein the inhibitor of the DNA-fragmenting agent is a detergent.
143. The method of embodiment 142, wherein the detergent comprises dodecyl sulfate, optionally wherein the concentration of the detergent in the third combined droplet is about 0.1% to about 0.2% v/v.
144. The method of any one of embodiments 141 to 143, further comprising adjusting the temperature of the microfluidic device to about 10° C. to about 20° C. (e.g., about 12° C. to about 16° C., or about 14° C.).
145. The method of any one of embodiments 133 to 137, wherein the DNA-fragmenting agent comprises a a DNA cutting enzyme, optionally in combination with a DNA nicking enzyme.
146. The method of any one of embodiments 133 to 137 and 145, wherein incubating the second combined droplet comprises adjusting the temperature of the microfluidic device to a temperature of about 30° C. to about 42° C. (e.g., about 35° C. to about 39° C., or about 37° C.), optionally for at least about 10 minutes (e.g., about 10 to 20 minutes, about 12 to about 18 minutes, or about 15 minutes).
147. The method of embodiment 145 or 146, further comprising:

merging the second combined droplet with a fourth droplet of aqueous medium to form a third combined droplet, wherein the fourth droplet comprises a DNA polymerase having A-tailing activity; and

adjusting the temperature of the microfluidic device to a temperature of about 60° C. to about 70° C. (e.g., about 62° C. to about 68° C., or about 65° C.), optionally for at least about 15 minutes (e.g., about 15 to 45 minutes, about 20 to about 40 minutes, about 25 to about 35 minutes, or about 30 minutes).
148. The method of embodiment 147, further comprising:

adjusting the temperature of the microfluidic device to a temperature of about 15° C. to about 25° C. (e.g., about 18° C. to about 22° C., or about 20° C.);

merging the third combined droplet with a fifth droplet to form a fourth combined droplet, wherein the fifth droplet comprises a ligase and oligonucleotide adapters; and

optionally, incubating the fourth combined droplet for a period of at least about 10 minutes (e.g., about 10 to about 20 minutes (e.g., about 12 to about 18 minutes, or about 15 minutes).
149. The method of embodiment 148, further comprising inactivating the ligase by adjusting the temperature of the microfluidic device to a temperature of about 80° C. to about 90° C. (e.g., about 82° C. to about 88° C., or about 85° C.), optionally for at least about 10 minutes (e.g., about 10 to about 20 minutes, about 12 to about 18 minutes, or about 15 minutes).
150. The method of any one of embodiments 131 to 147, further comprising adding adapters to the nucleic acid fragments.
151. The method of any one of embodiments 134 to 137, further comprising adding adapters to the nucleic acid fragments, wherein the adapters are added by merging the second combined droplet comprising the nucleic acid fragments with a fourth droplet comprising an A-tailing enzyme and A-tailing reagents, thereby forming a third combined droplet, and merging the third combined droplet with a fifth droplet comprising a ligase and double-stranded adapters comprising a 5′-T overhang; optionally wherein the fourth and/or fifth droplets further comprise a surfactant, optionally wherein the surfactant is a surfactant as recited in any one of embodiments 98-105.
152. The method of any one of embodiments 134 to 137, wherein the third droplet comprises a transposase and oligonucleotides comprising adapter sequences, and wherein the second combined droplet is incubated, thereby providing nucleic acid fragments that further comprise adapter sequences, optionally wherein the nucleic acid fragments are purified following incubation.
153. The method of any one of embodiments 148 to 152, wherein the adapters comprise barcode sequences, optionally wherein nucleic acid fragments attached to the adapters are pooled with other nucleic acid fragments comprising adapters formed in a separate droplet, further optionally wherein pooling comprises merging a droplet comprising the nucleic acid fragments attached to the adapters and a droplet comprising the other nucleic acid fragments comprising adapters.
154. The method of embodiment 153, wherein the nucleic acid fragments attached to the adapters are exported from the microfluidic device and subjected to an amplification reaction (e.g., PCR, which can comprise at least 10, 20, or 30 cycles, or about 10 to 20 cycles, or about 12 to 15 cycles).
155. The method of any one of embodiments 63 to 130, further comprising:

merging the first combined droplet with a third droplet of aqueous medium to form a second combined droplet, wherein the third droplet comprises a reverse transcriptase; and

incubating the second combined droplet upon the droplet actuation surface for a period of time sufficient to reverse transcribe RNA released by the lysed one or more biological cells.
156. The method of embodiment 155, wherein the third droplet further comprises a buffer and precursors that support reverse transcriptase activity, optionally wherein the precursors comprise nucleotides and primers.
157. The method of embodiment 155 or 156, wherein the third droplet further comprises oligo-dT oligonucleotides.
158. The method of any one of embodiments 155 to 157, wherein the third droplet further comprises oligonucleotides linked to beads.
159. The method of any one of embodiments 155 to 158, wherein incubating the second combined droplet upon the droplet actuation surface comprises:

adjusting the temperature of the microfluidic device to a temperature of about 50° C. to about 60° C. (e.g., about 52° C. to about 58° C., or about 55° C.), for at least about 1 minute (e.g., about 1 to 5 minutes, about 1 to about 3 minutes, or about 2 minutes); and

adjusting the temperature of the microfluidic device to a temperature of about 37° C. to about 45° C. (e.g., about 40° C. to about 43° C., or about 42° C.), for at least about 45 minutes (e.g., at least about 50, about 55, about 60 minutes, or more).
160. The method of any one of embodiments 155 to 159, further comprising:

merging the second combined droplet with a fourth droplet of aqueous medium to form a third combined droplet, wherein the fourth droplet comprises a nucleic acid polymerase, and a buffer and precursors (e.g., nucleotides, primers, etc.) that support a polymerase activity of the nucleic acid polymerase; and

incubating the third combined droplet upon the droplet actuation surface, under conditions that promote amplification of cDNA present.
161. The method of any one of embodiments 134 to 140, 145 to 146, 150, and152 to 154, further comprising:

merging the second combined droplet with a fourth droplet of aqueous medium to form a third combined droplet, wherein the fourth droplet comprises a nucleic acid polymerase, and a buffer and precursors (e.g., nucleotides, primers, etc.) that support a polymerase activity of the nucleic acid polymerase; and

incubating the third combined droplet upon the droplet actuation surface, under conditions that promote amplification of fragmented DNA present.
162. The method of any one of embodiments 141 to 144, 147 to 149, and 153 to 154, further comprising:

merging the third combined droplet with a sixth droplet of aqueous medium to form a fourth combined droplet, wherein the sixth droplet comprises a nucleic acid polymerase, and a buffer and precursors (e.g., nucleotides, primers, etc.) that support a polymerase activity of the nucleic acid polymerase; and

incubating the fourth combined droplet upon the droplet actuation surface, under conditions that promote amplification of fragmented DNA present.
163. The method of any one of embodiments 160 to 162, wherein the primer oligonucleotides comprise a nucleic acid-based bar code.
164. The method of any one of embodiments 160 to 163, wherein the primer oligonucleotides comprise a poly-dT sequence.
165. The method of any one of embodiments 131 to 159, further comprising:

amplifying the nucleic acid fragments or cDNA, wherein amplifying comprises merging the droplet comprising the nucleic acid fragments or cDNA with a droplet comprising an amplification mixture and a surfactant (optionally wherein the surfactant is a polysorbate surfactant having a molecular weight of at least 1000 daltons (e.g., polysorbate 20), optionally at a concentration ranging from 0.1% to 0.5% (or 0.15% to 0.3%), or a surfactant as recited in any one of embodiments 98-105, thereby forming a combined amplification droplet; and

incubating the combined amplification droplet under conditions that promote amplification.
166. The method of any one of embodiments 131 to 159 and 165, further comprising exporting the nucleic acid fragments or cDNA from the microfluidic device and then amplifying the nucleic acid fragments or cDNA.
167. The method of embodiment 165 or 166, wherein the amplifying comprises PCR amplification.
168. The method of embodiment 165 or 166, wherein the amplifying comprises barcoding PCR amplification.
169. The method of embodiment 167 or 168, wherein the PCR amplification or the barcoding PCR amplification comprises at least 4 cycles, optionally wherein 4 to 15, 5 to 10, 5, 6, 7, 8, 9, 10, 11, 12, 13, 14, or 15 cycles are performed.
170. The method of embodiment 168 or 169, wherein the products of the barcoding PCR amplification are pooled with products of a different barcoding PCR amplification reaction, optionally wherein pooling comprises merging a droplet comprising the products of the barcoding PCR amplification and a droplet comprising the products of the different barcoding PCR amplification.
171. The method of any one of embodiments 168 to 170, wherein the products of the barcoding PCR amplification reaction are exported from the microfluidic device and subjected to a further amplification reaction (e.g., PCR, which can comprise at least about 10 cycles, or about 10 to 20 cycles, or about 12 to 15 cycles).
172. The method of any one of embodiments 131 to 171, further comprising pooling nucleic acid fragments, cDNA, or products of the amplification reaction from a plurality of droplets, thereby resulting in pooled nucleic acid, and optionally further comprising exporting the pooled nucleic acid.
173. The method of any one of embodiments 131 to 172, further comprising purifying nucleic acid fragments, cDNA, pooled nucleic acid, or products of the amplification reaction, optionally wherein purifying comprises on-chip bead-based purification (e.g., using magnetic beads that selectively bind to nucleic acids).
174. The method of embodiment 170 to 172, further comprising amplifying the pooled nucleic acid, and optionally purifying the amplified pooled nucleic acid.
175. The method of any one of embodiments 63 to 174, wherein the first droplet and second droplet each have a volume of about 5 to 50 nanoliters.
176. The method of embodiment 175, wherein the first droplet and the second droplet each have a volume of about 5 to 20 nanoliters.
177. The method of embodiment 175 or 176, wherein the second droplet has a volume about 1 to 3 times greater than the first droplet.
178. The method of any one of embodiments 63 to 177, wherein applying an electrowetting force to a droplet comprises activating electrowetting electrodes at a region of the droplet actuation surface that is proximal to the droplet(s).
179. The method of embodiment 178, wherein the substrate comprises a photoresponsive layer, and wherein activating electrowetting electrodes at the region of the droplet actuation surface proximal to the droplet(s) comprises directing a pattern of light onto the region of the droplet actuation surface.
180. A method of amplifying nucleic acid in a microfluidic device having an electrowetting configuration, the method comprising:

disposing a first droplet of aqueous medium upon a droplet actuation surface of the microfluidic device, wherein the first droplet comprises nucleic acid (e.g., nucleic acid fragments), and wherein the microfluidic device further comprises
a substrate having a dielectric layer and a first electrode configured to be connected to an AC voltage source, and
a second electrode configured to be connected to the AC voltage source,
wherein the dielectric layer is electrically coupled to the first electrode,
wherein the droplet actuation surface comprises a hydrophobic layer covalently bonded to the dielectric layer, and
wherein, when the first electrode and the second electrode are connected to opposing terminals of the AC voltage source, the substrate is capable of applying an electrowetting force to aqueous droplets in contact with the droplet actuating surface;

merging the first droplet with a second droplet of aqueous medium to form a combined droplet, wherein the second droplet comprises a nucleic acid polymerase, and wherein the combined droplet comprises a buffer and precursors (e.g., nucleotides, primers, etc.) that support a polymerase activity of the nucleic acid polymerase; and

incubating the combined droplet upon the droplet actuation surface, under conditions that promote amplification of the nucleic acid originating from the first droplet.
181 The method of embodiment 180, wherein the microfluidic device is the microfluidic device of any one of embodiments 1 to 62.
182. The method of embodiment 180 or 181, wherein incubating the combined droplet under conditions that promote amplification comprises adjusting the temperature of the microfluidic device to a first temperature that is sufficient to cause the nucleic acid originating from the first droplet to denature partially or fully.
183. The method of embodiment 182, wherein the first temperature is at least about 85° C. (e.g., at least about 88° C., about 90° C., about 92° C., about 93° C., about 94° C., about 95° C., or greater).
184. The method of embodiment 182 or 183, wherein incubating the combined droplet under conditions that promote amplification comprises further adjusting the temperature of the microfluidic device to a second temperature that promotes priming of the nucleic acid originating from the first droplet and/or the template-based extension of the primed nucleic acid.
185. The method of embodiment 184, wherein the second temperature is about 40° C. to about 75° C. (e.g., about 50° C. to about 70° C., or about 55° C. to about 65° C.).
186. The method of embodiment 184 or 185, wherein incubating the combined droplet under conditions that promote amplification comprises further adjusting the temperature of the microfluidic device to a third temperature that promotes the template-based extension of the primed nucleic acid.
187. The method of embodiment 186, wherein the second temperature is about 50° C. to about 67° C. (e.g., about 55° C. to about 65° C., or about 58° C. to about 62° C.).
188. The method of embodiment 186 or 187, wherein the third temperature is about 65° C. to about 80° C. (e.g., about 70° C. to about 78° C., or about 72° C. to about 76° C.).
189. The method of embodiment 184 or 185, wherein incubating the combined droplet under conditions that promote amplification comprises cycling the temperature of the microfluidic device between the first and second temperatures.
190. The method of any one of embodiments 186 to 188, wherein incubating the combined droplet under conditions that promote amplification comprises cycling the temperature of the microfluidic device between the first, second, and third temperatures.
191. The method of embodiment 189 or 190, wherein at least 4 cycles are performed, optionally wherein at least 5, 6, 7, 8, 9, 10, 11, 12, 13, 14, 15, 16, 17, 18, 19, 20, or more cycles are performed.
192. The method of any one of embodiments 180 to 191, wherein the first droplet further comprises a surfactant.
193. The method of any one of embodiments 180 to 192, wherein the second droplet further comprises a surfactant.
194. The method of embodiment 192 or 193, wherein the surfactant is non-ionic.
195. The method of embodiment 192, 193, or 194, wherein the surfactant comprises a polar head group of a size greater than 750 daltons, optionally wherein the polar head group size is greater than 800, 900, 1000, 1100, 1200, or 1300 daltons.
196. The method of embodiment 195, wherein the polar head group is of a size ranging from 750 to 2000 daltons, optionally wherein the size ranges from 750 to 1000, 1000 to 1200, 1200 to 1400, 1400 to 1600, 1600 to 1800, or 1800 to 2000 daltons.
197. The method of embodiment 192 or 193, wherein the surfactant is a polysorbate, optionally polysorbate 20.
198. The method of embodiment 192 or 193, wherein the surfactant is TET surfactant.
199. The method of embodiment 192 or 193, wherein the surfactant is N-(1,3-bis(Glucopyranoside)propan-2-yl)-3-Butyl-3-Cyclohexylheptanamide (Cy-Tripglu).
200. The method of embodiment 192 or 193, wherein the surfactant is a polyethylene oxide-polypropylene oxide (PEO-PPO) block copolymer, optionally wherein the PEO-PPO block copolymer is a poloxamer.
201. The method of embodiment 200, wherein the poloxamer is Pluronic F68, L31, or F127.
202. The method of any one of embodiments 192 to 202, wherein the surfactant is present at a concentration less than or equal to 0.5% v/v.
203. The method of embodiment 202, wherein the surfactant is present at a concentration ranging from 0.1% to 0.5%, 0.1% to 0.15%, 0.15% to 0.25%, 0.25% to 0.35%, or 0.35% to 0.5%.
204. The method of any one of embodiments 180 to 203, wherein the dielectric layer comprises one or more dielectric materials.
205. The method of any one of embodiments 180 to 204, wherein the dielectric layer comprises more than one layer of dielectric material to form a dielectric stack.
206. The method of any one of embodiments 180 to 205, wherein the dielectric layer comprises a first layer of dielectric material, and wherein the first layer of dielectric material comprises a metal oxide deposited by ALD.
207. The method of embodiment 206, wherein the metal oxide is aluminum oxide.
208. The method of embodiment 206 or 207, wherein the first layer of dielectric material comprises a first sublayer of metal oxide deposited by ALD and a second sublayer of silicon oxide deposited by ALD, wherein the surface of the second sublayer is covalently bound to the hydrophobic layer.
209. The method of embodiment 208, wherein the first sublayer has a thickness of about 1 nm to about 10 nm thick (e.g., about 2 nm to about 5 nm thick).
210. The method of embodiment 208 or 209, wherein the second sublayer has a thickness of about 1 nm to about 10 nm thick (e.g., about 2 nm to about 5 nm thick).
211. The method of any one of embodiments 205 to 210, wherein the dielectric stack further comprises a second layer of dielectric material.
212. The method of embodiment 211, wherein the second layer of dielectric material comprises silicon oxide or silicon nitride deposited by PECVD.
213. The method of any one of embodiments 180 to 204, wherein the dielectric layer consists of a single layer of metal oxide deposited by ALD.
214. The method of embodiment 213, wherein the metal oxide is aluminum oxide.
215. The method of 205, wherein the dielectric stack comprises:
   a first layer of silicon oxide or silicon nitride deposited by PEVCD;
   a second layer of metal oxide deposited by ALD on the first layer; and
   a third layer of silicon oxide deposited by ALD on the second layer, wherein the surface of the third layer opposite to the second layer defines the outermost surface of the dielectric stack.
216. The method of any one of embodiment 215, wherein the second layer has a thickness of about 1 nm to 10 nm.
217. The method of embodiment 216, wherein the second layer has a thickness of about 2 nm to 5 nm.
218. The method of any one of embodiments 215 to 217, wherein the third layer has a thickness of about 1 nm to 10 nm.
219. The method of embodiment 218, wherein the third layer has a thickness of about 2 nm to 5 nm.
220. The method of any one of embodiments 180 to 219, wherein the dielectric layer (or dielectric stack) has a thickness of at least about 40 nanometers.
221. The method of embodiment 220, wherein the dielectric stack has a thickness of about 40 nanometers to about 120 nanometers.
222. The method of any one of embodiments 180 to 221, wherein the dielectric layer (or dielectric stack) has an impedance of about 50 kOhms to about 150 kOhms.
223. The method of embodiment 222, wherein the dielectric stack has an impedance of about 100 kOhms.
224. The method of any one of embodiments 63 to 223, wherein the temperature of the microfluidic device is adjusted by a thermal control subsystem configured to regulate a temperature of the microfluidic device, and the thermal control circuit is configured to follow rules correlating a temperature value measured by the thermistor with a target temperature and a power output of Peltier thermoelectric device, the rules comprising:
   setting the power output to a first value if the difference between the target temperature and the thermistor-measured temperature is larger than N;
   setting the power output to a second value lower than the first value if the difference between the target temperature and the thermistor-measured temperature is equal to or smaller than N and larger than M; and
   determining the power output by a proportionate-integral-derivative (PID) loop controller with the thermistor-measured temperature as an input if the difference between the target temperature and the thermistor-measured temperature is smaller than or equal to M,
   wherein M is in the range of 5° C. to 15° C. (e.g., about 7° C. to about 13° C., or about 8° C. to about 12° C., or about 9° C. to about 11° C.) and N is in the range of 1° C. to 5° C. (e.g., about 2° C. to about 4° C. or about 2.5° C. to about 3.5° C.).
225. A system for operating a microfluidic device, the system comprising:

a support configured to hold and operatively couple with a microfluidic device, the support comprising:
an electrical signal generation subsystem configured to selectively apply a biasing voltage across a pair of electrodes in the microfluidic device when the microfluidic device is held by, and operatively coupled with, the support;
a thermal control subsystem configured to regulate a temperature of the microfluidic device when the microfluidic device is held by, and operably coupled with, the support,
the thermal control subsystem comprising
a thermal control circuit, a thermistor, and a Peltier thermoelectric device,
wherein the thermistor is positioned in the support and configured to measure the temperature of a location at or proximal to a surface of the microfluidic device,
wherein the Peltier thermoelectric device is configured to interface with the surface of the microfluidic device, and
wherein the thermal control circuit is configured to follow rules correlating a temperature value measured by the thermistor with a target temperature and a power output of Peltier thermoelectric device, the rules comprising:
   setting the power output to a first value if the difference between the target temperature and the thermistor-measured temperature is larger than N;
   setting the power output to a second value lower than the first value if the difference between the target temperature and the thermistor-measured temperature is equal to or smaller than N and larger than M; and
   determining the power output by a proportionate-integral-derivative (PID) loop controller with the thermistor-measured temperature as an input if the difference between the target temperature and the thermistor-measured temperature is smaller than or equal to M,
wherein M is in the range of 5° C. to 15° C. (e.g., about 7° C. to about 13° C., or about 8° C. to about 12° C., or about 9° C. to about 11° C.) and N is in the range of 1° C. to 5° C. (e.g., about 2° C. to about 4° C. or about 2.5° C. to about 3.5° C.).
226. The method or system of embodiment 224 or 225, wherein the first value is in the range of 70% to 100% power output of the Peltier thermoelectric device.
227. The method or system of embodiment 224 or 225, wherein the first value is 100% power output of the Peltier thermoelectric device.
228. The method or system of any one of embodiments 224 to 227, wherein the second value is a power output value determined from calibration data correlating a plurality of target temperature values with a plurality of power output values.
229. The method or system of embodiment 228, wherein: the target temperature values correlated to the power output values were determined by equilibrating a calibration chip comprising a thermocouple with the Peltier thermoelectric device at each of the power output values and associating the temperature registered by the thermocouple following equilibration with the power output value; and/or the plurality of target temperature values comprises at least 4, 5, 6, 7, 8, 9, or 10 values in the range of 0° C. to 100° C., optionally wherein a power output value corresponding to a target temperature value between values represented in the calibration data is determined by linear interpolation.
230. The system of any one of embodiments 225 to 229, further comprising a light modulating subsystem configured to emit structured light onto the microfluidic device when the microfluidic device is held by, and operatively coupled with, the support.
231. The system of any one of embodiments 225 to 230, wherein the support comprises a socket configured to receive and interface with the microfluidic device.
232. The system of any one of embodiments 225 to 231, wherein the electrical signal generation subsystem comprises a waveform generator configured to generate a biasing voltage waveform to be applied across the electrode pair when the microfluidic device is held by, and operatively coupled with, the support.
233. The system of embodiment 232, wherein the electrical signal generation subsystem further comprises a waveform amplification circuit configured to amplify the biasing waveform generated by said waveform generator.
234. The system of embodiment 232 or 233, wherein the electrical signal generation subsystem further comprises an oscilloscope configured to measure the biasing voltage waveform, and wherein data from the measurement is provided as feedback to the waveform generator.
235. The system of any one of embodiments 225 to 234, wherein the thermal control subsystem further comprises a cooling unit.
236. The system of embodiment 235, wherein the Peltier thermoelectric device is interposed between a surface of the microfluidic device and a surface of the cooling unit.
237. The system of embodiment 235 or 236, wherein the cooling unit comprises a cooling block, and a fluidic path configured to circulate cooled liquid through the cooling block, wherein the cooling block comprises the surface of the cooling unit.
238. The system of any one of embodiments 225 to 237, wherein the Peltier thermoelectric device and the thermoelectric power supply are mounted on and/or integrated with the support.
239. The system of any of embodiments 225 to 238, wherein the support further comprises a controller configured to control one or both of the electrical signal generation subsystem and the thermal control subsystem.
240. The system of embodiment 239, wherein the support comprises a printed circuit board assembly (PCBA), and wherein at least one of the electrical signal generation subsystem, the thermal control subsystem, and the controller are mounted on and/or integrated with the PCBA.
241. The system of embodiment 239 or 240, further comprising an external master controller operatively coupled with the controller, wherein the external master controller comprises a graphical user interface configured to receive operator input and for processing and transmitting the operator input to the controller for controlling one or both of the electrical signal generation subsystem and the thermal control subsystem.
242. The system of embodiment 241, wherein the controller is configured to transmit to the external master controller data and/or information sensed or received, or otherwise calculated based upon data or information sensed or received, from one or both of the electrical signal generation subsystem and the thermal control subsystem.
243. The system of any of embodiments 225 to 242, wherein the support and/or the light modulating subsystem are configured to be mounted on a microscope.
244. The system of any of embodiments 225 to 242, wherein the support and/or the light modulating subsystem are integral components of a microscope.
245. The system of any of embodiments 225 to 244, wherein the microfluidic device is an optically actuated microfluidic device.
246. The system of any of embodiments 225 to 245, wherein the light modulating subsystem comprises a digital mirror device (DMD) or a microshutter array system (MSA).
247. The system of any of embodiments 225 to 245, wherein the light modulating subsystem comprises an organic light emitting diode display (OLED), a liquid crystal on silicon (LCOS) device, a ferroelectric liquid crystal on silicon device (FLCOS), or a transmissive liquid crystal display (LCD).

In case of any contradiction or conflict between material incorporated by reference and the expressly described content provided herein, the expressly described content controls.

### EQUIVALENTS

The foregoing written specification is considered to be sufficient to enable one skilled in the art to practice the embodiments. The foregoing description and Examples detail certain embodiments and describes the best mode contemplated. It will be appreciated, however, that no matter how detailed the foregoing may appear in text, the embodiment may be practiced in many ways and should be construed in accordance with the appended claims and any equivalents thereof.

1. A method of processing biological cells in a microfluidic device having an electrowetting configuration, the method comprising:
disposing a first droplet of aqueous medium upon a droplet actuation surface of the microfluidic device, wherein the first droplet comprises one or more biological cells, and wherein the microfluidic device further comprises
a substrate having a dielectric layer and a first electrode configured to be connected to an AC voltage source, and
a second electrode configured to be connected to the AC voltage source,
wherein the dielectric layer is electrically coupled to the first electrode,
wherein the droplet actuation surface comprises a hydrophobic layer covalently bonded to the dielectric layer, and
wherein, when the first electrode and the second electrode are connected to opposing terminals of the AC voltage source, the substrate is capable of applying an electrowetting force to aqueous droplets in contact with the droplet actuating surface;
merging the first droplet with a second droplet of aqueous medium to form a first combined droplet, wherein the second droplet comprises a cell lysing agent;
incubating the first combined droplet upon the droplet actuation surface for a first period of time sufficient to lyse the one or more biological cells; and
inactivating the cell lysing agent.

2. The method of claim 1, wherein the microfluidic device further comprises a cover and at least one spacing element,
wherein the substrate and the cover are substantially parallel to one another and joined together by the spacing element so as to define an enclosure configured to hold a liquid,
wherein the droplet actuation surface defines, in part, the enclosure, and
wherein the cover comprises the second electrode and a surface of the second electrode defines, in part, the enclosure.

3. The method of claim 1, wherein the hydrophobic layer comprises self-associating molecules covalently bonded to a surface of the dielectric layer, to thereby form a densely packed hydrophobic monolayer thereon.

4. The method of claim 1, wherein the dielectric layer comprises a first layer of dielectric material comprising aluminum oxide.

5. The method of claim 4, wherein the dielectric layer further comprises a second layer of dielectric material, wherein the hydrophobic layer is covalently bonded to the first layer of dielectric material, and wherein the second layer of dielectric material comprises silicon dioxide or silicon nitride deposited by plasma-enhanced chemical vapor deposition (PECVD).

6. The method of claim 4, wherein the first layer of dielectric material comprises first and second sublayers of dielectric materials, wherein the first sublayer comprises silicon oxide and is covalently bonded to the hydrophobic layer, wherein the second sublayer of dielectric material comprises aluminum oxide, and wherein the first sublayer of dielectric material is deposited by atomic layer deposition (ALD) and/or wherein the second sublayer of dielectric material is deposited by ALD

7. The method of claim 1, wherein the dielectric layer has an impedance of about 50 kOhms to about 150 kOhms.

8. The method of claim 1,
wherein the hydrophobic layer is a monolayer formed from molecules each comprising a surface modifying ligand and a linking group that links the surface modifying ligand to the surface, each molecule having a structure of: 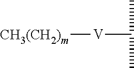
wherein: [symbol]
is the surface;
V is a linker;
m is an integer of 9 or greater.

9. (canceled)

10. The method of claim 8, wherein V is —Si(OZ)₂W—; W is —O— and connects to the surface; and Z is a bond to an adjacent silicon atom attached to the surface or is a bond to the surface.

11. The method of claim 8, wherein m is 15, 17 or 19.

12. The method of claim 1, further comprising filling the enclosure, or a portion thereof, with a first liquid medium which is immiscible with the first and second droplets, wherein the enclosure is filled with the first liquid medium prior to disposing the first droplet upon the droplet actuation surface, and wherein the first liquid medium comprises an organic liquid having a branched carbon backbone, mineral oil or a linear alkane organic liquid of the formula CₓH₍₂ₓ₊₂₎, wherein x is from 9 to 16.

13. (canceled)

14. The method of claim 12, wherein the organic liquid is bis(2-ethylhexyl) carbonate or heptamethylnonane.

15. The method of claim 1, PATENT
wherein the hydrophobic layer is a monolayer formed from molecules each comprising a surface modifying ligand and a linking group that links the surface modifying ligand to the surface, each molecule having a structure of: 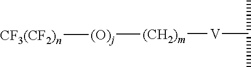
wherein: [symbol]
is the surface;
V is a linker;
n+m+j is 13 or greater, n is 5 or greater, m ranges from 2 to 13, and j is 0 or 1.

16. (canceled)

17. The method of claim 15, wherein V is —Si(OZ)₂W—; W is —O— and connects to the surface; and Z is a bond to an adjacent silicon atom attached to the surface or is a bond to the surface.

18. (canceled)

19. (canceled)

20. (canceled)

21. The method of claim 1, wherein the first droplet and/or the second droplet further comprises a surfactant.

22. (canceled)

23. (canceled)

24. The method of claim 1, wherein the dielectric layer comprises two or more layers of dielectric material that form a dielectric stack.

25. (canceled)

26. (canceled)

27. (canceled)

28. (canceled)

29. The method of claim 1, wherein the dielectric layer consists of a single layer of metal oxide deposited by ALD, or is comprised of a stack of dielectric layers comprising:
a first layer of silicon oxide or silicon nitride deposited by PECVD;
a second layer of metal oxide deposited by ALD on the first layer; and
a third layer of silicon oxide deposited by ALD on the second layer, wherein the surface of the third layer opposite to the second layer defines the outermost surface of the dielectric stack.

30. The method of claim 8 or 20, wherein the dielectric layer has a thickness of at least about 40 nanometers.

31. The method of claim 8 or 20, wherein the dielectric layer has an impedance of about 50 kOhms to about 150 kOhms.

32. (canceled)

33. (canceled)

34. (canceled)

35. The method of claim 1, the method further comprising fragmenting nucleic acid from the one or more biological cells, thereby producing nucleic acid fragments.

36. (canceled)

37. (canceled)

38. (canceled)

39. The method of claim 1, further comprising: merging the first combined droplet with a third droplet of aqueous medium to form a second combined droplet, wherein the third droplet comprises a reverse transcriptase; and incubating the second combined droplet upon the droplet actuation surface for a period of time sufficient to reverse transcribe RNA released by the lysed one or more biological cells.

40. The method of claim 1, further comprising amplifying nucleic acid fragments or cDNA generated from nucleic acid released from the one or more biological cells, wherein amplifying comprises merging a droplet comprising the nucleic acid fragments or cDNA with a droplet comprising an amplification mixture and a surfactant, thereby forming a combined amplification droplet, and incubating the combined amplification droplet under conditions that promote amplification.

41. (canceled)

42. (canceled)

43. (canceled)

44. A method of amplifying nucleic acid in a microfluidic device having an electrowetting configuration, the method comprising:
disposing a first droplet of aqueous medium upon a droplet actuation surface of the microfluidic device, wherein the first droplet comprises nucleic acid, and wherein the microfluidic device further comprises
a substrate having a dielectric layer and a first electrode configured to be connected to an AC voltage source, and
a second electrode configured to be connected to the AC voltage source,
wherein the dielectric layer is electrically coupled to the first electrode,
wherein the droplet actuation surface comprises a hydrophobic layer covalently bonded to the dielectric layer, and
wherein, when the first electrode and the second electrode are connected to opposing terminals of the AC voltage source, the substrate is capable of applying an electrowetting force to aqueous droplets in contact with the droplet actuating surface;
merging the first droplet with a second droplet of aqueous medium to form a combined droplet, wherein the second droplet comprises a nucleic acid polymerase, and wherein the combined droplet comprises a buffer and precursors (e.g., nucleotides, primers, etc.) that support a polymerase activity of the nucleic acid polymerase; and
incubating the combined droplet upon the droplet actuation surface, under conditions that promote amplification of the nucleic acid originating from the first droplet.

45. (canceled)

46. (canceled)

47. The method of claim 44, wherein the hydrophobic layer is a monolayer comprising a surface modifying ligand and a linking group that links the surface modifying ligand to the surface, wherein the droplet actuation surface has a structure of Formula I: 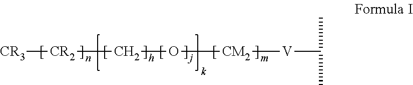
wherein [symbol] is a surface of the dielectric layer;
V is —P(O)(OY)W— or —Si(OZ)₂W—;
W is —O—, —S—, or —NH— and connects to the surface;
Z is a bond to an adjacent silicon atom attached to the surface or is a bond to the surface;
Y is a bond to an adjacent phosphorus atom attached to the surface or is a bond to the surface;
R is hydrogen or fluorine;
M is hydrogen or fluorine;
h is 0 or an integer of 2 or 3, j is 1, and k is 0 or 1;
m is 0 or an integer of 1 to 20;
n is 0 or an integer of 1 to 20;
the sum of (n+[(h+j)·k]+m) is an integer of 11 to 25;
when k is 1, then m is at least 2 and M is hydrogen; and
when k is 0 and R is fluorine, then m is at least 2 and M is hydrogen.

48. (canceled)

49. (canceled)

50. (canceled)

51. (canceled)

52. (canceled)

53. The method of claim 44, wherein the dielectric layer is comprised of a stack of dielectric layers comprising:
a first layer of silicon oxide or silicon nitride deposited by PEVCD;
a second layer of metal oxide deposited by ALD on the first layer; and
a third layer of silicon oxide deposited by ALD on the second layer, wherein the surface of the third layer opposite to the second layer defines the outermost surface of the dielectric stack.

54. The method of claim 53, wherein the dielectric stack has a thickness of at least about 40 nanometers.

55. The method of claim 53, wherein the dielectric stack has an impedance of about 50 kOhms to about 150 kOhms.

56. A system for operating a microfluidic device, the system comprising:
a support configured to hold and operatively couple with a microfluidic device, the support comprising:
an electrical signal generation subsystem configured to selectively apply a biasing voltage across a pair of electrodes in the microfluidic device when the microfluidic device is held by, and operatively coupled with, the support;
a thermal control subsystem configured to regulate a temperature of the microfluidic device when the microfluidic device is held by, and operably coupled with, the support,
the thermal control subsystem comprising
a thermal control circuit, a thermistor, and a Peltier thermoelectric device,
wherein the thermistor is positioned in the support and configured to measure the temperature of a location proximal to a surface of the microfluidic device,
wherein the Peltier thermoelectric device is configured to interface with the surface of the microfluidic device, and
wherein the thermal control circuit is configured to follow rules correlating a temperature value measured by the thermistor with a target temperature and a power output of Peltier thermoelectric device, the rules comprising:
setting the power output to a first value if the difference between the target temperature and the thermistor-measured temperature is larger than N;
setting the power output to a second value lower than the first value if the difference between the target temperature and the thermistor-measured temperature is equal to or smaller than N and larger than M; and
determining the power output by a proportionate-integral-derivative (PID) loop controller with the thermistor-measured temperature as an input if the difference between the target temperature and the thermistor-measured temperature is smaller than or equal to M,
wherein M is in the range of 5° C. to 15° C. (e.g., about 7° C. to about 13° C., or about 8° C. to about 12° C., or about 9° C. to about 11° C.) and N is in the range of 1° C. to 5° C. (e.g., about 2° C. to about 4° C. or about 2.5° C. to about 3.5° C.).

57. (canceled)

58. (canceled)

59. (canceled)

60. (canceled)
